(19) United States
(12) Patent Application Publication
(10) Pub. No.: US 2009/0036667 A1
(43) Pub. Date: Feb. 5, 2009

(54) CELLULOSE ACYLATE FILM AND METHOD FOR PRODUCING SAME, POLARIZING PLATE, RETARDATION FILM, OPTICAL COMPENSATORY FILM, ANTI-REFLECTION FILM, AND LIQUID CRYSTAL DISPLAY DEVICE

(75) Inventors: Kiyokazu Hashimoto, Kanagawa (JP); Shinichi Nakai, Shizuoka (JP); Zemin Shi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/912,530

(22) PCT Filed: Jun. 9, 2006
(86) PCT No.: PCT/JP2006/311636

§ 371 Date: Oct. 25, 2007

(30) Foreign Application Priority Data
Jun. 10, 2005 (JP) 2005-171488
Jun. 17, 2005 (JP) 2005-177792
Feb. 7, 2006 (JP) 2006-029935
Feb. 8, 2006 (JP) 2006-030693

(51) Int. Cl. C08B 3/06; B29C 47/00

(52) U.S. Cl. 536/69; 264/211.11

(57) ABSTRACT

A cellulose acylate film is stretched in the longitudinal direction by 1-300% under such conditions that the ration of the stretching distance (L) to the width (W) of the film before stretching, i.e., length/width ratio (L/W), is higher than 0.01 and lower than 0.3. The film stretched is relaxed in the longitudinal direction by 1-50% to produce a cellulose acylate film. When this film is incorporated in a liquid-crystal display, it can prevent the occurrence of color unevenness even when used in an high-temperature high-humidity atmosphere.

### TECHNICAL FIELD

The present invention relates to a cellulose acylate film which is stable at a high temperature and humidity and a method for producing the same. More particularly, the invention relates to a cellulose acylate film, in which color unevenness is unlikely to occur when being assembled into a liquid crystal display device and placed at a high temperature and humidity, and a method for producing the same. The invention also relates to a polarizing plate, an optical compensatory film, an anti-reflection film, and a liquid crystal display device using the cellulose acylate film.

### BACKGROUND ART

Recently, an optical film necessary for a liquid crystal display device requires high optical anisotropy. Accordingly, a cellulose acylate film is drawn to attain an in-plane retardation (Re) and a thickness retardation (Rth) and is used as an optical film. In more detail, the cellulose acylate film is used as a retardation film of a liquid crystal display device so as to widen a viewing angle. Recently, as a liquid crystal display device accomplishes upsizing and high definition, dimension stability of an optical film used therein is strongly required. In addition, with respect to a retardation film, an in-plane retardation (Re), a thickness retardation (Rth), a slow axis direction or the like needs to be uniformly controlled in a wide range of the film.

As a method of drawing a cellulose acylate film, there are a method of drawing the cellulose acylate film in a longitudinal (machine) direction (longitudinal drawing method), a method of drawing the cellulose acylate film in a transverse (widthwise) direction (transverse drawing method), and a method of simultaneously drawing the cellulose acylate film in longitudinal and transverse directions (simultaneous drawing method). Among them, the longitudinal drawing method has been conventionally widely used because an apparatus is compact. In general, the longitudinal drawing method is performed by heating a film between at least two pairs of nip rolls at a glass transition temperature (Tg) or more and allowing a carrying speed of the nip rolls at an outlet side to be larger than that of the nip rolls at an inlet side. The longitudinal drawing method using this apparatus has been variously improved. For example, Patent Document 1 discloses an improvement of an angle variation of a slow axis by reversing a longitudinal drawing direction to a casting film-forming direction. Patent Document 2 discloses an improvement of a thickness retardation (Rth) accomplished by stretching under a length/width ratio (L/W) of 0.3 to 2. The length/width ratio described herein indicates a value obtained by dividing the gap L between the nip rolls used for the drawing by the width W of a cellulose acylate film.

However, when the drawn film obtained by each of the methods disclosed in Patent Documents is used as a retardation film of a liquid crystal display device, color unevenness occurs in a liquid crystal display screen with time at a high temperature and high humidity. Such color unevenness remarkably deteriorates the value of the liquid crystal display device and thus an improvement thereof is required.

Meanwhile, when a cellulose acylate film is used as a retardation compensation film and a protective film of a polarizer in a vertical alignment (VA) type liquid crystal display device or the like, a transverse drawing method is preferably employed as a method of drawing a cellulose acylate film. This is because the cellulose acylate film drawn transversely and the polarizer drawn longitudinally can be directly adhered in a roll-to-roll manner and thus the labor of a process is remarkably reduced to increase productivity.

A method of drawing a cellulose acylate film in a transverse direction is disclosed in Patent Document 3 and Patent Document 4. These documents disclose a method of casting a mixture of a cellulose acylate solution, in which hydrogen atoms of a hydroxyl group of cellulose are replaced with an acetyl group and a propionyl group in a casting support, evaporating a portion of a solvent, and transversely drawing a film with a residual solvent in a tenter manner.

As disclosed in Patent Document 3 and Patent Document 4, when a cellulose acylate film is transversely drawn in the tenter manner, characteristics such as a retardation or elastic modulus can be improved by molecular orientation due to the drawing. However, since a distortion due to the drawing remains in a molecular chain, heat shrink of the molecular chain occurs in a high temperature environment or a high humidity environment and a dimension variation increases. When a polarizing plate or a retardation film is produced using such a drawn cellulose acylate film and is adhered to a liquid crystal panel via an adhesive, a panel warpage may be caused by the dimension variation due to a variation in temperature or humidity. In particular, if the size of an optical film increases as the size of a liquid crystal display device increases, this problem becomes serious. Dimension stability of the optical film interposed between the polarizing plate and the liquid crystal cell has large influence on the viewability of the liquid crystal display device. If a conventional cellulose acylate film having bad dimension stability is used, there is a fatal problem that liquid crystal image display unevenness occurs.

The transverse drawing method using the tenter manner disclosed in Patent Document 3 and Patent Document 4 causes a bowing phenomenon and disrupts the uniformity of physical properties in the transverse direction of the film. The bowing phenomenon occurs when the film is transversely drawn in the transverse direction in the tenter and indicates a behavior that a straight line drawn in the transverse direction of the film before the drawing using the tenter is changed to a concave shape or a convex shape in the longitudinal direction of the film after the drawing using the tenter. Due to such a bowing phenomenon, the shift of orientation axis of molecules occurs in the transverse direction in the conventional cellulose acylate film which is transversely drawn in the tenter manner. In more detail, a slow axis is inclined toward the end of the transverse direction of the film from the central portion (the shift of slow axis) and the variations in the retardations Re and Rth increase.

In order to improve the dimension stability of the film, a heat treatment is conventionally performed after the drawing. At this time, as a heating temperature increases, a heat shrink amount decreases. However, if the heating temperature increases, the bowing phenomenon and the optical characteristics (in particular, Re and Rth) deteriorate.

In contrast, in order to suppress the bowing phenomenon, a drawing temperature increases such that drawing stress is kept as low as possible and the heating temperature is kept as low as possible. However, if the drawing temperature is too high, the optical characteristics (in particular, Re and Rth) of the film deteriorate and, if the heating temperature is too low, the dimension stability deteriorates.

Since there is no method of simultaneously accomplishing the improvement of the dimension stability of the drawn cellulose acylate film and the suppression of the bowing phenomenon, color unevenness occurs in a liquid crystal display screen in a high temperature environment or a high humidity environment when the drawn cellulose acylate film is assembled into a liquid crystal display device as a retardation film. In particular, recently, since the size of an optical film increases along with upsizing and high definition of a liquid crystal display device, a need for improving the viewability of a liquid crystal display device by accomplishing the improvement of the dimension stability and the suppression of the bowing phenomenon gradually increases.

[Patent Document 1] Japanese Unexamined Patent Application Publication No. 2002-311240.

[Patent Document 2] Japanese Unexamined Patent Application Publication No. 2003-315551.

[Patent Document 3] Japanese Unexamined Patent Application Publication No. 2002-187960.

[Patent Document 4] Japanese Unexamined Patent Application Publication No. 2003-73485.

### DISCLOSURE OF THE INVENTION

### Problems to be solved by the Invention

Accordingly, an object of the invention is to provide a cellulose acylate film capable of suppressing color unevenness when being assembled into a liquid crystal display device and placed at a high temperature and high humidity. Another object of the invention is to accomplish the improvement of dimension stability of a drawn cellulose acylate film and the suppression of a bowing phenomenon. That is, another object of the invention is to provide a cellulose acylate film having excellent dimension stability in a warm wet or dry heat condition, uniform physical properties in the longitudinal direction and the transverse direction of the film, and the slight shift of a slow axis of the transverse direction and a small variation in retardations Re and Rth, and a method for producing the same. Another object of the invention is to provide a method for producing a cellulose acylate film having such properties easily. Another object of the invention is to provide a polarizing plate, an optical compensatory film, a retardation film, and a anti-reflection film capable of suppressing color unevenness when being assembled into a liquid crystal display device and placed at a high temperature and high humidity, and a liquid crystal display device capable of suppressing color unevenness when being placed at a high temperature and high humidity.

### Means for Solving the Problems

An object of the invention is realized by the invention having the following configuration.

[1] A method for producing a cellulose acylate film, which comprises drawing a cellulose acylate film and relaxing or heating the cellulose acylate film.
[2] The method for producing a cellulose acylate film according to [1], further comprising:

longitudinally drawing the cellulose acylate film by 1% to 300% under the condition that a length/width ratio (L/W) which is a ratio of a drawing length L to a width W of a film before drawing is greater than 0.01 and less than 0.3; and longitudinally relaxing the cellulose acylate film by 1% to 50%.

[3] The method for producing a cellulose acylate film according to [1], wherein the longitudinal drawing is performed by passing the cellulose acylate film obliquely between two pairs of nip rolls.
[4] The method for producing a cellulose acylate film according to [2] or [3], wherein transverse drawing is performed after the longitudinal relaxation is performed.
[5] The method for producing a cellulose acylate film according to [4], wherein the transverse drawing is performed using a tenter with a drawing ratio of 1% to 250%.

The method for producing a cellulose acylate film according to [4] or [5], wherein the film is transversely relaxed by 1% to 50% after the transverse drawing is performed.

[7] The method for producing a cellulose acylate film according to any one of [2] to [6], wherein the cellulose acylate film is formed by a melt-casting film formation method and is drawn.
[8] The method for producing a cellulose acylate film according to [7], wherein the melt-casting film formation method is performed using a touch roll.
[9] The method for producing a cellulose acylate film according to [1], wherein the cellulose acylate film is drawn using the tenter by 5% to 250% in a transverse direction and is heated in a state that binding of chucks at one or both sides of the tenter is released.
[10] The method for producing a cellulose acylate film according to [9], wherein cellulose acylate included in the cellulose acylate film has at least two types of acylate groups having a carbon number of 2 to 7 and satisfies Equations (A) to (C):

2.45≦X+Y≦3.0; Equation (A)

0≦x≦2.45; and Equation (B)

0.3≦y≦3.0 Equation (C)

wherein X denotes the substitution degree of an acetyl group and Y denotes the sum of the substitution degrees of the acyl groups having a carbon number of 3 to 7.
[11] The method for producing a cellulose acylate film according to [9] or [10], wherein the drawing is performed under the condition that a bowing ratio of the cellulose acylate film after the drawing becomes −1 to 1%.
[12] The method for producing a cellulose acylate film according to any one of [9] to [11], wherein the absolute value of an angle between a slow axis direction and a longitudinal direction of the cellulose acylate film after the heating is 89.50 to 90.50.
[13] The method for producing a cellulose acylate film according to any one of [9] to [12], wherein the film is carried with tension of 1 N/m to 70 N/m after the binding of the chuck is released in the tenter.
[14] The method for producing a cellulose acylate film according to any one of [9] to [13], wherein the film is relaxed by 0.1% to 40% in the transverse direction after the transverse drawing and before the heating at a temperature lower than a temperature when the transverse drawing is finished by 0 to 20° C.
[15] The method for producing a cellulose acylate film according to any one of [9] to [14], wherein a temperature distribution upon the transverse drawing in the tenter satisfies the following equation:

1≦Ts−Tc≦5

wherein Tc denotes an average temperature of a central portion of the film and Ts denotes an average temperature of the both ends of the film.
[16] The method for producing a cellulose acylate film according to any one of [9] to [15], wherein the drawing is performed in a state that the quantity of a residual solvent of the cellulose acylate film is 1 mass % or less.
[17] The method according to any one of [9] to [16], wherein the cellulose acylate film is drawn by 0% to 50% in the longitudinal direction before the drawing.
[18] The method for producing a cellulose acylate film according to any one of [10] to [17], wherein the cellulose acylate film having at least two kinds of acylate groups having the carbon number of 2 to 7 and satisfying said Equations (A) to (C) is a film which is formed by a melt-casting film formation method and is drawn using a touch roll.
[19] A cellulose acylate film produced by the method according to any one of [1] to [18].
[20] A cellulose acylate film, wherein a wet heat dimension variation δL(w) and a dry heat dimension variation δL(d) are both in the range of 0% to 0.2%, a wet heat variation δRe(w) and a dry heat variation δRe(d) of an in-plane retardation (Re) are both in the range of 0% to 10%, and a wet heat variation δRth(w) and a dry heat variation δRth(d) of a thickness retardation Rth are both in the range of 0% to 10%.
[21] The cellulose acylate film according to [20], wherein a fine retardation variation is 0% to 10%.
[22] The cellulose acylate film according to [20] or [21], wherein Re is 0 nm to 300 nm and Rth is 30 nm to 500 nm.
[23] The cellulose acylate film according to any one of [20] to [22], wherein Equations (1-1) and (1-2) below are satisfied:

2.5≦A+B<3.0; and Equation (1-1)

1.25≦B<3 Equation (1-2)

wherein A denotes the substitution degree of an acetyl group and B denotes the sum of the substitution degrees of propionyl group, a butyryl group, a pentanoyl group, and a hexanoyl group.
[24] The cellulose acylate film according to any one of [20] to [23], wherein the quantity of a residual solvent is 0.01 mass % or less.
[25] The cellulose acylate film according to any one of [20] to [24], wherein after the cellulose acylate film is formed, the cellulose acylate film is longitudinally drawn by 1% to 300% under the condition that a length/width ratio (L/W) which is a ratio of a drawing length L to a width W of a film before drawing is greater than 0.01 and less than 0.3 and then is longitudinally relaxed by 1% to 50%.
[26] A cellulose acylate film, wherein a dimension variation ratio when the film is suspended for 500 hours in an environment having a temperature of 60° C. and a relative humidity of 90% is −0.1% to 0.1% in a slow axis direction and a direction perpendicular thereto, a dimension variation ratio when the film is suspended for 500 hours in an environment having a temperature of 90° C. and a dry state is −0.1% to 0.1% in the slow axis direction and the direction perpendicular thereto, a thickness variation is 0 to 2 μm, a variation in in-plane retardation Re is 0 to 5 nm, a variation in a thickness retardation Rth is 0 to 10 nm, and the shift of the slow axis is −0.5 to 0.50.
[27] The cellulose acylate film according to [26], wherein cellulose acylate included in the cellulose acylate film has at least two types of acylate groups having a carbon number of 2 to 7 and satisfies Equations (A) to (C):

2.45≦X+Y≦3.0; Equation (A)

0≦x≦2.45; and Equation (B)

0.3≦y≦3.0 Equation (C)

wherein X denotes the substitution degree of an acetyl group and Y denotes the sum of the substitution degrees of the acyl groups having a carbon number of 3 to 7.
[28] The cellulose acylate film according to [26] or [27], wherein the cellulose acylate film obtained by forming the cellulose acylate to a film is drawn by 5% to 250% in the transverse direction using a tenter and is heated in a state that binding of chucks at one or both sides of the tenter is released.
[29] A polarizing plate using at least one cellulose acylate film according to any one of [19] to [28].
[30] The polarizing plate according to [29], wherein at least one cellulose acylate film is laminated on a polarization film.
[31] The polarizing plate according to [29] or [30], wherein the polarizing plate is adhered to a glass plate having a size of 40 inches and a thickness of 0.7 mm, a warpage immediately after the plate is left for 24 hours in an environment having a temperature 60° C. and a relative humidity of 90% is 2 mm or less, and a warpage immediately after the plate is left for 24 hours in an environment having a temperature of 90° C. and a dry state is 2 mm or less.
[32] A retardation film using at least one cellulose acylate film according to any one of [19] to [28].
[33] An optical compensatory film using at least one cellulose acylate film according to any one of [19] to [28].
[34] An anti-reflection film using at least one cellulose acylate film according to any one of [19] to [28].
[35] A liquid crystal display device comprising at least one film selected from the group consisting of the cellulose acylate film according to any one of [19] to [28], the polarizing plate according to any one of [29] to [31], the retardation film according to [32], the optical compensatory film according to [33], and the anti-reflection film according to [34].

### ADVANTAGEOUS EFFECTS OF THE INVENTION

A cellulose acylate film according to the invention can suppress color unevenness when being assembled into a liquid crystal display device and placed at a high temperature and high humidity. According to the invention, it is possible to provide a cellulose acylate film having excellent dimension stability in wet heat and dry heat environments and the slight shift of a slow axis of the transverse direction and small variations in retardations Re and Rth. This cellulose acylate film has uniform optical characteristics necessary for a large-sized liquid crystal display device. In a production method according to the invention, it is possible to efficiently produce a cellulose acylate film having such properties. A polarizing plate, an optical compensatory film, a retardation film, a anti-reflection film, and a liquid crystal display device according to the invention has excellent functions even at a high temperature and high humidity.

### BRIEF DESCRIPTION OF THE DRAWINGS

FIG. 1 is a schematic diagram of an apparatus for obliquely passing a film, longitudinally drawing the film, and longitudinally relaxing the film.

FIG. 2 is a schematic diagram of a conventional longitudinally drawing apparatus.

FIG. 3 is a schematic diagram showing the configuration of an extruder.

FIG. 4 is a schematic diagram showing the configuration of an apparatus for melting and forming a film, which includes a touch roll and a casting roll.

FIG. 5 is a schematic diagram of a tenter which can be preferably used in the invention.

FIG. 6 is a plane view of a cellulose acylate film in the tenter.

FIG. 7 is a schematic diagram of an embodiment of an apparatus for melting and forming a film according to a touch roll method.

Reference numerals 1a and 1b denote first nip rolls, 2a and 2b denote second nip rolls, 3 denotes a carrying roll, L denotes a drawing length, 22 denotes an extruder, 32 denotes a cylinder, 40 denotes a supply port, A denotes a feed zone, B denotes a compression zone, C denotes a metering zone, 51 denotes an extruder, 52 denotes a die, 53 denotes a molten material (melt), 54 denotes a touch roll, 61 to 63 denote cast rolls, 1 denotes a cellulose acylate film, 2 denotes a bowing marker, 3 denotes a bowing line, 4 denotes a device for detaching a chuck or a slit device of the end of a film, 5 denotes a chuck, 6 denotes a tenter clip rail, 7 denotes a tension cut roll, 11 denotes a central line of a cellulose acylate film, 12 denotes a cellulose acylate film, 14 denotes a multi-type casting drum, 23 denotes a touch roll, 24 denotes a die, 26 denotes a first casting drum, 28 denotes a second casting drum, 30 denotes a third casting drum, 31 denotes a nip roll, A denotes a feed zone, B denotes a compression zone, C denotes a metering zone, E denotes a preheat zone, F denotes a drawing zone, G denotes a relaxation zone, and H denotes a heating zone.

### DETAILED DESCRIPTION OF THE INVENTION

The cellulose acylate film, and their production methods and their applications are described in detail hereinunder. The description of the constitutive elements of the invention given hereinunder may be for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### Cellulose Acylate Film

### <<Feature>>

The invention provides a cellulose acylate film capable of suppressing color unevenness when being when being assembled into a liquid crystal display device and placed at a high temperature and high humidity. In particular, the invention provides a cellulose acylate film (hereinafter, referred to as a first cellulose acylate film of the invention) in which any one of a wet heat dimension variation δL(w) and a dry heat dimension variation δL(d) is 0% to 0.2%, any one of a wet heat variation δRe(w) and a dry heat variation δRe(d) of an in-plane retardation (Re) is 0% to 10%, and any one of a wet heat variation δRth(w) and a dry heat variation δRth(d) of a thickness retardation (Rth) is 0% to 10% and a cellulose acylate film (hereinafter, referred to as a second cellulose acylate film of the invention) in which a dimension variation when being suspended for 500 hours at a temperature of 60° C. and a relative humidity of 90% is −0.1% to 0.1% in a slow axis direction and a direction perpendicular thereto, a dimension variation when being suspended for 500 hours at a temperature of 90° C. and a dry state is −0.1% to 0.1% in a slow axis direction and a direction perpendicular thereto, a thickness variation is 0 to 2 μm, a variation in in-plane retardation Re is 0 to 5 nm, a variation in thickness retardation Rth is 0 to 10 nm, and the shift of slow axis is −0.5 to 0.5°.

### <<First Cellulose Acylate Film>> (δL(w) and δL(d))

δL(w) described herein indicates a dimension variation before and after 500 hours at a temperature of 60° C. and a relative humidity of 90% and δL(d) described herein indicates a dimension variation before and after 500 hours at a temperature of 80° C. and a dry state. Any one of δL(w) and δL(d) is preferably 0% to 0.2%, more preferably 0% to 0.15%, and most preferably 0% to 0.1%. Both L(w) and δL(d) are preferably 0% to 0.2%, more preferably 0% to 0.15%, and most preferably 0% to 0.1%.

In a roll film, δL(w) indicates the larger value between a dimension variation δTD(w) of a transverse (TD) direction and a dimension variation δMD(w) of a longitudinal direction (MD) expressed by the following equations:

δTD(w)(%)=100×|TD(F)−TD(t)|/TD(F); and

δMD(w)(%)=100×|MD(F)−MD(t)|/MD(F)

wherein TD(F) and MD(F) respectively indicate a dimension obtained by measuring the film, which is left for 5 hours or more at a temperature of 25° C. and a relative humidity of 60%, at the atmosphere before a thermal process, and TD(t) and MD(t) respectively indicate a dimension obtained by measuring the film, which is left for 5 hours or more at a temperature of 25° C. and a relative humidity of 60%, at the atmosphere after the thermal process (for 500 hours at a temperature of 60° C. and a relative humidity of 90%).

In a roll film, δL(d) indicates the larger value between a dimension variation δTD(d) of a transverse (TD) direction and a dimension variation δMD(d) of a longitudinal direction (MD) expressed by the following equation. The dry state described herein indicates a state in which a relative humidity is 10% or less:

δTD(d)(%)=100×|TD(F)−TD(T)|/TD(F); and

δMD(d)(%)=100×|MD(F)−MD(T)|/MD(F)

wherein TD(F) and MD(F) respectively indicate a dimension obtained by measuring the film, which is left for 5 hours or more at a temperature of 25° C. and a relative humidity of 60%, at the atmosphere before a thermal process, and TD(t) and MD(t) respectively indicate a dimension obtained by measuring the film, which is left for 5 hours or more at a temperature of 25° C. and a relative humidity of 60%, at the atmosphere after the thermal process (for 500 hours at a temperature of 80° C. and a dry state).

In a sheet film cut out from the roll, δL(w) indicates the larger value between a dimension variation δFD(w) of a direction (FD) perpendicular to an in-plane slow axis and a dimension variation δSD(w) of an in-plane slow axis (SD) direction expressed by the following equations:

δFD(w)(%)=100×|FD(F)−FD(t)|/FD(F); and

δSD(w)(%)=100×|SD(F)−SD(t)|/SD(F)

wherein FD(F) and SD(F) respectively indicate a dimension obtained by measuring the film, which is left for 5 hours or more at a temperature of 25° C. and a relative humidity of 60%, at the atmosphere before a thermal process, and FD(t) and SD(t) respectively indicate a dimension obtained by measuring the film, which is left for 5 hours or more at a temperature of 25° C. and a relative humidity of 60%, at the atmosphere after the thermal process (for 500 hours at a temperature of 60° C. and a relative humidity of 90%).

In a sheet film cut out from the roll, δL(d) indicates the larger value between a dimension variation δFD(d) of a direction (FD) perpendicular to an in-plane slow axis and a dimension variation δSD(d) of an in-plane slow axis (SD) direction expressed by the following equation. The dry state described herein indicates a state in which a relative humidity is 10% or less:

δFD(d)(%)=100×|FD(F)−FD(T)|/FD(F); and

δSD(d)(%)=100×|SD(F)−SD(T)|/SD(F)

wherein FD(F) and SD(F) respectively indicate a dimension obtained by measuring the film, which is left for 5 hours or more at a temperature of 25° C. and a relative humidity of 60%, at the atmosphere before a thermal process, and FD(T) and SD(T) respectively indicate a dimension obtained by measuring the film, which is left for 5 hours or more at a temperature of 25° C. and a relative humidity of 60%, at the atmosphere after the thermal process (for 500 hours at a temperature of 80° C. and a dry state).

### (δRe(w), δRe(d), δRth(w) and δRth(d))

δRe(d) and δRth(d) described in the invention are variations in Re and Rth before and after 500 hours at a temperature of 80° C. and a dry state expressed by the following equation, respectively. The dry state described herein indicates a state in which a relative humidity is 10% or less:

δRe(d)(%)=100×|Re(F)−Re(T)/Re(F); and

δRth(d)(%)=100×|Rth(F)−Rth(T)|/Rth(F)

wherein Re(F) and Rth(F) respectively indicate Re and Rth before 500 hours at a temperature of 80° C. and a dry state and Re(T) and Rth(T) respectively indicate Re and Rth after 500 hours at a temperature of 80° C. and a dry state.

δRe(w) and δRth(w) described in the invention are variations in Re and Rth before and after 500 hours at a temperature of 60° C. and a relative humidity of 90% expressed by the following equation, respectively:

δRe(w)(%)=100×|Re(F)−Re(t)|/Re(F); and

δRth(w)(%)=100×|Rth(F)−Rth(t)|/Rth(F)

wherein Re(F) and Rth(F) respectively indicate Re and Rth before 500 hours at a temperature of 60° C. and a relative humidity of 90% and Re(t) and Rth(t) respectively indicate Re and Rth after 500 hours at a temperature of 60° C. and a relative humidity of 90%.

Any one of δRe(w), δRe(d), δRth(w) and δRth(d)) is preferably 0% to 10%, more preferably 0% to 5%, and most preferably 0% to 2%. All of (δRe(w), δRe(d), δRth(w) and δRth(d)) are preferably 0% to 10%, more preferably 0% to 5%, and most preferably 0% to 2%.

### (Fine Retardation Variation)

In the invention, fine retardation variation is preferably 0% to 10%, more preferably 0% to 8%, and most preferably 0% to 5%, thereby reducing color variation. Such fine retardation variation was not really acknowledged as a problem conventionally, but causes a problem in high definition of a liquid crystal display device.

The fine retardation variation described herein indicates variation in retardation which occurs in a small region having a size of 1 mm or less and is measured by the following method. That is, in a roll film, a length of 1 mm in a transverse (TD) direction and a length of 1 mm in a longitudinal (MD) direction are taken, an in-plane retardation Re is measured with a pitch of 0.1 mm, a difference between a maximum value and a minimum value thereof is divided by an average value to express a percentage, and the larger value between the percentage of MD and the percentage of TD is the fine retardation variation. In a sheet film, a length of 1 mm in an in-plane slow direction (SD) and a length of 1 mm in a direction (FD) perpendicular to the in-plane slow axis are taken, an in-plane retardation Re is measured with a pitch of 0.1 mm, a difference between a maximum value and a minimum value thereof is divided by an average value to express a percentage, and the larger value between the percentage of SD and the percentage of FD is the fine retardation variation.

An in-plane retardation Re of a cellulose acylate film of the invention is preferably 0 nm to 300 nm, more preferably 20 nm to 200 nm, and most preferably 40 nm to 150 nm. A thickness retardation Rth thereof is preferably 30 nm to 500 nm, more preferably 50 nm to 400 nm, and most preferably 100 nm to 300 nm. It is preferable that Re≦Rth is satisfied and it is more preferable that Re×2≦Rth is satisfied.

In the present specification, Re and Rth denote the in-plane retardation and the retardation in the thickness direction at a wavelength of 590 nm, respectively. The Re is measured by inputting light having a wavelength of 590 nm in the normal direction of the film in KOBRA 21ADH or WR (made by Oji Scientific Instruments).

When the measured film is represented by a uniaxial or biaxial index ellipsoid, the Rth is calculated by the following method.

When light having a wavelength of 590 nm from an inclined direction from −50° to +50° by 10° in the normal direction of the film as an in-plane slow axis (determined by KOBRA 21ADH or WR) as a tilt angle (rotation angle)(any direction in the plane of the film becomes the tilt axis if there is no a slow axis) is input and the Re is measured at 11 points, the Rth is calculated by KOBRA 21ADH or WR based on the measured retardation value, an average refractive index and a film thickness.

In a film having a direction in which the retardation value is zero at any angle using the in-plane slow axis as the tilt axis from the normal direction, the retardation value at a tilt angle larger than the tilt angle is calculated by KOBRA 21ADH or WR after the sign thereof is changed to a negative sign.

The Rth may be calculated from Formula (b) and Formula (c) based on the average refractive index, the film thickness, and the retardation value measured from two inclined directions using the slow axis as the tilt angle (rotation angle)(any direction in the plane of the film becomes the tilt axis if there is no a slow axis).

$$\begin{matrix}[ Number 1 ] & Formula ( b ) \\ Re ( θ ) = [ nx - \frac{( ny \times nz )}{( \sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}} )} ] \times \frac{d}{cos \{ {sin}^{- 1} ( \frac{sin ( - θ )}{nx} ) \}} & \end{matrix}$$

In Formula, Re(θ) denotes the retardation value in the direction inclined by an angle θ from the normal direction, nx denotes the refractive index of the slow axis of the plane, ny denotes the refractive index in the direction orthogonal to nx in the plane, and nz denotes the refractive index in the direction orthogonal to nx and ny.

Rth=((nx+ny)/2−nz)×d Formula (c)

If the measured film is not represented by the uniaxial or biaxial index ellipsoid, that is, if the measured film is a film without an optic axis, Rth is calculated by the following method.

When light having a wavelength of 590 nm from an inclined direction from −50° to +50° by 100 in the normal direction of the film as an in-plane slow axis (determined by KOBRA 21ADH or WR) as a tilt angle (rotation angle) is input and the Re is measured at 11 points, the Rth is calculated by KOBRA 21ADH or WR based on the measured retardation value, an average refractive index and a film thickness.

By inputting the average refractive index and the film thickness, KOBRA 21ADH or WR calculates nx, ny and nz. From the calculated nx, ny and nz, Nz=(nx−nz)/(nx−ny) is calculated.

In the above measurement, values described in Polymer Handbook (JOHN WILEY & SONS, INC) and catalog values of a variety of optical films may be used as assumed values of an average refractive index. The value of the average refractive index which is not previously known may be measured by the Abbe refractometer. The values of the average refractive indexes of the optical films are as follow: cellulose acylate (1.48), cycloolefin polymer (1.52), polycarbonate (1.59), polymethylmethacrylate (1.49), and polystyrene (1.59).

### (Executing Means)

A method for producing a cellulose acylate film having the features according to the invention is not specially limited. For example, the cellulose acylate film having the features may be produced by selecting and combining the following (1) to (4). In particular, according to a production method of the invention necessarily including the following (1) and (2), it is possible to easily produce the cellulose acylate film having the features.

### (1) Length/Width Ratio

In the production method of the invention, a formed cellulose acylate film is longitudinally drawn in a length/width ratio (a ratio of the gap between the nip rolls (drawing length L) to the width of a film before the drawing (W): (L/W)) in a range from greater than 0.01 to less than 0.3. The length/width ratio is more preferably 0.03 to 0.25 and most preferably 0.05 to 0.2. The longitudinal drawing is generally performed between two pairs of nip rolls at a circumferential velocity. The small length/width ratio indicates that the length which film being drawn is small. The film is rapidly drawn in a short time. Since the film is rapidly drawn, orientation becomes strong and thus δL(w), δL(d), δRe(w), δRe(d), δRth(w) and δRth(d)) due to orientation relaxation can be reduced. Conventionally, the length/width (L/W) was generally about 1 (about 0.7 to 1.5).

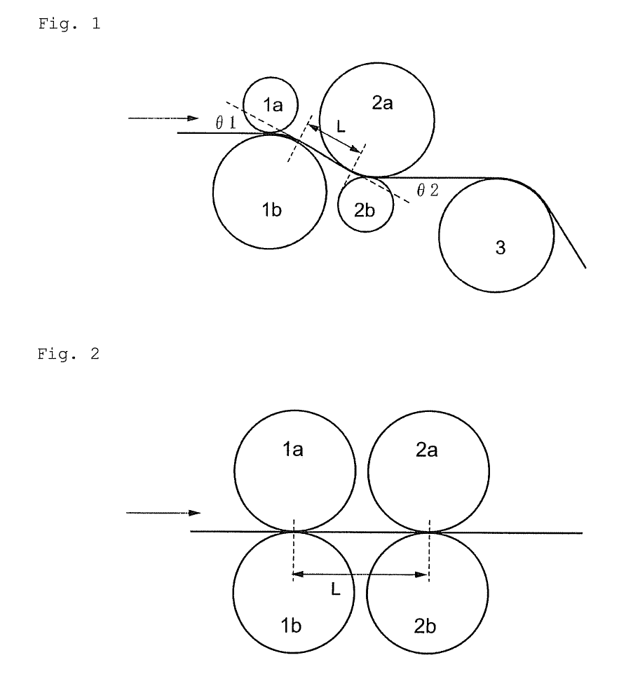

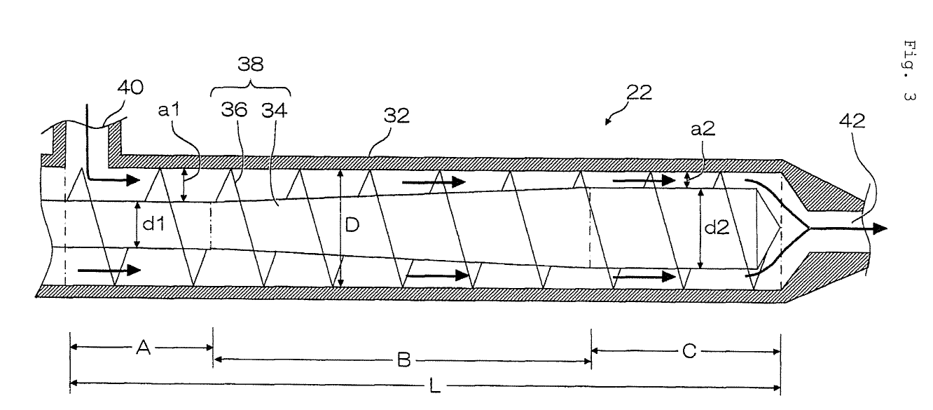

In order to draw the film with such a small length/width ratio, as shown in FIG. 1, it is preferable that a cellulose acylate film obliquely passes between the first nip rolls 1a and 1b and the second nip rolls 2a and 2b (in the drawing, the film is carried in a direction denoted by an arrow). The drawing is performed in a space in which the film is separated from the first nip rolls and is in contact with the second nip rolls. Accordingly, in order to reduce a distance (that is, a drawing length L) between the contacts of the film and the nip roll, as shown in FIG. 1, it is preferable that the film obliquely passes between the nip rolls. In the present specification, the “film obliquely pass” indicates that at least one of an angle θ1 between the film between the nip rolls 1a and 1b and the film between the nip rolls 1a and 1b and the nip rolls 2a and 2b and an angle θ2 between the film between the nip rolls 1a and 1b and the nip rolls 2a and 2b and the film between the nip rolls 2a and 2b is not 0°. The angles θ1 and θ2 are preferably 1° to 85°, more preferably 2° to 60°, and most preferably 3° to 40°. As shown in FIG. 2, since the film is drawn between the first nip rolls 1a and 1b and the second nip rolls 2a and 2b at θ1 and θ2 as 0°, L cannot be set to be equal to or smaller than the diameter of the nip roll.

In order to rapidly draw the film as described above, a drawing speed is preferably large, that is, the drawing speed is preferably 10 m/min to 100 m/min, more preferably 20 m/min to 80 m/min, and most preferably 30 m/min to 60 m/min. The drawing speed described herein indicates a speed for carrying the film, which is not drawn, by the first nip rolls in the drawing process.

The longitudinal drawing is preferably at a glass transition temperature (Tg) to (Tg+50° C.) of the film, more preferably (Tg+5° C.) to (Tg+40° C.), and most preferably (Tg+8° C.) to (tg+30° C.). A longitudinal drawing ratio is preferably 1% to 300%, more preferably 3% to 200%, and most preferably 5% to 150%. The drawing ratio described herein is obtained by the following equation.

Drawing ratio (%)=100×{(length after drawing)−(length before drawing)}/(length before drawing)

Tg of the cellulose acylate film is preferably 80° C. to 200° C., more preferably 90° C. to 180° C., and most preferably 100° C. to 160° C. Tg of the cellulose acylate film described herein indicates Tg of the film including additives, not Tg of cellulose acylate alone.

The longitudinal drawing and the transverse drawing of the invention is performed at a dry state in which a residual solvent is preferably 0.5 mass % or less, more preferably 0.3 mass % or less, and most preferably 0.1 mass % or less.

### (2) Longitudinal Relaxation

In the production method of the invention, the film is longitudinally relaxed by preferably 1% to 50%, more preferably 1% to 30%, and most preferably 1% to 15% after the longitudinal drawing. The longitudinal relaxation is preferably performed after the longitudinal drawing and before the transverse drawing and is more preferably performed immediately after the longitudinal drawing. The longitudinal relaxation may be performed by decreasing the speed of a carrying roll after the longitudinal drawing. For example, in the apparatus shown in FIG. 1, the longitudinal relaxation may be performed by setting the speed of the carrying roll 3 to be smaller than that of the second nip rolls 2a and 2b. In order to accomplish the relation ratio, the speed of the carrying roll 3, for example, decreases as follows. That is, in a drawing ratio Z(%) and a relaxation ratio Y(%), if the carrying speed of the nip rolls 1a and 1b located at an inlet side is V (m/min), the carrying speed of the nip rolls 2a and 2b located at an outlet side becomes V×(100+Z)/100 and the speed of the carrying roll 3 provided next to the nip rolls located at the outlet side becomes V×{100+(Z−Y)}/100.

The temperature of the longitudinal relaxation is preferably (Tg−20° C.) to (Tg+50° C.), more preferably (Tg−15° C.) to (Tg+40° C.), and most preferably (Tg−10° C.) to (Tg+30° C.). The “relaxation ratio” described herein indicates a value obtained by dividing a relaxation length by the dimension of the film before drawing.

That is, if the length of the film before drawing is 100 cm, the length of the film becomes 130 cm when the film is longitudinally drawn by 30%, and the length of the film becomes 120 cm when the relaxation is performed with a relaxation ratio of 10%.

By performing the longitudinal relaxation, distortion which remains in the film due to the drawing can be efficiently opened and thus δL(w), δL(d), δRe(w), δRe(d), δRth(w), and δRth(d) can be reduced.

It is possible to reduce the fine retardation variation of the cellulose acylate film obtained by (1) the rapid drawing and (2) the longitudinal relaxation according to the production method of the invention. That is, when the film is drawn by increasing the length/width ratio and increasing the drawing length, since the film is sequentially drawn from a place where the thickness of the film is small and thus the film is easily drawn, the fine retardation variation is apt to appear. In contrast, when the film is rapidly drawn by decreasing the length/width ratio according to the invention, it is possible to reduce the fine retardation variation due to drawing unevenness. When the longitudinal relaxation is performed according to the invention, the fine retardation variation can be reduced by opening the remaining distortion. That is, a more drawn portion is relaxed and thus the fine retardation variation due to drawing unevenness can be reduced.

### (3) Transverse Drawing

In the production of the cellulose acylate film, the transverse drawing is preferably performed after the longitudinal drawing and the longitudinal relaxation. The drawing ratio is preferably 1% to 250%, more preferably 10% to 200%, and most preferably 30% to 150%. The drawing temperature is preferably (Tg) to (Tg+50° C.), more preferably (Tg+5° C.) to (Tg+40° C.), and most preferably (Tg+8° C.) to (Tg+30° C.). The transverse drawing is preferably performed using a tenter.

Subsequent to the transverse drawing, relaxation is preferably performed by 1% to 50%, more preferably 1% to 30%, and most preferably 1% to 10% in the transverse direction. The “relaxation ratio” described herein indicates a value obtained by dividing a relaxation length by the dimension of the film before drawing.

### (4) Substitution Degree of Cellulose Acylate

In the production of the cellulose acylate film, cellulose acylate satisfying the following equations (1-1) and (1-2) is preferably used. A indicates the substitution degree of an acetyl group, and B indicates the sum of the substitution degrees of propionyl group, a butyryl group, a pentanoyl group, and a hexanoyl group. The “substitution degree” described in the present specification indicates the sum of a substitution ratio of hydrogen atoms of 2-, 3- and 6-position hydroxyl groups of cellulose. If the hydrogen atoms of all the 2-, 3- or 6-position hydroxyl groups are substituted with acyl groups, the substitution degree becomes 3. In the cellulose acylate satisfying the following equations (1-1) and (1-2), Re and Rth are apt to appear and thus the drawing ratio can decrease. As a result, δL(w), δL(d), δRe(w), δRe(d), δRth(w), and δRth(d) due to the distortion during drawing can be reduced. In addition, the fine retardation variation due to the drawing unevenness can be reduced.

2.5≦A+B<3.0, Formula (1-1)

1.25≦B<3. Formula (1-2)

More preferred is:

2.55≦A+B≦3.0, Formula (1-3)

0≦A≦2.0, Formula (1-4)

1.25≦B≦2.9. Formula (1-5)

Even more preferred is:

2.6≦A+B≦3.0, Formula (1-6)

0.05≦A≦1.8, Formula (1-7)

1.3≦B≦2.9. Formula (1-8)

Particular preferred is:

2.5≦A+B≦2.95, Formula (1-9)

0.1≦A ≦1.6, Formula (1-10)

1.4≦B≦2.9. Formula (1-11)

One kind or at least two kinds of cellulose acylate may be used in the invention. A high-molecular component may be properly mixed, instead of the cellulose acylate.

The substitution degree of the acyl group may be determined by using any one or a combination of a method based on ASTM D-817-91, a method of completely hydrolyzing cellulose acylate and determining the quantity of released carboxylic acid or salt thereof with gas chromatography or high-speed liquid chromatography and a method using ¹H-NMR or ¹³C-NMR.

### <<Second Cellulose Acylate Film>>

Next, a second cellulose acylate film of the invention will be described.

A dimension variation ratio due to a wet heat process and a dimension variation ratio due to a dry heat process of the cellulose acylate film of the invention are preferably −0.1% to 0.1%, more preferably −0.08% to 0.08%, and most preferably −0.06% to 0.06%.

The dimension variation ratio due to the wet heat process and a dimension variation ratio due to the dry heat process of the film are measured using an automatic pin gauge (made by Shinto Scientific Co., Ltd.). In the measurement, five sample pieces having a length of 150 mm and a width of 50 mm in the slow axis direction of the film and the direction perpendicular thereto are sampled. At this time, if the film is uneven in the slow axis direction, the slow axis direction is determined using the average value thereof. In the film having a roll shape, when five sample pieces having a length of 150 mm and a width of 50 mm in longitudinal direction (MD)(equal to the casting direction) of the film and the transverse direction (TD) (transverse direction) are sampled, these sample pieces are equal to the sample pieces obtained in the slow axis direction of the film and the direction perpendicular thereto (Hereinafter, it is equally treated when the “slow axis direction and the direction perpendicular thereto” apply to the film having the roll shape). Holes having 6 mmφ are formed in the both ends of each sample piece with an interval of 100 mm using a punch and the humidity is controlled for 24 hours or more in a chamber having a temperature of 25° C. and a relative humidity of 60%, and an original dimension L1 of the punch interval is measured using the pin gauge up to a minimum scale of 1/1000 mm. Next, each sample piece is suspended without a load in a constant-temperature device having a temperature of 60° C. and a relative humidity of 90% or an oven having a temperature of 90° C. and a dry state and is heated for 500 hours, the humidity is controlled for 24 hours in a chamber having a temperature 25° C. and a relative humidity of 60%, and a dimension L2 of the punch interval after the heating treatment is measured using the automatic pin gauge. The dry state described herein indicates the state that the relative humidity is 10% or less. Based on the measured results, the dimension variation ratio can be calculated by the following equation. The dimension variation ratio described herein is an average value of the five sample pieces.

Dimension variation ratio (%)={(L2−L1)/L1}×100

The variation in the in-plane retardation Re of the cellulose acylate film of the invention is preferably 0 to 5 nm, more preferably 0 to 4 nm, and most preferably 0 to 3 nm. The variation of the thickness retardation Rth of the cellulose acylate film of the invention is preferably 0 to 10 nm, more preferably 0 to 8 nm, and most preferably 0 to 5 nm.

The variations in Re and Rth are obtained by sampling a plurality of 3 cm×3 cm sample pieces in the slow axis direction of the film and the direction perpendicular thereto, measuring Re and Rth by the above-described method, and calculating an average of differences between measured values and an average value.

Re and Rth of the cellulose acylate film of the invention preferably satisfy the following equations:

0≦Re≦300; and

20≦Rth≦500.

Re and Rth of the cellulose acylate film of the invention more preferably satisfy the following equations:

0≦Re≦200; and

30≦Rth≦400.

Re and Rth of the cellulose acylate film of the invention most preferably satisfy the following equations:

0≦Re≦150; and

40≦Rth≦350.

The shift of the slow axis of the cellulose acylate film of the invention is preferably −0.4 to 0.4°, more preferably −0.3 to 0.3°, and most preferably −0.2 to 0.2°.

The shift of the slow axis of the film is obtained by sampling a plurality of 3 cm×3 cm sample pieces in the slow axis direction of the film, measuring the slow axis direction of each sample, and calculating an average of differences between measured values and an average value.

When the cellulose acylate film has a roll shape, a slow axis angle (the absolute value of an angle between the slow axis direction and the longitudinal direction) is preferably 89.5° to 90.5°, more preferably 89.6° to 90.4°, and most preferably 89.7° to 90.3°. The thickness of the cellulose acylate film of the invention is preferably 30 to 200 μm, more preferably 35 μm to 150 μm, and most preferably 35 μm to 100 μm. The thickness variation of the cellulose acylate film of the invention is preferably 0 to 2 μm, more preferably 0 to 1.5 μm, and most preferably 0 to 1 μm. The thickness is obtained by sampling a plurality of sample pieces of the film, and measuring the thickness thereof, and calculating an average value, and the thickness variation is obtained by calculating an average of differences between measured values and an average value.

Both the warpage due to the wet heat process and the warpage due to the dry heat process of the cellulose acylate film of the invention are 2 mm or less, preferably 1.5 mm or less, further more preferably 1.0 mm or less, and most preferably 0.5 mm or less.

The warpage is the curved height of the longitudinal direction of glass immediately after a polarizing plate of the cellulose acylate film adhered to a 40-inch glass plate with a thickness of 0.7 mm is left for 24 hours at a temperature of 60° C. and a relative humidity of 90% or at a temperature of 90° C. and a dry state. The measurement is performed by a caliper having measurement precision of 0.001 mm and a maximum value of the curved portion of the longitudinal direction of the glass plate is set to the warpage.

In cellulose acylate which configures the cellulose acylate film of the invention, the substitution degree of the 2-, 3- and 6-position hydroxyl group of the cellulose is not specially limited. Since the cellulose acylate in which the substitution degree of the 6-position hydroxyl group is preferably 0.8 or more, more preferably 0.85 or more, and most preferably 0.90 or more has high solubility, it is possible to produce a good solution against non-chlorine based organic solvent when the cellulose acylate in which the substitution degree of the 6-position is high is used.

The cellulose acylate composing the cellulose acylate film of which the cellulose acylate preferably satisfies the all following formulae (A) to (C). Wherein X represents a substitution degree for an acetyl group; Y represents a total substitution degree for an acyl group of which having 3 to 7 carbon atoms.

2.45≦X+Y≦3.0, Formula (A)

0≦x≦2.45, Formula (B)

0.3≦y≦3.0; Formula (C)

The cellulose acylate of the invention more preferably satisfies all the following formulae (D) to (F) and even more preferably satisfies all the following formulae (G) to (I):

2.50≦X+Y≦3.0, Formula (D)

0.1≦x≦2.4, Formula (E)

0.5≦y≦3.0. Formula (F)

2.50<X+Y<2.99, Formula (G)

0.15≦x≦2.0, Formula (H)

0.7≦y≦2.99. Formula (I)

One kind or at least two kinds of cellulose acylate may be used. A high-molecular component may be properly mixed, instead of the cellulose acylate.

Target acyl groups having carbon numbers of 3 to 7 of the substitution degree Y preferably include a propionyl group, a butyryl group, a 2-methylpropionyl group, a pentanoyl group, 3-methylbutyryl group, 2-methylbutyryl group, 2,2-dimethylpropionyl (pivaloyl) group, a hexanoyl group, 2-methylpentanoyl group, 3-methylpentanoyl group, 4-methylpentanoyl group, 2,2-dimethylbutyryl group, 2,3-dimethylbutyryl group, 3,3-dimethylbutyryl group, a cyclopentanecarbonyl group, a heptanoyl group, a cyclohexanecarbonyl group, and a benzoyl group, more preferably, a propionyl group, a butyryl group, a pentanoyl group, a hexanoyl group, and a benzoyl group, further more preferably, a propionyl group, a butyryl group, and most preferably a propionyl group

### (Executing Means)

The method for producing the cellulose acylate film having the above features of the invention is not specially limited. For example, the cellulose acylate film having the above features can be produced by properly selecting and combining the following (1) and (2). In particular, according to the production method of the invention necessarily including the following (1), it is possible to simultaneously suppress the dimension variation due to the wet heat process or the dry heat process, the shift of the slow axis, and the variation in the retardation in the longitudinal direction and the transverse direction and to easily produce the cellulose acylate film having the above features.

### (1) Binding Force of at Least One Chuck is Removed in a Tenter and Low-Tension Heating Treatment is Performed

The present inventors examined the cause of the dimension variation due to the wet heat process or the dry heat process of the cellulose acylate film produced by the conventional drawing technology and knew that, because the distortion due to drawing remains in the molecular chain, the remaining distortion of the molecular chain is opened and shrunk due to the wet heat process or the dry heat process. As a result of examining a drawing method for preventing the distortion due to drawing from remaining in the molecular chain, it is found that the remaining distortions in the longitudinal direction and the transverse direction can be simultaneously reduced by performing a heat treatment in a state that the binding force of a chuck (tenter clip) for gripping the both ends of the film in the tenter after drawing and decreasing the binding force of the film in the longitudinal direction and the transverse direction. In order to remove the binding force of the chuck, only one chuck may be detached or both the chucks may be detached. The binding force of the chuck may be substantially removed by decreasing the distance between the chucks for gripping the both ends of the film. In more detail, a tenter which is designed to decrease the interval between the tenter clip rails for guiding the movement route of the chuck may be used. It is possible to suppress the dimension variation of the film due to the wet heat process or the dry heat process and, at the same time, to reduce a bowing phenomenon by removing the binding force of at least one chuck in the tenter and performing a low-tension heat treatment.

### (2) The Temperature of the Drawing Tenter is Controlled

The present inventors examined a method of suppressing the bowing phenomenon and found that a temperature distribution of each zone of the longitudinal direction and a temperature distribution of the transverse direction in the drawing tenter control the bowing phenomenon. The drawing tenter which can be preferably used in the invention includes at least a preheat zone, a drawing zone, a relaxation zone, and a heating zone. It is possible to reduce the bowing phenomenon by controlling the temperature distributions of the drawing zone, the relaxation zone, and the heating zone. When a temperature difference occurs in the transverse direction of the film in each zone and a temperature gradient is given such that the temperature of the central portion of the film is slightly lower than that of the ends of the film, the drawing stress of the transverse direction of the film becomes uniform and the bowing phenomenon can be further reduced.

### (Drawing Process Using Tenter)

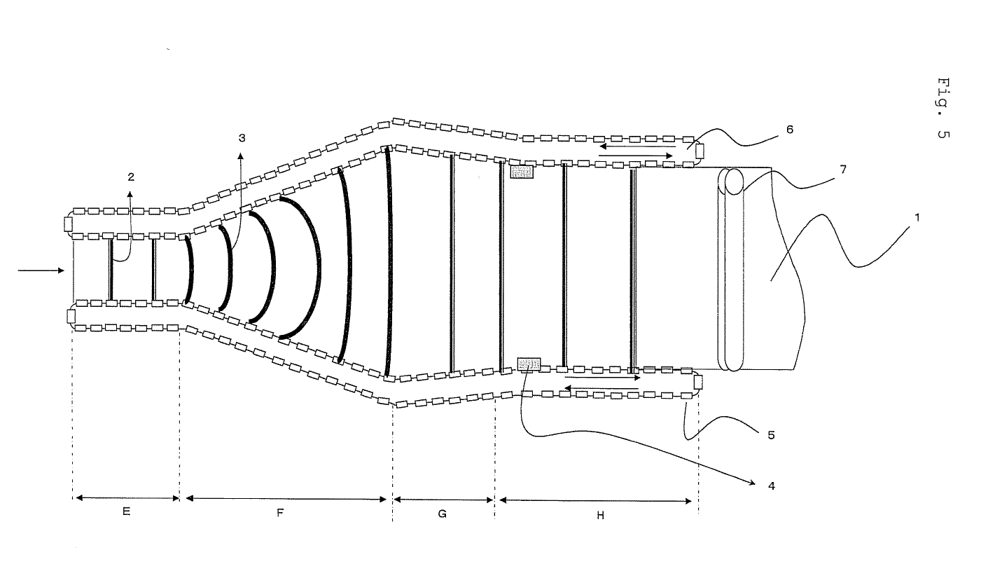

Hereinafter, a condition for processing the cellulose acylate film using the tenter will be described in detail. FIG. 5 is a schematic diagram of the tenter which can be preferably used in the invention. The tenter shown in FIG. 5 includes a preheat zone E, a drawing zone F, a relaxation zone G, and a heating zone H. In the tenter, the drawn cellulose acylate film (hereinafter, it may be referred to as a cellulose acylate film material produced by casting) is inserted between the both ends by the chucks (tenter clip) 5 which run on the tenter clip rails 6 and is moved in a direction denoted by an arrow. In the tenter used in the invention, the binding force of at least one chuck is removed by a device 4 for removing the binding force of the chuck provided in the heating zone H for heat treatment. The bowing marker 2 drawn in the cellulose acylate film before drawing is distorted by a non-linear shape like a bowing line 3, but the distortion of the bowing line of the cellulose acylate film 1 after drawing, which is obtained by a tension cut roll 7, is reduced. In the invention, a bowing ratio indicating the distortion degree of the bowing line is preferably −1 to 1%, more preferably −0.8% to 0.8%, and most preferably −0.5 to 0.5%. The bowing ratio described herein is calculated by the following equation from a maximum convex amount or a maximum concave amount when the linear bowing line drawn in the transverse direction on the surface of the film before performing the transverse drawing is retracted in a concave shape or a convex shape with respect to the longitudinal direction of the film after tenter drawing to be distorted in an arched line. At this time, a bowing line having a convex shape with respect to the traveling direction of the film is negative (−) and a bowing line having a concave shape is positive (+)

Bowing ratio (%)=maximum convex amount or concave amount of bowing line (mm)/entire width (mm)×100.

Hereinafter, the transverse drawing process will be described in detail according to the sequence of the zones in the tenter.

### (Preheat Zone)

The preheat zone is a zone for inserting the both ends of the cellulose acylate film between the chucks (tenter clip), moving the chucks for inserting the both ends of the film in parallel, and preheating the film while carrying the film without drawing.

The temperature of the preheat zone is preferably set in a range of (Tg−30° C.) to (Tg+30° C.) and may be adjusted according to the condition of the bowing phenomenon. When the bowing line has a convex shape at the outlet of the tenter in the traveling direction, the temperature of the preheat zone is preferably lower than that of the drawing zone, is more preferably set in a range of (Tg−30° C.) to (Tg+10° C.), and is most preferably set in a range of (Tg−30° C.) to (Tg+5° C.). It is possible to reduce the bowing phenomenon that the bowing line has the convex shape by setting the preheat temperature to the above range. When the bowing line has a concave shape at the outlet of the tenter in the traveling direction, the temperature of the preheat zone is preferably higher than that of the drawing zone, is more preferably set in a range of (Tg−10° C.) to (Tg+30° C.), and is most preferably set in a range of (Tg−5° C.) to (Tg+30° C.). It is possible to reduce the bowing phenomenon that the bowing line has the concave shape by setting the preheat temperature to the above range. In addition, Tg described herein is the glass transition temperature of the cellulose acylate film having a residual solvent quantity of 1 mass % or less.

### (Drawing Zone)

The drawing zone is a zone for increasing the distance between the chucks for inserting the both ends of the film, carrying the film, and drawing the film.

In the invention, the cellulose acylate film material formed by solution casting or melt casting is preferably dried and drawn in a state that a residual solvent quantity is 1 mass % or less. When wet drawing using a large quantity of solvent is performed, rapid evaporation of the solvent occurs by the heating step of the drawing process to generate fine bubbles, the solvent is apt to be left after the drawing process, and the residual solvent has bad influence on parts for a liquid crystal display device. When the wet drawing is performed in a state that the residual solvent quantity is large, the retardations Re and Rth are hard to increase by the plasticization effect of the solvent or the improvement of a viewing angle characteristic is insufficient. Among them, in particular, a largest problem is that the film drawing property becomes ununiform by the difference in evaporation speed of a local solvent, the variations in the retardations Re and Rth and the shift of the orientation slow axis are apt to occur. When the film is dried and drawn as described above, the above-described problems which occur in the wet drawing process using the solvent can be avoided. The residual solvent quantity of the cellulose acylate film material provided to the drawing process is preferably 1 mass % or less, more preferably 0.8 mass % or less, further more preferably 0.5 mass % or less, and most preferably 0.2 mass % or less.

In the invention, the temperature of the transverse drawing is preferably set in a range of (Tg−10° C.) to (Tg+35° C.), preferably in a range of (Tg−10° C.) to (Tg+30° C.), and most preferably in a range of (Tg−5° C.) to (Tg+30° C.). The temperature of the drawing zone does not need to be constant and may gradually vary. In the drawing zone, one-step drawing or multi-step drawing may be performed. When the multi-step drawing is performed, the temperature gradient is preferably given such that the temperature of the back end of the drawing zone is slightly lower than that of the front end of the drawing zone. Concretely, the temperature of the back end of the drawing zone is preferably lower than that of the front end of the drawing zone by 1 to 1° C., more preferably 1 to 8° C., most preferably 1 to 5° C. A method of generating the temperature difference of the multi-step drawing is not specially limited. In a hot-air heater, a method of generating the temperature difference by changing the air blast quantities of the front end of the drawing zone and the back end of the drawing zone may be employed. In a radiation heater such as a far-infrared or microwave heating device, a method of generating the temperature difference by changing the number of heaters or heater capabilities of the front end of the drawing zone and the back zone of the drawing zone may be employed.

In the invention, in the drawing zone, the temperature difference is generated in the transverse direction of the film and the temperature gradient is given such that the temperature Tc of the central portion of the film is slightly lower than the temperature Ts of the ends of the film. By giving the temperature gradient, the drawing stress of the transverse direction of the film becomes uniform and the bowing phenomenon is reduced.

In the invention, it is preferable that the temperature distribution of the transverse direction satisfies 1° C.≦Ts−Tc≦5° C. The temperature distribution of the drawing zone is set such that the temperature Ts of the both ends of the film is preferably higher than the temperature Tc of the central portion of the film by 1 to 5° C., more preferably 1 to 4° C., and most preferably 1 to 3° C. If the Ts−Tc is 5° C. or less, the balance of the optical characteristic of the transverse direction of the film is easily held and, if the Ts−Tc is 1° C. or more, the bowing phenomenon can be easily reduced. By increasing the temperature of the both ends of the film, the temperature which decreases by the heat conductivity of the metal chucks (clips) of the both ends of the film can be compensated and the shift of the slow axis in the transverse direction and the variations in the retardations can be minimized. In the invention, the temperatures Ts of the both ends are preferably equal to each other.

In the invention, Ts is an average temperature of a portion from the central line 11 of the transverse direction of the film in the tenter to the both sides spaced apart from the central line 11 by 20 to 45% (the whole width of the film is 100%) and Tc is an average temperature of a portion from the central line to the both sides spaced apart from the central portion by 20% or less.

A method of increasing the temperature of the ends is not specially limited, but, for example, a method of blowing hot air having a high temperature to only the ends or a method of mounting far-infrared or microwave heaters in the ends and heating the ends by radiation may be preferably used. In view of productivity, a hot-air heating method is preferably employed. In order to generate the temperature difference between the ends and the central portion of the film, a method of giving a gradient of a nozzle slit width in the transverse direction of the film such that the slit widths of the nozzles for blowing hot air to the ends of the film increase or a method of mounting infrared heaters at the ends of the film and heating the ends of the film may be used. The method of mounting the infrared heaters and heating the ends of the film easily changes the device, compared with the method of the increasing the slit widths of the nozzles for blowing hot air. The air blowing quantity can be easily adjusted by mounting a plurality of blowing ports in the heating zone (heater) and adjusting a damper mounted in each blowing port. By mounting an airflow meter in each blowing port, an air volume can be easily detected.

In the invention, a drawing ratio of the transverse direction is preferably 5% to 250%, more preferably 5% to 200%, and most preferably 5% to 150%. When the multi-step drawing is performed, a ratio of the drawing ratio of the back end of the drawing zone to the drawing ratio of the front end of the drawing zone is preferably in a range of 0.01 to 1, more preferably in a range of 0.01 to 0.9, further more preferably 0.01 to 0.8, and most preferably 0.01 to 0.5. The drawing ratio described herein indicates an actual drawing ratio in the front end of the drawing zone and the back end of the drawing zone.

In order to set optical characteristics (in particular, Re and Rth) in a desired range, the longitudinal drawing, the transverse drawing, or a combination thereof is performed. In the invention, the longitudinal drawing is performed by at least a ratio of 0% to 50% in the longitudinal direction of the film before performing the transverse drawing of the transverse direction. The ratio of the longitudinal drawing is more preferably 0% to 45% and most preferably 0% to 40%. The longitudinal drawing and the transverse drawing may be independently performed (uniaxial drawing) or may be combined (biaxial drawing). In the biaxial drawing, the longitudinal drawing and the transverse drawing may be sequentially performed (sequential drawing) or may be simultaneously performed (simultaneous drawing).

In the invention, the longitudinal drawing/transverse drawing ratio is preferably 0 to 0.4. The longitudinal drawing/transverse drawing ratio is more preferably 0 to 0.3 and most preferably 0 to 0.2. The longitudinal drawing/transverse drawing ratio is a value obtained by dividing the drawing ratio of the longitudinal direction by the drawing ratio of the transverse direction, and the drawing ratio is expressed by the following equation.

Drawing ratio (%)=[100×{(length after drawing)−(length before drawing)}/length before drawing]]

Markers having a constant interval are drawn on the surface of the film before drawing and the interval between the markers before and after drawing is measured such that the length before drawing and the length after drawing can be obtained.

In the invention, the drawing speeds of the longitudinal drawing and the transverse drawing are preferably 10%/min to 10000%/min, more preferably 20%/min to 1000%/min, and most preferably 30%/min to 800%/min. In the multi-step drawing, it indicates an average value of the drawing speeds of the ends.

In the invention, the drawing may be performed on-line during the film forming process or may be performed off-line after the film forming process is finished and winding is performed.

### (Relaxation Zone)

The relaxation zone is a zone for decreasing the widths of the chucks for inserting the both ends of the film which is transversely drawn by the drawing zone and relaxing the film.

The relaxation zone may not be necessarily provided, but the relaxation zone is preferably provided. The relaxation process of the transverse direction is performed by gradually decreasing the width between the chucks with respect to a maximum width between the chucks which run on the left and right rails after the transverse drawing while gripping the film by the chucks (tenter clip). By performing the relaxation process, it is possible to solve the unevenness of the stress of the central portion and the ends when the drawing is performed and to efficiently suppress the dimension variation and the bowing phenomenon due to the heat. The relaxation is performed in a drawing direction with a ratio of 0.1% to 40%, more preferably 0.5% to 35%, and most preferably 1% to 30% with respect to a total drawing ratio (maximum drawing ratio).

Relaxation ratio (%)=100×[{(drawing ratio before relaxation)−(drawing ratio after relaxation)}/drawing ratio before drawing]

That is, if the width of the film before drawing is 100 cm, the width of the film becomes 130 cm when the film is drawn by 30%, and the final substantial drawing ratio becomes 24% and thus the width of the film becomes 124 cm when the relaxation is performed with a relaxation ratio of 20%.

The temperature of the relaxation zone is preferably set to be lower than the temperature of the completion side of the drawing zone by 0 to 20° C., more preferably by 1 to 15° C., and most preferably 2 to 12° C. By providing a temperature gradient between the relaxation zone and the drawing zone, it is possible to suppress the bowing phenomenon and to easily obtain a film having a uniform optical property of the width direction. In the invention, in the relaxation zone, the relaxing is performed in a state that the temperature Ts of the both ends of the film is preferably higher than the temperature Tc of the central portion by 1 to 5° C., more preferably 1 to 4° C., and most preferably 1 to 3° C.

### (Heating Zone)

The heating zone is a zone for heating the film in the tenter next to the relaxation zone (next to the drawing zone if the relaxation zone is not included).

In the production method of the invention, the binding force of at least one of the chucks (tenter clip) for gripping the both ends of the film in the tenter is removed. By reducing the binding force of the longitudinal direction and the transverse direction of the film, it is possible to reduce residual distortion of the transverse direction and the longitudinal direction and to reduce the dimension variation of the film due to the wet heat process or the dry heat process.

In the invention, the carrying tension of the longitudinal direction of the film after removing the binding force of the chuck is preferably in the range of 1 to 70 N/m, 2 to 60 N/m, and most preferably in the range of 3 to 50 N/m. If the carrying tension is greater than the range of the invention, heat shrinkage is unpreferably apt to increase. In contrast, if the carrying tension is less than the range of the invention, carrying trouble such as meandering is unpreferably apt to occur. Such tension can be accomplished by controlling the tension cut roll mounted in at least one of the inlet side and the outlet side of the heating zone. At this time, it is preferable that the tension is monitored and adjusted by mounting a tension pickup. Since winding is released if the winding is performed with such low tension, it is preferable that the tension cut is performed in the front of a winding portion and the winding is performed with high tension.

In the production method of the invention, the temperature of the heating zone is set to (Tg−30° C.) to (Tg+20° C.), more preferably (Tg−20° C.) to (Tg+15° C.), and most preferably (Tg−20° C.) to (Tg+10° C.). If the temperature is (Tg+20° C.) or less, the optical characteristics (in particular, Re and Rth) of the drawn cellulose acylate film are easily adjusted to a desired range. If the temperature is (Tg−30° C.) or more, heat shrinkage is easily controlled in a proper range. A carrying speed is preferably 2 to 100 m/min, more preferably 3 to 70 m/min, and most preferably 5 to 50 m/min. A heating time is preferably 1 sec to 5 min, more preferably 3 sec to 4 min, and most preferably 5 sec to 3 min.

The temperature of each zone in the drawing tenter is preferably controlled by controlling a heating source. The heating source is not specially limited, and an infrared panel heater or a hot air generator may be preferably used in view of forming a proper temperature distribution in the transverse direction. Among them, since an air conditioning blowing system and a small-sized infrared panel heater are preferable because division is possible such that a proper temperature distribution is obtained in the transverse direction. The heating sources thereof may be mounted in a drawing furnace or may be mounted in a heating furnace which is provided independent of the drawing furnace. In the air conditioning blowing heater, air is blown to the upper and lower surfaces of the film by the plurality of slit nozzles mounted in the tenter and the wind speed of hot air and the temperature of hot air may be freely changed according to the setting temperature of each zone in the traveling direction of the film in the drawing tenter. In the heating process, a plurality of infrared panel heaters is mounted in the last half of the drawing furnace in the transverse direction as a heating source which is positioned in the drawing furnace or an annealing furnace and the setting temperatures may be changed by the measurement value of the retardation. In the cooling process, a cooling plate for adjusting the temperature in the transverse direction of the film is positioned in the drawing furnace or the annealing furnace and the temperature is adjusted in association with a retardation distribution.

The both ends may be slit and cut off with a width of a product before winding is performed and the both ends may be subjected to a knurling process (embossing process) in order to prevent adhesion or scratch during winding. The knurling process may be performed by heating and/or pressurizing a metal ring having uneven putters at the sides. Since the portions of the both ends of the film gripped by the chucks are deformed and are not used as a product, the portions may be cut and reused as a raw material. In the invention, at least one end is subjected to the knurling process with preferably a height of 5 μm to 50 μm, more preferably 10 μm to 40 μm, and most preferably 15 μm to 35 μm. It is preferable that the height of the knurl does not decrease during the low-tension heat treatment.

Preparing Method of the Cellulose Acylate Film

Hereinafter, implementation methods of the invention will be sequentially described in detail.

### <<Cellulose Acylate Resin>>

Description will now be made in detail of a method of preparing cellulose acylate of the present invention. Raw cotton and a synthesizing method for the cellulose acylate of the present invention are also described in detail in Published Technical Report of the Hatsumei Kyokai (Association of Inventions) (Published Report No. 2001-1745, published on Mar. 15, 2001 by Hatsumei Kyokai), pages 7 to 12.

### (Raw Materials and Preliminary Treatment)

The material for cellulose is preferably derived from hardwood or softwood pulp, or cotton linter. The material for cellulose is preferably one of high purity having an α-cellulose content of 92 to 99.9% by mass.

If the material is in the form of a sheet or block, it is preferably crushed prior to use and its crushing is preferably carried out until cellulose becomes minute powder-feather form.

### (Activation)

The material for cellulose is preferably treated with an activating agent (or activated) prior to acylation. A carboxylic acid or water can be used as the activating agent and when water is used, activation is preferably followed by the step of adding an excess of an acid anhydride for dehydration, washing with a carboxylic acid to replace water, or adjusting the conditions of acylation. The activating agent may be added at any temperature by such a method as spraying, dropping or dipping.

Carboxylic acids preferred as an activating agent are carboxylic acids having 2 to 7 carbon atoms (for example, acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2, 3-dimethylbutyric acid, 3,3-dimethylbutyric acid, cyclopentanecarboxylic acid, heptanoic acid, cyclohexanecarboxylic acid and benzoic acid), more preferably acetic acid, propionic acid or butyric acid, and still more preferably acetic acid.

An acylation catalyst, such as sulfuric acid, may be added at the time of activation, if required. However, as the addition of a strong acid, such as sulfuric acid, can promote depolymerization, its addition is preferably limited to, say, 0.1 to 10% by mass of cellulose. It is also possible to use two or more kinds of activating agents together, or add an acid anhydride of carboxylic acid having 2 to 7 carbon atoms.

The amount of the activating agent to be added is preferably at least 5%, more preferably at least 10% and still more preferably at least 30%, by mass of cellulose. The amount of the activating agent which is equal to or larger than the lower limit stated above is preferable for avoiding any inconvenience, such as a reduction in the activation degree of cellulose. The upper limit of the amount of the activating agent is not specifically set except for avoiding a lowering of productivity, but is preferably at most 100 times, more preferably at most 20 times and still more preferably at most 10 times, by mass as large as cellulose. It is allowable to carry out activation by adding a large excess of activating agent over cellulose and then reduce its amount by operations, such as filtration, air drying, drying under heat, vacuum distillation and solvent substitution.

Time for activation is preferably 20 minutes or more and while its upper limit is not specifically set unless it affects productivity, it is preferably 72 hours or less, more preferably 24 hours or less and still more preferably 12 hours or less. The activation temperature is preferably from 0° C. to 90° C., more preferably from 15° C. to 80° C. and still more preferably from 20° C. to 60° C. The activation of cellulose may also be carried out at an elevated or reduced pressure. Electromagnetic waves, such as microwaves or infrared radiation, may be used as a source of heat.

### (Acylation)

When the cellulose acylate is produced, it is preferable that acid anhydride of carboxylic acid is added to the cellulose and is reacted using Brönsted acid or Lewis acid as a catalyst such that the hydroxyl group of the cellulose is acylated.

The synthesis of the cellulose acylate having a large 6-position substitution degree is disclosed in Japanese Unexamined Application Publication No. 11-5851, Japanese Unexamined Application Publication No. 2002-212338, or Japanese Unexamined Application Publication No. 2002-338601.

As another synthesis of the cellulose acylate, a method of reacting with carboxylic acid anhydride or carboxylic acid halide under the existence of base (sodium hydrate, potassium hydrate, barium hydroxide, sodium carbonate, pyridine, triethylamine, potassium tert-butoxy, sodium methoxide, sodium ethoxide or the like) or a method of using mixed acid anhydride (mixed anhydride of carboxylic acid and trifluoroacetic acid, mixed anhydride of carboxylic acid and methanesulfonic acid) as an acylation agent may be used. In particular, the latter method is efficient when an acyl group having a large carbon number or an acyl group in which an acylation method using carboxylic acid anhydride-acetic acid-sulfuric acid catalyst is difficult is introduced.

Cellulose mixed acylate can be obtained by using, for example, a method in which two kinds of carboxylic acid anhydrides are added in a mixed state or one after the other as an acylating agent to be reacted with cellulose, a method employing a mixed acid anhydride of two kinds of carboxylic acids (for example, a mixed acetic and propionic acid anhydride), a method in which a mixed acid anhydride (for example, a mixed acetic and propionic acid anhydride) is synthesized in a reaction system from a carboxylic acid and the anhydride of another carboxylic acid (for example, acetic acid and propionic acid anhydride) and reacted with cellulose, or a method in which cellulose acylate having a substitution degree of less than 3 is synthesized and has its remaining hydroxyl groups acylated by using an acid anhydride or halide.

### (Acid Anhydrides)

Preferred examples of carboxylic acid anhydrides are of carboxylic acids having 2 to 7 carbon atoms and include anhydrous acetic acid, propionic acid anhydride, butyric acid anhydride, 2-methylpropionic acid anhydride, valeric acid anhydride, 3-methylbutyric acid anhydride, 2-methylbutyric acid anhydride, 2,2-dimethylpropionic acid anhydride (pivalic acid anhydride), hexanoic acid anhydride, 2-methylvaleric acid anhydride, 3-methylvaleric acid anhydride, 4-methyl-valeric acid anhydride, 2,2-dimethylbutyric acid anhydride, 2,3-dimethylbutyric acid anhydride, 3,3-dimethylbutyric acid anhydride, cyclopentanecrboxylic acid anhydride, heptanoic acid anhydride, cyclohexanecarboxylic acid anhydride and benzoic acid anhydride.

More preferable are anhydrous acetic acid, propionic acid anhydride, butyric acid anhydride, valeric acid anhydride, hexanoic acid anhydride, heptanoic acid anhydride, and the like and still more preferable are anhydrous acetic acid, propionic acid anhydride and butyric acid anhydride.

The use of a combination of these acid anhydrides is preferably made for preparing a mixed ester. Their mixing ratio is preferably selected in accordance with the substitution ratio of a mixed ester as intended. The acid anhydride is usually added in an excess equivalent to cellulose. More specifically, it is preferable to add from 1.2 to 50 equivalents, more preferably from 1.5 to 30 equivalents and still more preferably from 2 to 10 equivalents to the hydroxyl groups of cellulose.

### (Catalyst)

An acylation catalyst may be used in preparing cellulose acylate according to the present invention. A Brönsted or Lewis acid is preferably used as an acylation catalyst. The definitions of the Brönsted and Lewis acids are found in, for example, “Rikagaku Jiten” (Encyclopedia of Physics and Chemistry), 5th Edition (2000). Preferred examples of Brönsted acids are sulfuric acid, perchloric acid, phosphoric acid, methanesulfonic acid, benzenesulfonic acid and p-toluenesulfonic acid. Preferred examples of Lewis acids are zinc chloride, tin chloride, antimony chloride and magnesium chloride.

Sulfuric or perchloric acid is more preferable as a catalyst and sulfuric acid is still more preferable. The catalyst is preferably added in the amount of from 0.1 to 30%, more preferably from 1 to 15% and still more preferably from 3 to 12% by mass of cellulose.

### (Solvent)

A solvent may be added at the time of acylation for adjusting viscosity, reaction rate, stirring property, acyl substitution ratio, and the like. While dichloromethane, chloroform, carboxylic acid, acetone, ethyl methyl ketone, toluene, dimethyl sulfoxide or sulfolane can, for example, be used as the solvent, carboxylic acid is preferred, including, for example, carboxylic acid having 2 to 7 carbon atoms (for example, acetic acid, propionic acid, butyric acid, 2-methylpropionic acid, valeric acid, 3-methylbutyric acid, 2-methylbutyric acid, 2,3-dimethylpropionic acid (pivalic acid), hexanoic acid, 2-methylvaleric acid, 3-methylvaleric acid, 4-methyl-valeric acid, 2,2-dimethylbutyric acid, 2,3-dimethylbutyric acid, 3,3-dimethylbutyric acid or cyclopentanecarboxylic acid). Acetic acid, propionic acid, butyric acid, and the like are, among others, preferred. A mixture of solvents can also be used.

### (Conditions for Acylation)

Although acylation can be carried out by mixing a mixture of an acid anhydride, a catalyst and a solvent, if required, with cellulose, or by mixing them one after another with cellulose, it is usually preferable to prepare a mixture of an acid anhydride and a catalyst, or a mixture of an acid anhydride, a catalyst and a solvent as an acylating agent and react it with cellulose. It is preferable to cool the acylating agent beforehand to restrain any temperature elevation in the reaction vessel by the heat of the acylation reaction. It is preferably cooled to a temperature of from −50° C. to 20° C., more preferably from −35° C. to 10° C., and still more preferably from −25° C. to 5° C. The acylating agent may be employed in a liquid state, or may be frozen and employed in a solid state in crystal, flake or block form.

The acylating agent may be added to cellulose all at a time, or may be added thereto a plurality of times. Alternatively, cellulose may be added to the acylating agent all at a time, or may be added thereto a plurality of times. When the acylating agent is added a plurality of times, it is possible to use a single kind of acylating agent or a plurality of acylating agents differing from one another in composition. Preferred cases include (1) adding first a mixture of an acid anhydride and a solvent, and then a catalyst, (2) adding first a mixture of an acid anhydride, a solvent and a part of a catalyst, and then a mixture of the remaining catalyst and the solvent, (3) adding first a mixture of an acid anhydride and a solvent, and then a mixture of a catalyst and the solvent, and (4) adding first a solvent, and then a mixture of an acid anhydride and a catalyst, or a mixture of the acid anhydride, catalyst and solvent.

Although the acylation of cellulose is an exothermic reaction, it is preferable that a maximum temperature of 50° C. not be exceeded by acylation in the method of preparing cellulose acylate according to the present invention. The reaction temperature not exceeding that level is preferable for avoiding any inconvenience such as the progress of depolymerization making it difficult to obtain cellulose acylate having a polymerization degree suited for the purpose of the present invention. The maximum temperature not to be exceeded by acylation is preferably 45° C., more preferably 40° C. and still more preferably 35° C. The reaction temperature may be controlled by using a temperature controller, or by controlling the initial temperature of the acylating agent. It is also possible to evacuate the reaction vessel and control the reaction temperature by the heat generated by the evaporation of the liquid component in the reaction system. It is also effective to employ cooling during the initial period of the reaction and heating thereafter, since the generation of heat by acylation is remarkable during the initial period of the reaction. The end point of acylation can be determined by means of light transmittance, solution viscosity, temperature change in the reaction system, solubility of the reaction product in an organic solvent, observation through a polarizing microscope, and the like.

The minimum temperature of the reaction is preferably −50° C., more preferably −30° C. and still more preferably −20° C. Time for acylation is preferably from 0.5 to 24 hours, more preferably from 1 to 12 hours and still more preferably from 1.5 to 6 hours. If it is less than 0.5 hour, the reaction does not proceed satisfactorily under the usual reaction conditions, while no time exceeding 24 hours is desirable for industrial production.

### (Reaction Terminator)

The acylation reaction is preferably followed by the addition of a reaction terminator.

The reaction terminator may be anything that can decompose an acid anhydride, and preferred examples are water, alcohol (such as ethanol, methanol, propanol or isopropyl alcohol) or a composition containing them. The reaction terminator may also contain a neutralizing agent, as will be stated below. When the neutralizing agent is added, the addition of a mixture of a carboxylic acid, such as acetic, propionic or butyric acid, and water is preferable to the direct addition of water or alcohol for avoiding the generation of a large amount of heat exceeding the cooling capacity of the reaction apparatus and causing inconveniences, such as a reduction in the polymerization degree of cellulose acylate and any undesired sedimentation of cellulose acylate. Acetic acid is preferable to any other carboxylic acid. While any ratio of carboxylic acid and water can be employed, the proportion of water is preferably from 5 to 80%, more preferably from 10 to 60% and still more preferably from 15 to 50% by mass.

As a method of addition, the reaction terminator may be added to the reaction vessel for acylation, or alternatively, the reaction mixture may be added to a container for the reaction terminator. The addition of the reaction terminator preferably takes from three minutes to three hours. Its addition taking three minutes or more is preferable for avoiding any inconvenience, such as the generation of so large an amount of heat as to cause a lowering in the polymerization degree of cellulose acylate, insufficient hydrolysis of the acid anhydride or a lowering in stability of cellulose acylate. Its addition not taking more than three hours is preferable for avoiding any problem, such as a reduction in industrial productivity. Its addition more preferably takes from four minutes to two hours, still more preferably from five minutes to one hour and still more preferably from 10 to 45 minutes. While the addition of the reaction terminator does not essentially require any cooling of the reaction vessel, its cooling is preferable for restraining any undesirable temperature elevation and thereby any depolymerization. The reaction terminator is preferably cooled, too.

### (Neutralization Agent)

During a reaction stop process of acylation or after a reaction stop process of acylation, a neutralization agent or a solution thereof may be added for the hydrolysis of excessive anhydrous carboxylic acid which remains in the system, the neutralization of a portion or all of carboxylic acid and esterification catalyst, and the control of a residual sulfate group quantity and a residual metal quantity.

Preferable examples of the neutralization agent include carbonate, hydrogen carbonate, organic salt (e.g. acetate salt, propionate, butyrate, benzoate compound, phthalate compound, hydrogen phthalate, citric salt, tartrate or the like), phosphate, hydroxide or oxide of ammonium, organic quaternary ammonium (e.g. tetramethylammonium, tetraethylammonium, tetrabutylammonium, diisopropyldiethylammonium or the like), alkali metal (preferably, lithium, sodium, potassium or rubidium, cesium, more preferably, lithium, sodium or potassium, and most preferably, sodium or potassium), an element of group 2 (preferably, beryllium, calcium, magnesium, strontium or barium, and preferably calcium or magnesium), metal of groups 3 to 12 (e.g. iron, chrome, nickel, copper, lead, zinc, molybdenum, niobium, titanium or the like), or an element of groups 13 to 15 (e.g. aluminum, tin, antimony or the like). These neutralization agents may be mixed or mixed salt (e.g. magnesium acetate propionate, potassium sodium tartrate or the like) may be formed. If the anion of the neutralization agent is bivalent or greater, hydrogen salt (e.g. sodium acid carbonate, potassium bicarbonate, sodium dihydrogenphosphate, magnesium hydrogenphosphate or the like) may be formed.

The neutralization agents more preferably include alkali metal, carbonate, hydrogen carbonate, organic salt, hydroxide or oxide and most preferably include carbonate, hydrogen carbonate, acetate, or hydroxide of sodium, potassium, magnesium, or calcium.

The solvent of the neutralization agent includes water, alcohol (e.g. ethanol, methanol, propanol, isopropyl alcohol or the like), organic acid (e.g. acetic acid, propionic acid, butyric acid or the like), ketone (e.g. acetone, ethylmethyl ketone or the like), a polar solvent of dimethylsulfoxide, or a mixed solvent thereof.

### (Partial Hydrolysis)

As the cellulose acylate obtained as described has a total substitution degree (the sum of 2-, 3- and 6-position substitution degree) of nearly 3, it is usual practice to hold it at a temperature of 20° C. to 90° C. for several minutes to several days in the presence of a small amount of catalyst (usually an acylation catalyst, such as the remaining sulfuric acid) and water for hydrolyzing the ester bonds partially and lowering the acyl substitution degree of cellulose acylate to a desired level (so-called aging). As the process of the partial hydrolysis causes the hydrolysis of the sulfuric acid ester of cellulose, too, it is possible to reduce the amount of the sulfuric acid ester bonded to cellulose by controlling the conditions of the hydrolysis.

When the desired cellulose acylate has been obtained, it is preferable to neutralize the catalyst remaining in the system completely by using a neutralizing agent as mentioned above or a solution thereof to terminate the partial hydrolysis. The addition of a neutralizing agent (for example, magnesium carbonate or acetate) forming a salt having low solubility in the reacted solution is desirable for the effective removal of the catalyst (for example, sulfuric acid ester) in the solution or bonded to cellulose.

### (Filtration)

The reaction mixture (dope) is preferably subjected to filtration for removing or reducing any unreacted matter, sparingly soluble salt and any other foreign matter from the cellulose acylate. Its filtration may be carried out at any stage from the completion of acylation to reprecipitation. Its dilution with a suitable solvent prior to its filtration is preferable for controlling its filtration pressure and its ease of handling.

### (Reprecipitation)

The obtained cellulose acylate solution is mixed with a poor solvent such as an aqueous solution of carboxylic acid (e.g. acetic acid, propionic acid or the like) or water or a poor solvent is mixed with the cellulose acylate solution to reprecipitate the cellulose acylate and a target cellulose acylate can be obtained by cleaning and stabilizing process. The reprecipitation may be successively performed or may be performed by a constant quantity in a batch manner. The concentration of the cellulose acylate solution and the composition of the poor solution are adjusted by the polymerization or the substitution method of the cellulose acylate to control the molecular weight distribution or the form of the reprecipitated cellulose acylate.

From the purposes such as the improvement of purification effect, the adjustment of the molecular weight distribution or apparent density, the reprecipitated cellulose acylate is molten in a good solvent (e.g. acetic acid, acetone or the like) again, and is mixed with a poor solvent (e.g. water or an aqueous solution of carboxylic acid (acetic acid, propionic acid, butylic acid or the like), the reprecipitation is performed one time or plural times, as necessary.

### (Washing)

The cellulose acylate as produced is preferably washed. Any washing solvent may be used if it sparingly dissolves cellulose acylate and yet can remove impurities therefrom, though water or warm water is usually employed. Washing water preferably has a temperature of from 25° C. to 100° C., more preferably from 30° C. to 90° C. and still more preferably from 40° C. to 80° C. Washing treatment may be made on a batch basis by repeating filtration and the change of the washing solution, or by using a continuous washing apparatus. The waste solution resulting from the steps of reprecipitation and washing is preferably reused as a poor solvent for another step of reprecipitation, or distilled or otherwise treated so that a solvent, such as carboxylic acid, may be recovered for reuse.

While any method can be used for checking the progress of washing, preferred examples thereof rely on hydrogen ion concentration, ion chromatography, electrical conductivity, ICP, elemental analysis and atomic absorption spectrum.

Such treatment makes it possible to remove the catalyst (such as sulfuric acid, perchloric acid, trifluoroacetic acid, p-toluenesulfonic acid, methanesulfonic acid or zinc chloride), the neutralizing agent (such as the carbonate, acetate, hydroxide or oxide of calcium, magnesium, iron, aluminum or zinc), the reaction product of the neutralizing agent and the catalyst, the carboxylic acid (such as acetic, propionic or butyric acid), the reaction product of the neutralizing agent and the carboxylic acid, and the like from cellulose acylate, and is, therefore, effective for increasing the stability of cellulose acylate.

### (Stabilization)

The cellulose acylate which has been washed by warm water treatment is preferably treated with an aqueous solution of a weak alkali (for example, the carbonate, hydrogen carbonate, hydroxide or oxide of sodium, potassium, calcium, magnesium or aluminum) in order to be further improved in stability, or have any odor of carboxylic acid removed.

The amount of the remaining impurities can be controlled by the amount of the washing solution, washing temperature or time, a method of stirring, the shape of a washing container, and the composition and concentration of the stabilizing agent.

### (Drying)

Cellulose acylate is preferably dried to have its water content adjusted to a desired level in accordance with the present invention. While any drying method can be employed if it enables the intended water content to be realized, it is desirable to perform drying efficiently by employing a method such as heating, air blowing, pressure reduction or stirring, or a combination thereof. Drying is preferably performed at a temperature of from 0° C. to 200° C., more preferably from 40° C. to 180° C. and still more preferably from 50° C. to 160° C. The cellulose acylate of the present invention preferably has a water content of 2% by mass or less, more preferably 1% by mass or less, and still more preferably 0.7% by mass or less.

### (Form)

The cellulose acylate of the present invention may have any of various forms, such as particulate, powdery, fibrous or block, but since it is preferably particulate or powdery as a material for film production, the cellulose acylate as dried may be crushed or sieved to have a uniform particle size and an improved property of handling. When cellulose acylate is particulate, at least 90% by mass of its particles which are used preferably have a particle size of 0.5 to 5 mm. Moreover, at least 50% by mass of its particles which are used preferably have a particle size of 1 to 4 mm. The cellulose acylate particles are preferably as close to spherical as possible in shape. In addition, the particles of cellulose acylate of the invention preferably have appearant density in the range of 0.5 to 1.3, more preferably in the range of 0.7 to 1.2, and particularly preferably in the range of 0.8 to 1.15. The method of measuring appearant density is in accordance with JIS K-7365.

The particles of cellulose acylate of the invention preferably have a repose angle in the range of 100 to 70°, more preferably in the range of 15° to 60°, and particularly preferably in the range of 20° to 50°.

### (Polymerization Degree)

The number average polymerization degree of cellulose acylate preferably used in the invention is in the range of 100 to 300, more preferably in the range of 12° to 250, and even more preferably in the range of 13° to 200. Its average polymerization degree can be determined by e.g. the limiting viscosity method of UDA et al (Kazuo UDA and Hideo SAITO: Journal of the Society of Fibers, Vol. 18, No. 1, pages 105 to 120, 1962), or a method of determining a molecular weight distribution by gel permeation chromatography (GPC). For further details, reference is made to JP-A-9-95538.

According to the present invention, the weight average polymerization degree/number average polymerization degree of cellulose acylate as determined by GPC is preferably in the range of 1.6 to 3.6, more preferably in the range of 1.7 to 3.3 and particularly preferably in the range of 1.8 to 3.2 when it is the first cellulose acylate film. When it is the second cellulose acylate film, it is preferably in the range of 1.0 to 5.0, more preferably in the range of 1.2 to 4.5 and particularly preferably in the range of 1.2 to 4.0.

As for cellulose acylate, one kind of a cellulose acylate or a mixture of two or more kinds of cellulose acylates may be used. In addition, a mixture in which cellulose acylate and other high molecular components are properly mixed may be used. The high molecular components to be mixed preferably have excellent compatibility with cellulose acylate. The permeability, in case of being formed as a film, is preferably of 80% or higher, preferably 90% or higher, and further preferably 92% or higher.

### (Residual Sulfur Content in the Cellulose Acylate)

In the method for producing the cellulose acylate, if a sulfuric acid is used as a catalyst, sulfate ester may remain in the cellulose acylate which is finally obtained. The heat stability of the cellulose acylate may be influenced by the residual sulfur content. In the invention, the sulfur content is preferably 0 to 100 ppm, more preferably 10 to 80 ppm, and most preferably 10 to 60 ppm of a sulfur atom with respect to the cellulose acylate.

### <<Additives>>

### (Plasticizer)

The addition of a plasticizer to the cellulose acylate of the present invention makes it possible to reduce stretching irregularity. As the example of the plasticizer, alkylphthalylalkyl glycolates, phosphoric acid esters, carboxylic acid esters are included.

Specific examples of alkylphthalylalkyl glycolates are methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate and octyl phthalyl ethyl glycolate.

Specific examples of phosphoric acid esters are triphenyl phosphate, trioctyl phosphate, and biphenyldiphenyl phosphate. It is also preferable to use the phosphate plasticizers as set forth in claims 3 to 7 in JP-T-6-501040.

Examples of carboxylic acid esters are phthalic acid esters such as dimethyl phthalate, diethyl phthalate, dibutyl phthalate, dioctyl phthalate and diethylhexyl phthalate; citric acid esters such as acetyltrimethyl citrate, acetyltriethyl citrate and acetyltributyl citrate; adipic acid esters such as dimethyl adipate, dibutyl adipate, diisobutyl adipate, bis(2-ethylhexyl) adipate, diisodecyl adipate and bis(butyldiglycol adipate). It is also preferable to use butyl oleate, methylacetyl ricinolate, dibutyl sebacate or triacetine, or a combination thereof.

The amount of the plasticizer is preferably from 0 to 20% by mass, more preferably from 1 to 20% by mass and more preferably from 2 to 15% by mass to a cellulose acylate film.

Further, polyhydric alcohol plasticizers may be added. The specific example of the polyhydric alcohol plasticizers used in the present invention include glycerol ester compounds such as glycerol or diglycerol esters; polyalkylene glycols such as polyethylene or polypropylene glycol; and compounds having acyl groups bonded to hydroxyl groups of polyalkylene glycols, which are highly compatible with cellulose fatty acid esters and produce a remarkable thermo-plastic effect.

Specific examples of glycerol esters are glycerol diacetate stearate, glycerol diacetate palmitate, glycerol diacetate myristate, glycerol diacetate laurate, glycerol diacetate caprate, glycerol diacetate nonanate, glycerol diacetate octanoate, glycerol diacetate heptanoate, glycerol diacetate hexanoate, glycerol diacetate pentanoate, glycerol diacetate oleate, glycerol acetate dicaprate, glycerol acetate dinonanate, glycerol acetate dioctanoate, glycerol acetate diheptanoate, glycerol acetate dicaproate, glycerol acetate divalerate, glycerol acetate dibutyrate, glycerol dipropionate caprate, glycerol dipropionate laurate, glycerol diproionate myristate, glycerol dipropionate palmitate, glycerol dipropionate stearate, glycerol dipropionate oleate, glycerol tributyrate, glyceol tripentanoate, glycerol mono-palmitate, glycerol monostearate, glycerol distearate, glycerol propionate laurate and glycerol oleate propionate. These esters are merely examples and may be used alone or in combination.

Glycerol diacetate caprilate, glycerol diacetate pelargonate, glycerol diacetate caprate, glycerol diacetate laurate, glycerol diacetate myristate, glycerol diacetate palmitate, glycerol diacetate stearate and glycerol diacetate oleate are, among others, preferred.

Specific examples of diglycerol esters are diglycerol tetraacetate, diglycerol tetrapropionate, diglycerol tetra-butyrate, diglycerol tetravalerate, diglycerol tetrahexanoate, diglycerol tetraheptanoate, diglycerol tetracaprilate, diglycerol tetrapelargonate, diglycerol tetracaprate, diglycerol tetralaurate, diglycerol tetramyristate, diglycerol tetrapalmitate, diglycerol triacetate propionate, diglycerol triacetate butyrate, diglycerol triacetate valerate, diglycerol triacetate hexanoate, diglycerol triacetate heptanoate, diglycerol triacetate caprilate, diglycerol triacetate pelargonate, diglycerol triacetate caprate, diglycerol triacetate laurate, diglycerol triacetate myristate, diglycerol triacetate palmitate, diglycerol triacetate stearate, diglycerol triacetate oleate, diglycerol diacetate dipropionate, diglycerol diacetate dibutyrate, diglycerol diacetate divalerate, diglycerol diacetate dihexanoate, diglycerol diacetate diheptanoate, diglycerol diacetate dicaprilate, diglycerol diacetate pelargonate, diglycerol diacetate dicaprate, diglycerol diacetate dilaurate, diglycerol diacetate dimyristate, diglycerol diacetate dipalmitate, diglycerol diacetate distearate, diglycerol diacetate dioleate, diglycerol acetate tripropionate, diglycerol acetate tributyrate, diglycerol acetate trivalerate, diglycerol acetate trihexanoate, diglycerol acetate triheptanoate, diglycerol acetate tricaprilate, diglycerol acetate tripelargonate, diglycerol acetate tricaprate, diglycerol acetate trilaurate, diglycerol acetate trimyristate, diglycerol acetate tripalmitate, diglycerol acetate tristearate, diglycerol acetate trioleate, diglycerol laurate, diglycerol stearate, diglycerol caprilate, diglycerol myristate, diglycerol oleate and other mixed acid esters of diglycerol. These esters are merely examples and may be used alone or in combination.

Diglycerol tetraacetate, diglycerol tetrapropionate, digkycerol tetrabutyrate, diglycerol tetracaprilate and diglycerol tetralaurate are, among others, preferred.

Specific examples of polyalkylene glycols are polyethylene glycol and polypropylene glycol having an average molecular weight of 200 to 1000. These are merely examples and may be used alone or in combination.

Specific examples of compounds having acyl groups bonded to hydroxyl groups of polyalkylene glycols are polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristate, polyoxypropylene palmitate, polyoxypropylene stearate, polyoxypropylene oleate and polyoxypropylene linoleate. These compounds are merely examples and may be used alone or in combination.

### (Ultraviolet Absorber)

Next, the cellulose acylate of the invention includes at least one or two ultraviolet inhibitor. It is preferable that the ultraviolet absorber for liquid crystal is excellent in absorption capability of ultraviolet rays having a wavelength of 380 nm or less in view of preventing the deterioration of liquid crystal and hardly absorbs visible light having a wavelength of 400 nm or more in view of liquid crystal display property. For example, there are an oxybenzophenone-based compound, a benzotriazole-based compound, a salicylic ester based compound, a benzophenone-based compound, a cyanoacrylate-based compound and a nickel complex-based compound. Particularly preferable ultraviolet absorber may include the benzotriazole-based compound or the benzophenone-based compound. Among them, the benzotriazole-based compound is preferable because the cellulose acylate is not unnecessarily colored.

The preferable ultraviolet inhibitor may include 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3(3,5-di-tert-butyl-4-hydroxyphenyl)propionate], n,n′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)-isocyanulate.

In addition, a mixture of 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″, 5″,6″-tetrahydrophthalimidemethyl)-5′-methylphenyl)benzotriazole, 2,2-methylenebis(4-(1,1,3,3-tetramethylbutyl)-6-(2H-benzotriazole-2-il)phenol), 2-(2′-hydroxy-3′-tert-butyl-5′-methylphenyl)-5-chlorobenzotriazole, 2-(2H-benzotriazole-2-il)-6(normal chain and lateral chain dodecyl)-4-methylphenol, octyl-3-[3-tert-butyl-4-hydroxy-5-(chloro-2H-benzotriazole-2-il)phenyl]propionate, and 2-ethylhexyl-3-[3-tert-butyl-4-hydroxy-5-(5-chloro-2H-benzotriazole-2-il)phenyl]propionate, a high molecular ultraviolet absorber as an ultraviolet absorber, or an ultraviolet absorber of a polymer type disclosed in Japanese Unexamined Application Publication No. 6-148430 are preferably used.

In addition, hydrazine-based metal deactivation agent such as 2,6-di-tert-butyl-p-cresol, pentaerythrityl-tetrakis-(3-(3,5-di-tert-butyl-4-hydroxyphenyl)propionate), or triethyleneglycol-bis[3-(3-tert-butyl-5-methyl-4-hydroxyphenyl)propionate] is preferable. For example, hydrazine-based metal N,N′-bis[3-(3,5-di-tert-butyl-4-hydroxyphenyl)propionyl]hydrazine or a phosphorus processing stabilizer such as tris(2,4-di-tert-butylphenyl)phosphate may be simultaneously used. The additive amount of these compounds is preferably 1 ppm to 3.0% and more preferably 10 ppm to 2% of mass ratio with respect to the cellulose acylate.

The ultraviolet absorbers which are commercialized products are as follows and may be used in the invention.

As the benzotriazole-based ultraviolet absorber, there are TINUBIN P (Chiba Speciality Chemical)), TINUBIN 234 (Chiba Speciality Chemical), TINUBIN 320 (Chiba Speciality Chemical), TINUBIN 326(Chiba Speciality Chemical), TINUBIN 327 (Chiba Speciality Chemical), TINUBIN 328 (Chiba Speciality Chemical), and Sumisob 340 (sumitomo chemical co. Ltd). As the benzophenone-based ultraviolet absorber, there are Seesorb 100 (Shipro Kasei Kaisha, Ltd.), Seesorb 101 (Shipro Kasei Kaisha, Ltd.), Seesorb 101S (Shipro Kasei Kaisha, Ltd.), Seesorb 102 (Shipro Kasei Kaisha, Ltd.), Seesorb 103 (Shipro Kasei Kaisha, Ltd.), ADEKA's type LA-51 (ADEKA Corporation), chemisop 111 (Chemipro Kasei Kaisha, Ltd.), and UVINUL D-49(BASF). As oxalic acid anilide-based ultraviolet absorber, there are TINUBIN 312 (Chiba Speciality Chemical) and TINUBIN 315(Chiba Speciality Chemical). As salicylic acid-based ultraviolet absorber, there are Seesorb 201 (Shipro Kasei Kaisha, Ltd.) and Seesorb 202 (Shipro Kasei Kaisha, Ltd.). As the cyanoacrylate-based ultraviolet absorber, there are Seesorb 501 (Shipro Kasei Kaisha, Ltd.) and UVINUL N-539(BASF).

### (Stabilizer)

In the invention, as a stabilizer for inhibiting thermal degradation or inhibiting coloring, as necessary, a phosphate-based compound, a phosphite compound, phosphate, thiophosphate, weak organic acid, an epoxy compound or a mixture of two kinds thereof may be added in a range that required capability is not damaged.

In the invention, as the stabilizer, any one or both of a phosphate-based compound and a phosphate compound is preferably used. The blending quantity of the stabilizer is preferably 0.005 to 0.5 mass %, more preferably 0.01 to 0.4 mass %, and most preferably 0.02 to 0.3 mass % with respect to the cellulose acylate film.

### (1) Phosphite-Based Stabilizer

Concrete phosphite-based color-preventing agents are not particularly limited, but preferred phosphite-based stabilizers are compounds described in JP-A-2004-182979 [0023]˜[0039]. Particular preferred are phosphite-based stabilizers represented by the following formulae (1) to (3):

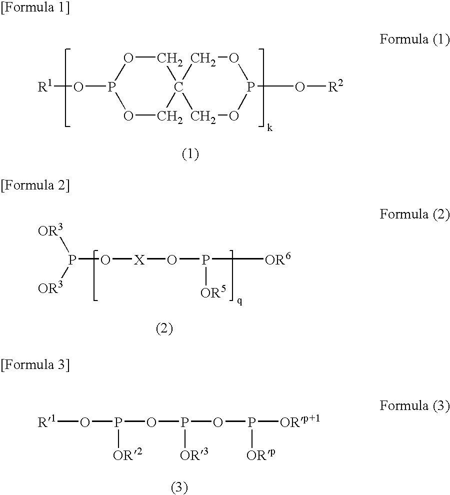

wherein R¹, R², R³, R⁴, R⁵, R⁶, R′¹, R′², R′³ . . . R′^{p}, R′^{p+1} each independently represents a hydrogen atom or a group selected from the group consisting of an alkyl group, an aryl group, an alkoxyalkyl group, an aryloxyalkyl group, an alkoxyaryl group, an arylalkyl group, an alkylaryl group, an polyaryloxyalkyl group, a polyalkoxyalkyl group and a polyalkoxyaryl group having 4 to 23 carbon atoms. But, all of the R in respective formulae (1), (2), (3) are not hydrogen atoms. X in the phosphite-based color-preventing agent shown by the formula (2) represents a group selected from aliphatic chains, aliphatic chains having an aromatic nucleus in the side branch thereof, aliphatic chains having an aromatic nucleus in the chain, and chains comprising oxygen atoms that do not continue by two or more in the above-described chain. k, q each represents an integer of 1 or more, and p represents an integer of 3 or more. The number of k, q in these phosphite-based color-preventing agents is preferably 1-10. By setting the number of k, q to at least 1, the volatility thereof at heating becomes small; and setting them to at most 10, the compatibility with cellulose acetate propionate is improved, which are preferred. p is preferably 3-10. By setting p to at least 3, the volatility thereof at heating becomes small; and setting it to at most 10, the compatibility with cellulose acetate propionate is improved, which are preferred.

For the concrete examples of the phosphite-based color-preventing agent represented by the formula (1), those represented by the following formulae are preferred:

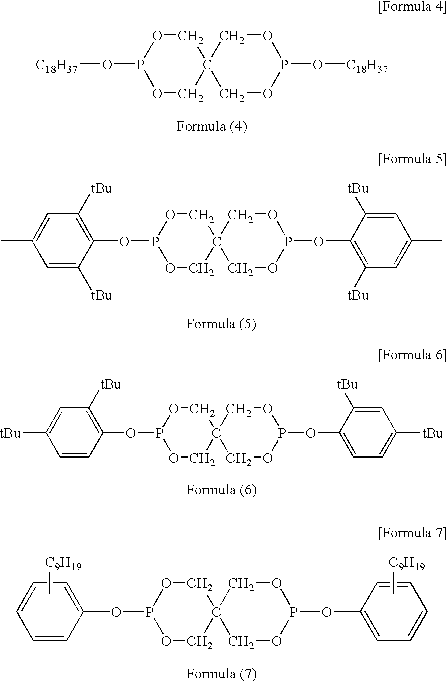

For the concrete examples of the phosphite-based color-preventing agent represented by the formula (2), those represented by the following formulae are preferred:

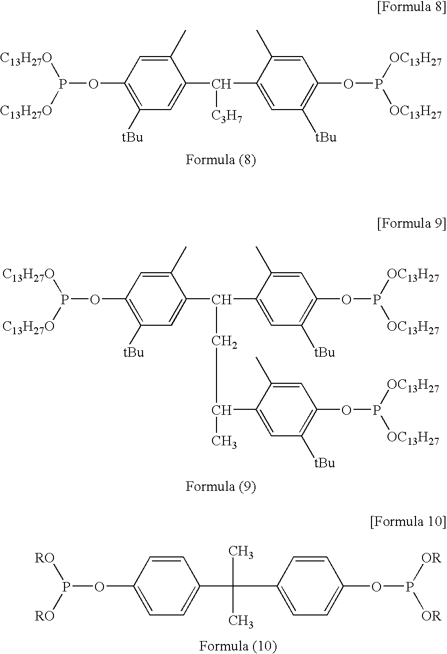

wherein R represents an each independent alkyl group having 12 to 15 carbon atoms.

### (2) Phosphorous Ester-Based Stabilizer

Phosphorous ester-based stabilizers are not limited. The concrete examples of the phosphorous ester-based stabilizer are compounds described in JP-A-S51-70416, JP-A-H10-306175, JP-A-S57-78431, JP-A-S54-157159 and JP-A-S55-13765. Preferred phosphorous ester-based stabilizers are, for example, cyclic neopentane tetra-yl bis(octadecyl)phospite, cyclic neopentane tetra-yl bis(2,4-di-t-butylphenyl)phosphite, cyclic neopentane tetra-yl bis(2,6-di-t-butyl-4-methylphenyl)phosphite, 2,2-methylene bis(4,6-di-t-butylphenyl)octylphosphite, and tris(2,4-di-t-butylphenyl)phosphite.

### (3) Other Stabilizers

As a stabilizer, a weak organic acid, a thioether-based compound, or an epoxy compound may be blended.

The weak organic acid means acids having pka of at least 1, which are not especially limited provided that it does not interfere the action of the invention and has color-preventing properties and physical deterioration-preventing properties. Examples thereof are tartaric acid, citric acid, malic acid, fumaric acid, oxalic acid, succinic acid, and maleic acid. One or more such acids may be used either singly or as combined.

Examples of the thioether-based compound are dilauryl thiodipropionate, ditridecyl thiodipropionate, dimyristyl thiodipropionate, distearyl thiodipropionate, and palmityl stearyl thiodipropionate. One or more such compounds may be used either singly or as combined.

Example of the epoxy compound are those derived from epichlorohydrin and bisphenol-A, and also usable are derivatives from epichlorohydrin and glycerin, and cyclic compounds such as vinyl cyclohexane dioxide and 3,4-epoxy-6-methylcyclohexylmethyl-3,4-epoxy-6-methylcyclohexane carboxylate. Epoxidized soybean oil, epoxidized caster oil, and long chain-α-olefin oxides can be used too. One or more such compounds may be used either singly or as combined.

### (Matting Agent)

It is preferable that the cellulose acylate film according to the invention contains fine particles as a matting agent. Examples of the fine particles usable in the invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate.

These fine particles form the secondary particles having an average particle size of usually from 0.1 to 3.0 μm. In a film, these fine particles occur as aggregates of the primary particles and provide irregularities of 0.1 to 3.0 μm on the film surface. It is preferred that the average secondary particle size is from 0.2 μm to 1.5 μm, more preferably from 0.4 μm to 1.2 μm and most preferably from 0.6 μm to 1.1 μm. The primary or secondary particle size is determined by observing a particle in the film under a scanning electron microscope and referring the diameter of its circumcircle as the particle size. 200 particles are observed at various sites and the mean is referred to as the average particle size.

The preferred amount of the fine particles is in the range of 1 to 5,000 ppm, more preferably in the range of 5 to 1,000 ppm, and further preferably in the range of 1° to 500 ppm, relative to the amount of cellulose acylate as the weight ratio.

Fine particles containing silicon are preferred because of having a low turbidity. In particular, silicon dioxide is preferred. It is preferable that fine particles of silicone dioxide have an average primary particle size of 20 nm or less and an apparent specific gravity of 70 g/l or more. Fine particles having a small average primary particle size of 5 to 16 nm are more preferable, since the haze of the resultant film can be lowered thereby. The apparent specific gravity is preferably form 90 to 200 g/l or more and more preferably from 100 to 200 g/l or more. A higher apparent specific gravity makes it possible to prepare a dispersion having the higher concentration, thereby improving haze and aggregates.

As the fine particles of silicon dioxide, use can be made of marketed products such as AEROSIL R972, R972V, R974, R812, 200, 200V, 300, R202, OX50 and TT600 (each manufactured by Dehussa Japan Co., Ltd.). As the fine particles of zirconium oxide, use can be made of products marketed under the trade name of, for example, AEROSIL R976 and R811 (each manufactured by Dehussa Japan Co., Ltd.). Among these products, AEROSIL 200V and AEROSIL R972V are particularly preferable, since they are fine particles of silicon dioxide having an average primary particle size of 20 nm or less and an apparent specific gravity of 70 g/1 or more and exert an effect of largely lowering the coefficient of friction while maintaining the turbidity of the optical film at a low level.

### (Optical Adjuster)

An optical adjuster may be preferably added to the cellulose acylate of the invention. As the optical adjuster, there is a retardation adjuster, which is preferably contained in order to adjust the retardation of the cellulose acylate film of the invention. As the optical adjuster, two kinds of aromatic compounds may be simultaneously used as an aromatic compound having at least two aromatic rings. The aromatic ring of the aromatic compound described herein includes an aromatic hetero ring in addition to an aromatic hydrocarbon ring. As the examples of the optical adjuster, for example, that disclosed in Japanese Unexamined Patent Application Publication No. 2001-166144, Japanese Unexamined Patent Application Publication No. 2003-344655, Japanese Unexamined Patent Application Publication No. 2003-248117, or Japanese Unexamined Patent Application Publication No. 2003-66230 may be used and thus the in-plane retardation Re or the thickness retardation Rth can be controlled. The additive amount is preferably 0 to 15 mass %, more preferably 0 to 10 mass %, and most preferably 0 to 8% with respect to the cellulose acylate.

### (Other Additives)

An optical anisotropy controller, a surfactant, and an odor trapping agent (amine, etc.) can be added.

Materials whose details are described in Kokai Gifo of Japan Institute of Invention & Innovation, Kogi No. 2001-1745 (published Mar. 15, 2001, Japan Institute of Invention & Innovation), pages 17 to 22 are preferably used.

An infrared absorbing dye described, for example, in JP-A-2001-194522 may be used. An ultraviolet absorber described, for example, in JP-A-2001-151901 may be used. Preferably, each is included in cellulose acylate in a proportion of 0.001 to 5% by mass.

### <<Formation of Film>>

The cellulose acylate film may be formed by any one of a solution-casting film formation method and a melt-casting film formation method. These film forming methods will now be described in detail.

### (Solution-Casting Film Formation Method)

In a solution-casting film formation of the cellulose acylate resin, both of chlorine-containing solvents and chlorine-free solvents can be used for solvent.

### (1) Chlorine-Containing Solvent

The chlorine-containing organic solvent is preferably dichloromethane or chloroform. Dichloromethane is particularly preferred. Any organic solvent other than chlorine-containing organic solvent may be incorporated into the chlorine-containing organic solvent without particular problems. In this case, it is necessary to use dichloromethane in an amount of at least 50 weight %.

Chlorine-free solvents used in combination with the chlorine-containing solvent used in the present invention will be described below. Preferred examples of the chlorine-free solvent include esters, ketones, ethers, alcohols and hydrocarbons each having 3 to 12 carbon atoms. The esters, ketones, ethers and alcohols may have a cyclic structure. Compounds having two or more functional groups of ester, ketone or ether (i.e., —O—, —CO— or —COO—) may also be used as the solvent, and the organic solvents may also have other functional groups such as alcoholic hydroxyl group. Such solvents having two or more functional groups preferably have carbon atoms in a number within the range defined above for the compounds having any one of the functional groups. Examples of the esters having 3 to 12 carbon atoms include ethyl formate, propyl formate, pentyl formate, methyl acetate, ethyl acetate and pentyl acetate. Examples of the ketones having 3 to 12 carbon atoms include acetone, methyl ethyl ketone, diethyl ketone, diisobutyl ketone, cyclopentanone, cyclohexanone and methylcyclohexanone. Examples of the ethers having 3 to 12 carbon atoms include diisopropyl ether, dimethoxymethane, dimethoxyethane, 1,4-dioxane, 1,3-dioxolane, tetrahydrofuran, anisole and phenetole. Examples of the organic solvents having two or more functional groups include 2-ethoxyethyl acetate, 2-methoxyethanol and 2-butoxyethanol.

The alcohols used in combination with the chlorine-containing organic solvents may have a straight, branched or cyclic structure. The alcohol is particularly preferably a saturated aliphatic hydrocarbon. The alcohols may be any of primary, secondary and tertiary alcohols. Examples of the alcohols include methanol, ethanol, 1-propanol, 2-propanol, 1-butanol, 2-butanol, tert-butanol, 1-pentanol, 2-methyl-2-butanol and cyclohexanol. As the alcohol, a fluorine-containing alcohol may also be used. Examples include 2-fluoroethanol, 2,2,2-trifluoroethanol, 2,2,3,3-tetrafluoro-1-propanol and so forth. The hydrocarbons may have a straight, branched or cyclic structure. Either aromatic hydrocarbons or aliphatic hydrocarbons may be used. The aliphatic hydrocarbons may be saturated or unsaturated. Examples of the hydrocarbons include cyclohexane, hexane, benzene, toluene and xylene.

Although the chlorine-free organic solvent used together with the chlorine-containing organic solvent is are not particularly limited, it may be selected from methyl acetate, ethyl acetate, methyl formate, ethyl formate, acetone, dioxolane, dioxane, ketones and acetoacetic acid esters having 4 to 7 carbon atoms, and alcohols and hydrocarbons having 1 to 10 carbon atoms. Preferred examples of the chlorine-free organic solvent used together include methyl acetate, acetone, methyl formate, ethyl formate, methyl ethyl ketone, cyclopentanone, cyclohexanone, methyl acetylacetate, methanol, ethanol, 1-propanol, 2-propanol, 1-butanol, 2-butanol, cyclohexanol, cyclohexane and hexane.

Examples of the combination of the chlorine-containing organic solvents used as a preferred main solvent in the present invention include the following combinations. However, the combination used in the invention is not limited to these examples (the numerals in the parentheses mentioned below means parts by weight).

### Dichloromethane/butanol (94/6)

### Dichloromethane/butanol/methanol (84/4/12)

### Dichloromethane/methanol/ethanol/butanol (80/10/5/5)

### Dichloromethane/acetone/methanol/propanol (80/10/5/5)

### Dichloromethane/methanol/butanol/cyclohexane (80/10/5/5)

Dichloromethane/methyl ethyl ketone/methanol/butanol (80/10/5/5)
Dichloromethane/acetone/methyl ethyl ketone/ethanol/isopropanol (72/9/9/4/6)

### Dichloromethane/cyclopentanone/methanol/isopropanol (80/10/5/5)

Dichloromethane/methyl acetate/butanol (80/10/10)

### Dichloromethane/cyclohexanone/methanol/hexane (70/20/5/5)

Dichloromethane/methyl ethyl ketone/acetone/methanol/ethanol (50/20/20/5/5),
Dichloromethane/1,3-dioxolane/methanol/ethanol (70/20/5/5)

### Dichloromethane/dioxane/acetone/methanol/ethanol (60/20/10/5/5)

### Dichloromethane/acetone/cyclopentanone/ethanol/isobutanol/cyclohexane (65/10/10/5/5/5)

Dichloromethane/methyl ethyl ketone/acetone/methanol/ethanol (70/10/10/5/5)
Dichloromethane/acetone/ethyl acetate/ethanol/butanol/hexane (65/10/10/5/5/5)
Dichloromethane/methyl acetoacetate/methanol/ethanol (65/20/10/5)

### Dichloromethane/cyclopentanone/ethanol/butanol (65/20/10/5)

### (2) Chlorine-Free Solvent

Preferred chlorine-free solvent is selected from esters, ketones and ethers each having 3 to 12 carbon atoms. The esters, ketones and ethers may have a cyclic structure.

Compounds having two or more functional groups of ester, ketone or ether (i.e., —O—, —CO— or —COO—) may also be used as the main solvent, and the organic solvents may have other functional groups such as alcoholic hydroxyl group. Such solvents having two or more functional groups preferably have carbon atoms in a number within the range defined above for the compounds having any one of the functional groups. Examples of the esters having 3 to 12 carbon atoms include ethyl formate, propyl formate, pentyl formate, methyl acetate, ethyl acetate and pentyl acetate. Examples of the ketones having 3 to 12 carbon atoms include acetone, methyl ethyl ketone, diethyl ketone, diisobutyl ketone, cyclopentanone, cyclohexanone and methylcyclohexanone. Examples of the ethers having 3 to 12 carbon atoms include diisopropyl ether, dimethoxymethane, dimethoxyethane, 1,4-dioxane, 1,3-dioxolane, tetrahydrofuran, anisole and phenetole. Examples of the organic solvents having two or more functional groups include 2-ethoxyethyl acetate, 2-methoxyethanol and 2-butoxyethanol.

Further examples of the solvent preferred for the solution-casting film formation used in the present invention include a mixed solvent composed of three or more kinds of different solvents. The first solvent is one selected from methyl acetate, ethyl acetate, methyl formate, ethyl formate, acetone, dioxolane and dioxane or a mixed solvent of two or more kinds of them. The second solvent is selected from ketones having 4 to 7 carbon atoms and acetoacetic acid esters. The third solvent is selected from alcohols or hydrocarbons having 1 to 10 carbon atoms, preferably alcohols having 1 to 8 carbon atoms. When the first solvent is a mixture of two or more kinds of solvents, the second solvent may not be used. The first solvent is preferably methyl acetate, acetone, methyl formate, ethyl formate or a mixture thereof. The second solvent is preferably methyl ethyl ketone, cyclopentanone, cyclohexanone, methyl acetylacetate or a mixture thereof.

The alcohol as the third solvent may have a straight, branched or cyclic structure. In particular, the third solvent is preferably an alcohol derived from a saturated aliphatic hydrocarbon. The alcohol may be any of primary, secondary and tertiary alcohols. Examples of the alcohol include methanol, ethanol, 1-propanol, 2-propanol, 1-butanol, 2-butanol, tert-butanol, 1-pentanol, 2-methyl-2-butanol and cyclohexanol. As the alcohol, a fluorine-containing alcohol may also be used. Examples thereof include 2-fluoroethanol, 2,2,2-trifluoroethanol and 2,2,3,3-tetrafluoro-1-propanol. The hydrocarbon may have a straight, branched or cyclic structure. Either an aromatic hydrocarbon or an aliphatic hydrocarbon may be used. The aliphatic hydrocarbon may be saturated or unsaturated. Examples of the hydrocarbon include cyclohexane, hexane, benzene, toluene, xylene and so forth. The alcohols and the hydrocarbons as the third solvent may be used independently or as a mixture of two or more kinds of them. Specific examples of compounds as the third solvent include alcohols such as methanol, ethanol, 1-propanol, 2-propanol, 1-butanol, 2-butanol and cyclohexanol, cyclohexane and hexane. Among these, methanol, ethanol, 1-propanol, 2-propanol and 1-butanol are particularly preferred.

The aforementioned mixed solvent of three kinds of solvents preferably contains the first, second and third solvents at proportions of 20 to 95 weight %, 2 to 60 weight % and 2 to 30 weight %, respectively, more preferably 30 to 90 weight %, 3 to 50 weight % and 3 to 25 weight %, respectively. Still more preferably, the mixed solvent contains 30 to 90 weight % of the first solvent, 3 to 30 weight % of the second solvent and 3 to 15 weight % of an alcohol as the third solvent. When the first solvent is a mixture, and the second solvent is not used, the first and third solvent are preferably contained at proportions of 20 to 90 weight % and 5 to 30 weight %, respectively, more preferably 30 to 86 weight % and 7 to 25 weight %, respectively. The aforementioned chlorine-free organic solvents used in the present invention are described in more detail in Kokai Gifo of Japan Institute of Invention & Innovation, Kogi No. 2001-1745, published on Mar. 15, 2001, pp. 12-16.

Preferred examples as main solvent of the combination of the chlorine-free organic solvents used for the present invention are described below. However, the combination can be used in the invention is not limited to these examples (the numerals in the parentheses mentioned below means parts by weight).

Methyl acetate/acetone/methanol/ethanol/butanol (75/10/5/5/5)
Methyl acetate/acetone/methanol/ethanol/propanol (75/10/5/5/5)
Methyl acetate/acetone/methanol/butanol/cyclohexane (75/10/5/5/5)
Methyl acetate/acetone/ethanol/butanol (81/8/7/4)
Methyl acetate/acetone/ethanol/butanol (82/10/4/4)
Methyl acetate/acetone/ethanol/butanol (80/10/4/6)
Methyl acetate/methyl ethyl ketone/methanol/butanol (80/10/5/5)
Methyl acetate/acetone/methyl ethyl ketone/ethanol/isopropanol (75/8/8/4/5)
Methyl acetate/cyclopentanone/methanol/isopropanol (80/10/5/5)
Methyl acetate/acetone/butanol (85/10/5)
Methyl acetate/cyclopentanone/acetone/methanol/butanol (60/15/15/5/5)
Methyl acetate/cyclohexanone/methanol/hexane (70/20/5/5)
Methyl acetate/methyl ethyl ketone/acetone/methanol/ethanol (50/20/20/5/5)
Methyl acetate/1,3-dioxolane/methanol/ethanol (70/20/5/5)
Methyl acetate/dioxane/acetone/methanol/ethanol (60/20/10/5/5)
Methyl acetate/acetone/cyclopentanone/ethanol/isobutanol/cyclohexane (65/10/10/5/5/5)
Methyl formate/methyl ethyl ketone/acetone/methanol/ethanol (50/20/20/5/5)
Methyl formate/acetone/ethyl acetate/ethanol/butanol/hexane (65/10/10/5/5/5)
Acetone/methyl acetoacetate/methanol/ethanol (65/20/10/5)

### Acetone/cyclopentanone/ethanol/butanol (65/20/10/5)

Acetone/1,3-dioxolane/ethanol/butanol (65/20/10/5)
1,3-Dioxolane/cyclohexanone/methyl ethyl ketone/methanol/butanol (55/20/10/5/5/5)

Further, it is also preferable to dissolve the resin in multiple steps by, after dissolution, further adding a part of the solvents, as summarized below (the numerals in the parentheses mentioned below means parts by weight).

Preparation of a cellulose acylate resin solution with methyl acetate/acetone/ethanol/butanol (81/8/7/4), filtration, concentration and subsequent further addition of 2 weight parts of butanol

Preparation of a cellulose acylate resin solution with methyl acetate/acetone/ethanol/butanol (81/10/4/2), filtration, concentration and subsequent further addition of 4 weight parts of butanol.

Preparation of a cellulose acylate resin solution with methyl acetate/acetone/ethanol (84/10/6), filtration, concentration and subsequent further addition of 5 weight parts of butanol

### (3) Preparation of Solution

The cellulose acylate of the invention is preferably molten in an organic solvent by 10 to 35 mass %, more preferably 13 to 30 mass %, and most preferably 15 to 28 mass %. In order to control the cellulose acylate solution to the above concentration, the cellulose acylate solution is controlled to have a predetermined concentration in a melting step and controlled to have a predetermined high-concentration solution by the below-described condensation process after a low concentration solution (for example, 9 to 14 mass %) is previously produced. A predetermined low-concentration cellulose acylate solution may be produced by previously producing a high-concentration cellulose acylate solution and adding various additive agents. Prior to the melting, the cellulose acylate is swollen for 0.1 hours to 100 hours at 0° C. to 50° C. The various additive agents may be added before the swelling process, during or after the swelling process, or during or after a cooling dissolving process.

In the preparation of the cellulose acylate solution (dope), the dissolving method is not specially limited. The cellulose acylate may be dissolved at a room temperature or the cellulose acylate may be dissolved by a cooling dissolving method, a high-temperature dissolving method or a combination thereof. The method of preparing the cellulose acylate solution is disclosed in Japanese Unexamined Patent Application Publication No. 5-163301, Japanese Unexamined Patent Application Publication No. 61-106628, Japanese Unexamined Patent Application Publication No. 58-127737, Japanese Unexamined Patent Application Publication No. 9-95544, Japanese Unexamined Patent Application Publication No. 10-95854, Japanese Unexamined Patent Application Publication No. 10-95854, Japanese Unexamined Patent Application Publication No. 10-45950, Japanese Unexamined Patent Application Publication No. 2000-53784, Japanese Unexamined Patent Application Publication No. 11-322946, Japanese Unexamined Patent Application Publication No. 11-322947, Japanese Unexamined Patent Application Publication No. 2-276830, Japanese Unexamined Patent Application Publication No. 2000-273239, Japanese Unexamined Patent Application Publication No. 11-71463, Japanese Unexamined Patent Application Publication No. 04-259511, Japanese Unexamined Patent Application Publication No. 2000-273184, Japanese Unexamined Patent Application Publication No. 11-323017, Japanese Unexamined Patent Application Publication No. 11-302388, Japanese Unexamined Patent Application Publication No. 10-67860, Japanese Unexamined Patent Application Publication No. 10-324774. A method of dissolving the cellulose acylate in an organic solvent may be properly applied to the invention. With respect to a non-chlorine-based solvent, the method disclosed in 22 pages to 25 pages of open technical report No. 2001-1745, Japan Institute of Invention and Innovation issued on Mar. 15, 2001 is performed. When the dope solution of the cellulose acylate is prepared, solution condensation and filtering are performed and are disclosed in detail in 25 pages of open technical report No. 2001-1745, Japan Institute of Invention and Innovation issued on Mar. 15, 2001. When the cellulose acylate is dissolved at a high temperature, the cellulose acylate is dissolved at a boiling point or more of the organic solvent used and, in this case, is dissolved in a pressurized state.

The cellulose acylate solution of the invention is preferably in a range that the viscosity of the solution and dynamic storage elastic modulus are specified. In order to obtain these values with respect to a sample solution of 1 mL, measurement is performed using Steel Cone (made by TA Instruments) having a diameter of 4 cm/2′ in a rheometer (CLS 500). The measurement is performed by oscillation step/temperature ramp in a range of 40° C. to −10° C. at 2° C./min and a storage elastic modulus G′ (Pa) of −5° C. and static non-Newton viscosity n*(Pa·s) of 40° C. are obtained. In addition, the sample solution is measured after previously keeping warm until the temperature of liquid becomes constant at a measurement start temperature. In the invention, it is preferable that the viscosity at 40° C. is 1 to 400 Pa·s and the dynamic storage elastic modulus at 15° C. is 500 Pa or more, and it is more preferable that the viscosity at 40° C. is 10 to 200 Pa·s and the dynamic storage elastic modulus at 15° C. is 100 to 1000000 Pa. It is preferable that the dynamic storage elastic modulus at a low temperature is large. For example, if a casting support has −5° C., the dynamic storage elastic modulus is preferably 10000 to 1000000 Pa at −5° C., and, if a casting support has −50° C., the dynamic storage elastic modulus is preferably 10000 to 5000000 Pa at −50° C.

### (4) Detailed Explanation of Solution-Casting Film Formation Method

Next, a solution-casting film formation method will be described in detail. As a method and apparatus for producing the cellulose acylate film of the invention, a method and apparatus for forming a solution casting film provided in the production of the conventional cellulose acylate film may be used. A dope (cellulose acylate solution) prepared from a dissolving machine (iron pot) is stored in a storage pot, bubbles contained in the dope are deformed, and a final preparation is performed. The dope is delivered from an outlet to a pressurizing die through a pressurizing gear pump for transmitting liquid with high precision, the dope flows from a cap (slit) of a pressurizing die onto a metal support of a casting portion which runs endlessly, and a half-dried dope film (also called a web) is peeled from the metal support at a peeling point in which the metal support substantially circuits. The both ends of the obtained web are inserted between the chucks (clips), the web is carried to the tenter and dried while maintaining the width thereof, is carried to a roll group of a dry device to finish the dry, and is wound by a predetermined length using a winding machine. A combination of the tenter and the dry device of the roll group is changed according to the purpose thereof. In the method of forming the solution casting film used in a photographic sensitive material such as silver halide or a protective film for an electronic display, a coating device may be added in order to perform a surface treatment of a film such as an undercoated layer, an antistatic layer, a halation preventing layer, and a protective layer in addition to the apparatus for forming the solution casting film. The production methods are disclosed in page 25 to page 30 of open technical report No. 2001-1745, Japan Institute of Invention and Innovation issued on Mar. 15, 2001, which includes casting (including all casting), a metal support, dry, peeling, and drawing.

In the invention, the spatial temperature of the casting portion is not specially limited, but is preferably −5° to 50° C., more preferably −3° to 40° C., and most preferably −2° to 30° C. In particular, the cellulose acylate solution casted by a low spatial temperature is instantly cooled on the support to improve a gel strength such that a film including an organic solvent is held. Accordingly, it is possible to peel the film from the support in a short time without evaporating the organic solvent from the cellulose acylate and to realize high-speed casting. As means for cooling the space, air, nitrogen, argon, or helium may be used and the kind thereof is not specially limited. In this case, the relative humidity is preferably 0 to 70% and more preferably 0 to 50%. In the invention, the temperature of the support of the casting portion for casting the cellulose acylate solution is −50 to 130° C., more preferably −3° to 25° C., and most preferably −2° to 15° C. In order to maintain the casting portion at the temperature of the invention, cooled gas may be introduced into the casting portion or a cooling device may be provided in the casting portion to perform cooling. At this time, water is not adhered and a method using dried gas may be used.

The cellulose acylate solution which is preferably used in the invention is a cellulose acylate solution including at least one liquid or solid plasticizing agent by 0.1 to 20 mass % with respect to the cellulose acylate at 25° C., and/or a cellulose acylate solution including at least one liquid or solid ultraviolet absorber by 0.001 to 5 mass % with respect to the cellulose acylate, and/or a cellulose acylate solution including fine particles which include at least one type of solid and has an average grain size of 5 to 3000 nm by 0.001 to 5 mass % with respect to the cellulose acylate, and/or a cellulose acylate solution including at least one type of fluorine-based interfacial active agent by 0.001 to 2 mass % with respect to the cellulose acylate, and/or a cellulose acylate solution including at least one type of stripping agent by 0.0001 to 2 mass % with respect to the cellulose acylate, and/or a cellulose acylate solution including at least one type of deterioration-preventive agent by 0.0001 to 2 mass % with respect to the cellulose acylate, and/or a cellulose acylate solution including at least one type of optical anisotropy control agent by 0.1 to 15 mass % with respect to the cellulose acylate, and/or a cellulose acylate solution including at least one type of infrared absorber by 0.1 to 5 mass % with respect to the cellulose acylate.

In the casting process, one kind of cellulose acylate solution may be casted into a single layer or two kinds of cellulose acylate solutions may be simultaneously or sequentially co-casted. In the casting process including two layers or more, a cellulose acylate solution and a cellulose acylate film are preferably a cellulose acylate solution and a cellulose acylate film produced by the solution, in which the compositions of a chlorine-based solvents of the layers are equal or different, the additive agents of the layers is one kind of material or a mixture of two kinds of materials, the addition positions of the additive agents of the layers are equal or different, the concentrations of the additive agents in the solutions are equal or different in all the layers, the association molecular weights of the layers are equal or different, the temperature of the solutions of the layers are equal or different, the coating quantities of the layers are equal or different, the viscosities of the layers are equal or different, the thicknesses of the layer after dry are equal or different, the materials contained in the layers are identical state or distributions or different states or distributions, the physical properties of the layers are equal or different, the physical properties of the layers are distributions of identical or different physical properties. Here, the physical property includes the physical property disclosed in page 6 to page 7 of open technical report No. 2001-1745, Japan Institute of Invention and Innovation issued on Mar. 15, 2001, which includes, for example, haze, transmissivity, spectroscopical characterization, retardations Re and Rth, a molecule orientation axis, axis shift, tear strength, folding strength, tensile strength, a difference between inner and outer winding Rt, backlash, kinetic friction, alkali hydrolysis, a curl value, percentage of water content, quantity of residual solvent, a heat shrink ratio, high humidity value evaluation, a moisture permeation degree, flatness of a base, dimension stability, a heat shrink start temperature, elastic modulus, the measurement of luminescent foreign matters, and impedance and sheet used in the evaluation of the base. The yellow index, the transparency degree, and thermophysical properties Tg (crystallization heat) of the cellulose acylate disclosed in page 11 of open technical report No. 2001-1745, Japan Institute of Invention and Innovation issued on Mar. 15, 2001 are enumerated.

In the dry process, the both ends of the obtained web by peeling are inserted between the chucks (clips), the web is carried to the tenter and dried while maintaining the width thereof, is carried to a roll group of a dry device to finish the dry, and is wound by a predetermined length using a winding machine. A combination of the tenter and the dry device of the roll group is changed according to the purpose thereof. In the method of forming the solution casting film used in a photographic sensitive material such as silver halide or a protective film for an electronic display, a coating device may be added in order to perform a surface treatment of a film such as an undercoated layer, an antistatic layer, a halation preventing layer, and a protective layer in addition to the apparatus for forming the solution casting film.

In the invention, the dry method in the solution-casting film formation method is not specially limited, but a dry method for gradually rising the temperature of a film in a state that a solvent is included is more preferable in view of ensuring the optical elasticity of the film. A retardation film including the cellulose acylate film of the invention may be adhered with a polarization film in a liquid crystal display device. Most of the polarization film is uniaxially drawn by immersing iodine in PVA. Since the PVA has a hydrophilic property, expansion and shrinkage are repeated according to a variation in humidity. Accordingly, the cellulose acylate film adhered with the polarization film is subjected to shrinkage or expansion stress and, as a result, the orientation of the cellulose acylate molecules vary and thus Re and Rth vary. The variation in Re and Rth due to the stress may be measured by optical elasticity and is preferably 1 to 25×10⁻⁷ (cm²/kgf), more preferably, 1 to 20×10⁻⁷ (cm²/kgf), and most preferably 1 to 18×10⁻⁷ (cm²/kgf).

The winding process is performed after the web is dried in the dry process using the above-described method, the both ends thereof are trimmed, and the web is subjected to an embossing process (Knurling process). The residual solvent in the dried film is preferably 0 mass % to 1 mass % and more preferably 0 mass % to 0.5 mass %. After the dry process, the both ends of the web are trimmed and the web is wound. The width thereof is preferably 0.5 m to 5 m, more preferably 0.7 m to 3 m, and most preferably 1 m to 2 m. The winding length is preferably 300 m to 30000 m, more preferably 500 m to 10000 m, and most preferably 1000 m to 7000 m. Before winding, a lamination film is preferably adhered to at least one surface of the web in view of preventing scratch.

The film thickness after dry is preferably 30 to 200 μm, more preferably 35 μm to 180 μm, and most preferably 40 μm to 150 μm. The thickness variation of an undrawn original fabric film is preferably 0% to 2%, more preferably 0% to 1.5%, and most preferably 0 to 1% in the thickness direction or the transverse direction.

### (Melt-Casting Film Formation Method)

### (1) Pelletization

Prior to the melt-casting film formation, the transport thermoplastic resin and the additive are preferably mixed and palletized.

When carrying out the pelletization, preferably the cellulose acylate and the additive are dried previously, but a bent type extruder may be used instead of the drying. In case where the drying is carried out, such drying method can be employed as heating them in a heating furnace at 90° C. for at least 8 hours, but this is not the only one method. The pellet can be formed by melting the cellulose acylate and the additive using a twin screw kneading extruder at 150 to 250° C., and solidifying the extruded product in a noodle state in water and then cutting it. The pellet may also be formed according to an under water cutting method in which the mixture is molten with an extruder and then extruded from a pipe sleeve directly into water to be cut.

For the extruder, any publicly known single screw extruder, non-intermeshing counter-rotating twin screw extruder, intermeshing counter-rotating twin screw extruder, intermeshing corotating twin screw extruder can be used as long as it can give sufficient melt kneading.

The pellet has preferably such size as the cross-sectional area of 1 to 300 mm² and the length of 1 to 30 mm, more preferably the cross-sectional area of 2 to 100 mm² and the length of 1.5 to 10 mm. When the pellet is formed, the additive also may be thrown through the raw material-throwing port or vent port provided in the midstream of an extruder.

The extruder has a rotation number of preferably 10 to 1000 rpm, more preferably 20 to 700 rpm, even more preferably 30 to 500 rpm. The rotation number of at least 10 rpm can realize reasonable staying time, and thus the lowering of molecular weight caused by thermal degradation and yellow hue deterioration hardly occurs. When the rotation number is at most 1000 rpm, the break of the molecule due to shear hardly occurs, and thus the lowering of the molecular weight and the increase in the generation of cross-linked gel hardly occur.

In the pelletization, the staying time in the extruder is preferably 10 seconds to 30 minutes, more preferably 15 seconds to 10 minutes, even more preferably 30 seconds to 3 minutes. When sufficient melting is possible, a shorter staying time is preferred in point that the degradation of resin and the generation of yellow hue can be prevented.

### (2) Drying

It is preferable that the moisture in the pellet is reduced prior to the melt-casting film formation. For the drying, a dehumidification air dryer is often used, but the means for the drying is not limited only when an intended water content is attained (efficient drying is preferred by employing such means as heating, air blasting, pressure reduction and stirring either singly or as combined; more preferably a drying hopper is formed into a heat-insulated structure). The drying temperature is preferably 0 to 200° C., more preferably 40 to 180° C., especially preferably 60 to 150° C. Such drying temperature can effectively prevent blocking due to the adhesion of resin with keeping a proper value of water content. The drying air volume is preferably 20 to 400 m³/hr, more preferably 50 to 300 m³/hr, especially preferably 100 to 250 m³/hr. When the drying air volume is at least 20 m³/hr, drying is more effectively performed. On the other hand, when the drying air volume is at most 400 m³/hr, it is preferable for the economical point with the sufficient drying effect. The drying air has a dew point of preferably 0 to −60° C., more preferably −10 to −50° C., especially preferably −2° to −40° C. The necessary drying time is usually at least 15 minutes, preferably at least 1 hour, especially preferably at least 2 hours. On the other hand, when the drying time is at most 2 hours, the heat deterioration of the resin is favorably prevented. The polymer in the invention has the water content of preferably at most 1.0% by mass, more preferably at most 0.1% by mass, especially preferably at most 0.01% by mass.

### (3) Melt Extruding

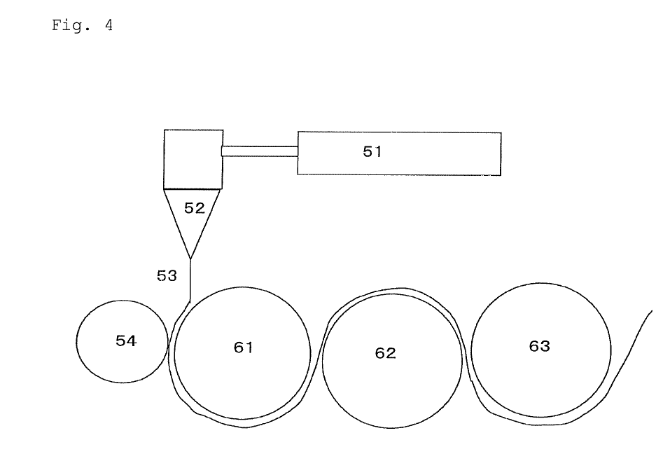

The above-described cellulose acylate resin is fed into a cylinder via a feeding port of an extruder. FIG. 3 is a schematic diagram of a typical extruder 22 which can be used in the invention. The cylinder 32 includes a feeding portion (region A) for transmitting the cellulose acylate resin fed from the feeding port, a compression zone (region B) for melting, mixing, and compressing the cellulose acylate resin, and a metering zone (region C) for metering the molten, mixed, and compressed cellulose acylate resin in this order from the feeding port 40. In order to reduce the water content of the resin by the above-described method, the dry process is preferably performed. However, in order to prevent the molten resin from being oxidized due to residual oxygen, evacuation is more preferably performed using an extruder attached with a vent in inert gas (nitrogen or the like) flow in the extruder. The screw compression ratio of the extruder is set to 2.5 to 4.5 and L/D is set to 20 to 70. Here, the screw compression ratio indicates a volume ratio between the feeding portion A and the metering zone C, that is, the volume per unit length of the feeding portion A÷the volume per unit length of the metering zone C, and is calculated using the outer diameter d1 of the screw axis of the feeding portion A, the outer diameter d2 of the screw axis of the metering zone C, the diameter a1 of a groove of the feeding portion A, and the diameter a2 of a groove of the metering zone C. The L/D is a ratio of the length of the cylinder to the inner diameter of the cylinder. The extruding temperature is set to 190 to 240° C. If the temperature of the extruder exceeds 230° C., a cooler may be provided between the extruder and the die.

If the screw compression ratio is too small, that is, is less than 2.5, the melting and mixing are insufficient to occur a non-dissolved portion or shear heating is too low such that the melting of crystal is insufficient. Thus, fine crystal is apt to remain in the cellulose acylate film after production and bubble is apt to occur. Accordingly, if the strength of the cellulose acylate film is reduced or the film is drawn, the residual crystal deteriorates a drawing property and the orientation is insufficient. In contrast, if the screw compression ratio is too large, that is, is greater than 4.5, shear stress is too applied and thus the resin is apt to deteriorate by heating. Accordingly, the cellulose acylate film after the production has a tinge of yellow. If the shear stress is too applied, molecules are cut, the molecular weight is reduced, and the mechanical strength of the film deteriorates. Accordingly, in order to prevent the cellulose acylate film after the production from having a tinge of yellow, to improve the strength of the film, and to prevent fracture due to the drawing, the screw compression ratio is preferably 2.5 to 4.5, more preferably 2.8 to 4.2, and most preferably 3.0 to 4.0.

If the L/D is too small, that is, is less than 2°, melting or mixing is insufficient and thus fine crystal is apt to remain in the cellulose acylate film after the production similar to the case where the compression ratio is small. In contrast, if the L/D is too large, that is, is greater than 7°, a holding time of the cellulose acylate resin in the extruder becomes too large and thus the resin is apt to occur. In addition, if the holding time becomes large, molecules are cut, the molecular weight is reduced, and the mechanical strength of the cellulose acylate film deteriorates. Accordingly, in order to prevent the cellulose acylate film after the production from having a tinge of yellow, to improve the strength of the film, and to prevent fracture due to the drawing, the L/D is preferably 20 to 70, more preferably 22 to 65, and most preferably 24 to 50.

The extruding temperature is preferably in the above-described range. The obtained cellulose acylate film has characteristic values such as a haze of 2.0% or less and a yellow index (YI value) of 10 or less.

Here, the haze is an indicator indicating whether the extruding temperature is too low, that is, the quantity of the crystal left in the cellulose acylate film after the production is large or small. If the haze is greater than 2.0%, the strength of the cellulose acylate film after the production is reduced and the fracture upon the drawing is apt to occur. The yellow index (YI value) is an indicator indicating whether the extruding temperature is too high. If the yellow index (YI value) is 10 or less, no problem occurs in view of the tinge of yellow.

For the type of the extruder, generally a single screw extruder that requires a relatively low facility cost is used frequently, including such screw types as full-flight, Maddock and Dulmage. For the cellulose acylate resin having a comparatively low thermal stability, the full-flight type is preferred. The use of a twin screw extruder, which can practice the extrusion while volatizing unnecessary volatile components through a vent port provided in the midstream by changing the screw segment, is also possible, although the cost of facilities is high. The twin screw extruder is mainly classified into two types, i.e., co-rotation and counter-rotation types, both of which are usable herein. Of these, a co-rotation type, which hardly allows an accumulation portion to occur and has a high self-cleaning performance, is preferred. The twin screw extruder is suitable for the film formation of polymer because it has a high kneading ability and high feeding performance of resin to make extrusion at low temperatures possible, although facilities are expensive. By disposing a vent port properly, the direct use of undried polymer pellets or powder is also possible. Selvage of a film etc. that are formed during the film formation may be reused directly without drying.

The preferred diameter of a screw varies depending on a targeted extrusion volume per unit time, and is preferably 10-300 mm, more preferably 20-250 mm, even more preferably 30-150 mm.

### (4) Filtration

In order to filtrate foreign substances in resin or avoid damage of a gear pump caused by foreign substances, a so-called breaker plate type filtration is preferably carried out, wherein a filtering medium is provided for the extruder outlet. In addition, in order to filtrate foreign substances with a higher accuracy, a filtering apparatus built with a so-called leaf type disc filter is preferably disposed after the pass of the gear pump. The filtration can be effected by providing one filtration section, or may be multi-step filtration effected by providing a plurality of filtering sections. The filtering medium preferably may have a higher filtration accuracy, but from the viewpoint of the pressure capacity of the filtering medium or the increase of filtering pressure that is caused by the clogging of the filtering medium, the filtration accuracy is preferably 15-3 μm, more preferably 10-3 μmm. In particular, in case where an apparatus using a leaf type disc filter that carries out final foreign substance filtration is employed, the use of a filtering medium having a high accuracy is preferred in point of the quality, and the adjustment based on the loading number of the filter sheet is possible for the purpose of securing the fitness for the pressure capacity and the lifetime of the filter. For the type of the filtering medium, since it is used under high temperatures and high pressures, the use of steel materials are preferred, and of these, the use of stainless steel or steel is preferred, and the use of stainless steel is especially desirable in point of corrosion resistance. For the filtering medium, in addition to those having a constitution formed by knitting wire material, a sintered filtering medium formed by sintering, for example, metal long fibers or metal powder can be used, and the sintered filtering medium is preferred from the viewpoint of the filtration accuracy and filter life.

### (5) Gear Pump

To improve uniformity in the thickness, reducing fluctuation in the discharge amount is important. Disposing a gear pump between the extruder and the die, and supplying a fixed amount of a cellulose acylate resin through the gear pump is effective. Such a gear pump has a pair of gears, i.e., a drive gear and a driven gear engaged with each other. By driving the drive gear to engage and rotate the two gears, a molten resin is sucked into the cavity through a suction port provided on the housing, and the resin is discharged through a discharge port also provided on the housing in a constant amount. Even if the pressure of the resin at the tip of the extruder slightly fluctuates, such fluctuation is absorbed by the use of the gear pump, and thus the fluctuation in the pressure of the resin in the downstream of the film forming apparatus becomes very small, and this improves thickness fluctuation. By using a gear pump, the fluctuation of the pressure resin at the die can be kept within +/−1%.

To improve the capability of volumetric feeding of gear pumps, an approach of controlling the pressure before a gear pump at a constant value by changing the rotational number of the screw is also applicable. A high accuracy gear pump using 3 or more gears in which fluctuation in the gear is eliminated is also effective.

For other advantages of using a gear pump, since film forming can be performed with a decreased pressure at the screw tip, reduction of energy consumption, prevention of increase in the resin temperature, improvement in transportation efficiency, shortening of the residence time in the extruder and reduction of the L/D in the extruder can be expected. Further, when using a filter for removing contaminants, the amount of the resin supplied through the screw may fluctuate due to increase in the filtration pressure in the absence of a gear pump; this problem, however, can be solved by using a gear pump in combination. On the other hand, such a gear pump has a disadvantage that equipment becomes long depending on which equipment is selected, and the residence time of the resin is extended. In addition, due to the shearing stress in the gear pump, molecular chains may be broken. Accordingly, attention must be paid to these disadvantages.

A preferred residence time for a resin which is introduced into the extruder through a supply port and discharged from the die is from 2 to 60 minutes, more preferably from 3 to 40 minutes, and further preferably from 4 to 30 minutes.

If the flow of polymer for circulation in a bearing of the gear pump becomes poor, sealing with the polymer at the driving part and the bearing part becomes poor, causing problems such as large fluctuation in the pressure of measurement and the pressure of extrusion and feeding of liquid. Therefore, designing of gear pumps (particularly clearance) in accordance with the melt viscosity of cellulose acylate resin is necessary. Further, in some cases, the residence part in the gear pump gives rise to deterioration of transparent thermoplastic resin, and therefore a structure with the smallest possible residence is preferred. A polymer tube and adapters connecting the extruder and the gear pump or the gear pump and the die must also be designed with the smallest possible residence. In addition, for the stabilization of the extrusion pressure of transparent thermoplastic resin whose melt viscosity is highly dependent on the temperature, fluctuation in the temperature is preferably kept as small as possible. In general, a band heater whose equipment cost is low is often used for heating the polymer tube, but an aluminum cast heater with a smaller temperature fluctuation is more preferably used. Further, to stabilize the discharge pressure of the extruder as described above, melting is preferably performed by heating with a heater dividing the barrel of the extruder into 3 to 20 areas.

### (6) Die

A transparent thermoplastic resin is melted in an extruder configured as above, and the molten resin is continuously fed to a die, if necessary, through a filtering device and/or a gear pump. Any type of commonly used dies such as a T-die, a fish-tail die, and a hanger coat die may be used as long as the die is designed so that the residence of the molten resin in the die is short. A static mixer may be disposed immediately before the T die in order to improve uniformity of the resin temperature. The clearance of the T die outlet is generally 1.0 to 5.0 times, preferably 1.2 to 3 times, more preferably 1.3 to 2 times the film thickness. When the lip clearance is less than 1.0 times the film thickness, a well-formed sheet is difficult to obtain by film forming. When the lip clearance is larger than 5.0 times the film thickness, the uniformity in the thickness of the sheet is disadvantageously decreased. The die is a very important device for determining the thickness uniformity of the film, and a die capable of precisely controlling the thickness is preferred. The thickness is generally controllable in increments of 40 to 50 mm, but dies capable of controlling the film thickness in increments of preferably 35 mm or less, more preferably 25 mm or less are preferred. In order to improve the uniformity of the formed film, a design in which unevenness in the temperature of the die and unevenness in the flow rate in the width direction are as small as possible is essential. In addition, an automatic thickness control die in which the film thickness in the downstream is measured to calculate thickness deviation and the result is given as a feedback for controlling the thickness in the die is effective for reducing thickness fluctuation in a long-term continuous production.

A single layer film forming apparatus whose equipment cost is low is generally used for producing a film. In some cases, however, a multi-layer film forming apparatus may also be used for forming a functional layer as an outer layer so as to produce a film having two or more structures. Generally, a thin functional layer is preferably stacked on the surface layer, and the ratio of the thickness of the layers is not particularly limited.

### (7) Casting

A molten resin extruded in the form of a sheet through a die according to the above method is solidified by cooling on a casting drum to give a film. In this step, contact between the casting drum and the melt-extruded sheet is preferably increased using an electrostatic application method, an air knife method, an air chamber method, a vacuum nozzle method, or a touch roll method. Such a method of improving the contact may be performed on the entire surface of the melt-extruded sheet or on some part. In particular an adhesion improving method of which only both side of the film are contacted, called edge pining method, is often used, but it is not limited in that method.

A touch roll method is preferable as an adhesion improving method. In this method, the melt discharged from the die is inserted between the casting drum and the touch roll to be cooled and solidified and the melt is uniformly adhered to the casting drum. As a result, the uniformity of the structure (orientation) or the thickness of the formed film can be improved, the uniformity of the retardation after the drawing is improved, and color unevenness can be reduced. For example, as shown in FIG. 4, the melt passes from the extruder 51 to the die 52 and the cellulose acylate molten material (melt) 53 is fed onto a first casting roll 61 and is in contact with a touch roll 54, and is guided to a second casting roll 62 and a third casting roll 63.

The touch roll preferably has elasticity in order to reduce residual distortion which occurs when the melt discharged from the die is inserted between the rolls. In order to apply elasticity to the roll, the thickness of the outer tube of the roll is smaller than that of a general roll, and the thickness Z of the outer tube is preferably 0.05 mm to 7.0 mm, more preferably 0.2 mm to 5.0 mm, and most preferably 0.3 mm to 2.0 mm. For example, the touch roll is formed by reducing the thickness of the outer tube to apply elasticity or providing an elastic layer on a metal shaft, covering an outer tube, and filling a liquid medium layer between the elastic layer and the outer tube. The surfaces of the casting roll and the touch roll are preferably mirror surfaces and the average heights Ra thereof are preferably 100 nm or less, more preferably 50 nm or less, and more preferably 25 nm or less. In more detail, for example, that disclosed in Japanese Unexamined Patent Application Publication No. 11-314263, Japanese Unexamined Patent Application Publication No. 2002-36332, Japanese Unexamined Patent Application Publication No. 11-235747, Japanese Unexamined Patent Application Publication No. 2004-216717, Japanese Unexamined Patent Application Publication No. 2003-145609, or PCT Publication No. 97/28950 may be used.

When the touch roll, in which liquid is filled in the thin outer tube, contacts the casting roll, the touch roll is elastically deformed in a concave shape by the pressure. Accordingly, since the touch roll and the casting roll surface-contact each other, the pressure is distributed and a low surface pressure is realized. Thus, it is possible to correct fine irregularities of the surface without residual distortion in the film inserted therebetween. The linear pressure of the touch roll is preferably 3 kg/cm to 100 kg/cm, more preferably 5 kg/cm to 80 kg/cm, and most preferably 7 kg/cm to 60 kg/cm. The linear pressure described herein is a value obtained by dividing a force applied to the touch roll by the width of the discharge port of the die. If the linear pressure is 3 kg/cm or more, the fine irregularities can be easily reduced by pressing the touch roll and, if the linear pressure is 100 kg/cm or less, the touch roll can uniformly touch over the entire surface of the casting roll and thus the fine irregularties can be easily reduced over the entire width. By controlling the linear pressure, the plane orientation of the cellulose acylate film due to the surface pressure of the touch roll is facilitated and the dimension stability of the film is further improved. Since the surface pressure is uniformly applied, the variations in the retardations Re and Rth can be reduced and the display unevenness of the liquid crystal display device is further improved. In addition, the improvement of the physical properties (the dimension stability and the variations in the retardations) of the formed film is obtained by controlling the film forming condition of the touch roll of the invention and the drawing and heating condition (the drawing temperature distribution, heating tension, or the like) of the tenter of the invention. In order to use the touch roll, the unevenness of the fine irregularities (die line) formed in the film and the thickness of the film are further reduced.

The touch roll is set at a temperature of preferably 60 to 160° C., more preferably 70 to 150° C., and further preferably 80 to 140° C. The temperature control can be achieved by passing liquid or gas adjusted to the temperature inside the rolls.

It is more preferable that the annealing is performed using a number of casting drums (roll)(among these, the one employing the touch roll is placed to be touched to a first casting roll of the highest upstream (near to the die)). While using three cooling rolls is rather common, the number of rolls is not limited thereto. The roll diameter is preferably from 50 to 5,000 mm, more preferably from 100 to 2,000 mm, and further preferably from 15° to 1,000 mm. The face-to-face distance between the plural rolls is preferably from 0.3 to 300 mm, more preferably from 1 to 100 mm, and further preferably from 3 to 30 mm.

The casting drum is set to preferably from 60 to 160° C., more preferably from 70 to 150° C., and further preferably from 80 to 140° C. The resin is then peeled off from the casting drum and taken up through a nip roller. The take up rate is preferably 10 m/minute to 100 m/minute, more preferably 15 m/minute to 80 m/minute, and further preferably 20 m/minute to 70 m/minute.

The width of the formed film is preferably 0.7 m to 5 m, more preferably 1 m to 4 m, and most preferably 1.3 m to 3 m. The thickness of the undrawn film is preferably 30 μm to 400 μm, more preferably 40 μm to 300 μm, and most preferably 50 μm to 200 μm.

When the touch roll is used, the surface of the touch roll may be rubber or resin such Teflon (registered trademark) or a metal roll. A roll such as a flexible roll in which the surface of the roll is slightly depressed by a pressure and the pressurizing area widens by reducing the thickness of the metal roll may be used.

The temperature of the touch roll is preferably 60° C. to 160° C., more preferable 70° C. to 150° C., and most preferably 80° C. to 140° C.

### (8) Taking Up

Preferably, the seat is taken up after both ends of the sheet are trimmed. The cut-off portion by trimming may be crushed or may be granulated, depolymerized, or reporimerized if it is necessary and reused as a raw material of the same or the other kind of film. As a trimming cutter, any cutter such as a rotary cutter, a shear blade, and a knife may be used. In general, use of a hard blade or a ceramic blade is preferred because they have a long life and generation of chips upon cutting can be reduced.

Before the take-up, a lamination film is preferably applied to at least one surface for preventing scars. The thickness of lamination film is 5 to 200 μm, more preferably 10 to 150 μm, and further preferably 15 to 100 μm. The material may be polyethylene, polyester, polypropylene, or the like, without being particularly limited. The take up tension is preferably 1 kg/m in width to 50 kg/m in width, more preferably 2 kg/m in width to 40 kg/m in width, and further preferably 3 kg/m in width to 20 kg/m in width. When the take-up tension is 1 kg/m or more in width, uniform take up of the film tends to be easy. On the other hand, when the take-up tension is 50 kg/m or less in width, the tight winding of the film or giving a poor appearance of the wound film tend to improve, and also problems such as raised portions in the film is extended due to creep, resulting in waving of the film, and residual birefringence is produced due to extension of the film, are more likely to improve. The take-up tension is detected by tension control along the line, and the film is preferably taken up being controlled to a constant take-up tension. When the film temperature varies depending on the position in the film forming line, films may have a slightly different length due to thermal expansion. Accordingly, it is necessary that the drawing ratio of nip rollers is adjusted so that a tension higher than a pre-determined tension is not applied to the film in the line.

Before the take-up, a process of providing thickness on one side or both sides (knurling treatment) can be preferably performed. The width for thickening process is preferably 1 to 50 mm, more preferably 2 to 30 mm. The height of rough protrusion due to the thickening process is preferably 10 to 100 μm, more preferably 20 to 80 μm. The position of the process is 0 to 50 mm, more preferably 0 to 30 mm from both ends of the film.

The film can be taken up at a constant tension by the control in the tension control. More preferably, however, the tension is tapered proportional to the roll diameter to determine an appropriate take-up tension. Generally, the tension is gradually reduced as the roll diameter increases, but in some cases, the tension is preferably increased as the roll diameter increases.

### <<Stretching>>

In the invention, a cellulose acylate film formed as described above is preferably subjected to a longitudinal stretching/transverse stretching according to the method described above. The longitudinal stretching and the transverse stretching may be carried out by cutting from the film formed or may be successively performed. That is, after film forming, taken up piece is resent for stretching or after film forming, directly subjected to successive stretching.

These stretching processes are preferably performed under the conditions of which the amount of solvent is 0.5% or less by mass, more preferably it is 0.3% or less by mass, even more preferably it is 0.1% or less by mass.

### Producing of Cellulose Acylate Film

The cellulose acylate film obtained in the above manner may be used alone; in combination of polarizing plate; or with the provision of a liquid crystalline layer, a layer having a controlled refractive index (low reflecting layer), or a hard coat layer, provided thereon. These may be achieved by the following processes.

### <<Surface Treatment>>

The surface treatment of a cellulose acylate film is sometimes effective for providing an improved adhesion between it and any functional layer (for example, an undercoat or backup layer). Examples are glow discharge treatment, ultraviolet irradiation, corona treatment, flame treatment and acid or alkali treatment. Glow discharge treatment is preferably carried out by treatment with a low-temperature plasma occurring at a low gas pressure of 10⁻³ to 20 torr or by plasma treatment at an atmospheric pressure. Plasma-excitable gas is gas excited into a plasma under such conditions, for example, argon, helium, neon, krypton, xenon, nitrogen, carbon dioxide, tetrafluoromethane or any other Freon, or a mixture thereof.

Details thereof are stated in Published Technical Report of The Hatsumei Kyokai (Association of Inventions) (Report No. 2001-1745, published on Mar. 15, 2001 by Hatsumei Kyokai), pages 30 to 32. The atmospheric pressure plasma treatment which has recently been drawing attention employs, for example, from 20 to 500 Kgy of irradiation energy at 10 to 1,000 Kev and preferably from 20 to 300 Kgy of irradiation energy at 30 to 500 Kev.

Of those, Alkali saponification treatment is particularly preferable.

The alkali saponification treatment of a cellulose acylate film may be effected by dipping the film in a saponifying solution or coating it with the solution. The dipping method may be carried out by passing a film for a period of 0.1 to 10 minutes through a tank containing an aqueous solution of e.g. NaOH or KOH having a pH of 10 to 14 and a temperature of 20° C. to 80° C., neutralizing it, washing it with water and drying it.

The coating method may be carried out by dip coating, curtain coating, extrusion coating, bar coating or E type coating. A coating solution for alkali saponification treatment is preferably prepared by selecting a solvent which improves the wetting property of the saponifying solution on the film and maintains its surface in a good condition without forming any unevenness thereon. More specifically, an alcoholic solvent is preferable and isopropyl alcohol is particularly preferable. An aqueous solution of a surface active agent can also be used as a solvent. The alkali in the coating solution for alkali saponification is preferably one soluble in the solvent and KOH or NaOH is particularly preferable. The coating solution preferable has a pH of 10 or higher and more preferably 12 or higher. The reaction of alkali saponification is preferably carried out for a period of from one second to five minutes, more preferably from five seconds to five minutes and still more preferably from 20 seconds to three minutes, all at room temperature. The reaction of alkali saponification is preferably followed by washing with water the surface coated with the saponifying solution, or by washing it with an acid and thereafter with water. These methods of saponification are specifically described in, for example, JP-A-2002-82226 and WO02/46809.

An undercoat layer is preferably formed for adhesion to a functional layer. The undercoat layer may be formed after the above surface treatment or without any surface treatment. For details of the undercoat layer, reference is made to Published Technical Report of The Hatsumei Kyokai (Association of Inventions) (Report No. 2001-1745, published on Mar. 15, 2001 by Hatsumei Kyokai), page 32.

These surface treatment and undercoat treatment steps can be performed in the end of the film forming method, in an independent step or in the step of combination of function layer described below.

<<Combination with a Functional Layer>>

The transparent thermoplastic resin film of the present invention is preferably combined with functional layers as described in detail in Kokai Gifo of Japan Institute of Invention & Innovation, Kogi No. 2001-1745, published on Mar. 15, 2001, pages 32 to 45. It is particularly preferable to form a polarizer to make a polarizer (polarizing plate), an optical compensatory layer

(optical compensatory sheet) or an antireflection layer (antireflection film).

### (A) Polarizer (Formation of Polarizing Plate)

(A-1) Materials used for a Polarizer

A polarizer which is now commercially available is usually made by dipping a stretched polymer in a solution of iodine or a dichroic dye in a bath so that iodine or a dichroic dye may penetrate through the polymer. A coating type polarizer, typically of Optiva Inc., can also be used as a polarizer. The iodine or dichroic dye in the polarizer is aligned in the binder to exhibit a polarizing performance. An azo, stilbene, pyrazolone, triphenylmethane, quinoline, oxazine, thiazine or anthraquinone dye is used as the dichroic dye. The dichroic dye is preferably water-soluble. The dichroic dye preferably has a hydrophilic substituent group (for example, a sulfo, amino or hydroxyl group). Examples of compounds are found in Kokai Gifo of Japan Institute of Invention & Innovation, Kogi No. 2001-1745, published on Mar. 15, 2001, page 58.

The binder of the polarizer may be a polymer which is itself cross-linkable, or a polymer which is cross-linkable by a cross-linking agent, or any of a plurality of combinations thereof. Examples of suitable binders are methacrylate copolymers, styrene copolymers, polyolefins, polyvinyl alcohols and modified polyvinyl alcohols, poly(N-methylolacrylamide), polyesters, polyimides, vinyl acetate copolymers, carboxymethyl cellulose and polycarbonates as listed in paragraph [0022] of JP-A-H08-338913. A silane coupling agent can be used as a binder. Water-soluble binders, such as poly(N-methylolacrylamide), carboxymethyl cellulose, gelatin, polyvinyl alcohols or modified polyvinyl alcohols, are preferable, gelatin, polyvinyl alcohols and modified polyvinyl alcohols are more preferable, and polyvinyl alcohols and modified polyvinyl alcohols are most preferable. It is particularly preferable to use together two kinds of polyvinyl alcohols or modified polyvinyl alcohols having different degrees of polymerization. It is preferable to use polyvinyl alcohols having a saponification degree of from 70 to 100% and more preferably from 80 to 100%. The preferred polymerization degree thereof is from 100 to 5,000. For modified polyvinyl alcohols, reference is made to JP-A-H08-338913, JP-A-H09-152509 and JP-A-H09-316127. Two or more kinds of polyvinyl alcohols or modified polyvinyl alcohols may be used together.

The polarizer preferably has a thickness of 10 μm or more. As regards the upper limit of its thickness, a smaller thickness is better for avoiding the leakage of light from a liquid crystal display device, and it is preferably equal to or less than the thickness of a commercially available polarizing plate (about 30 μm), more preferably 25 μm or less and still more preferably 20 μm or less.

The polymer for forming a polarizer may be a cross-linked one. A polymer or monomer having a cross-linking functional group may be mixed in the polymer for a polarizer, or a cross-linking functional group may be given to the polymer itself. Its cross-linking may be effected by applying light or heat, or making a pH change to form a polymer having a cross-linked structure. For the cross-linking agent, reference is made to U.S. Reissue Pat. No. 23,297. A boron compound, such as boric acid or borax, can be used as a cross-linking agent, too. The amount of the cross-linking agent to be added to the polymer is preferably from 0.1 to 20% by mass thereof. This makes it possible to form a polarizer improved in alignment and wet heat resistance. When a cross-linking reaction has ended, the amount of any unreacted cross-linking agent is preferably 1.0% by mass or less and more preferably 0.5% by mass or less. This makes it possible to form a polarizer of improved weatherability.

### (A-2) Stretching of Polarizer

A polarizer is preferably dyeing with iodine or a dichroic dye after stretching a polarizer for forming a polarizer (stretching method) or rubbing it (rubbing method). When the stretching method is employed, its stretching ratio is preferably from 2.5 to 30.0 times and more preferably from 3.0 to 10.0 times. Dry stretching in the air may be employed. It is also possible to employ wet stretching by dipping a film in water. Its dry stretching ratio is preferably from 2.5 to 5.0 times and its wet stretching ratio is preferably from 3.0 to 10.0 times. Its stretching may be effected in parallel to its MD direction (parallel stretching), or in an inclined direction (inclined stretching). Its stretching may be completed at a time, or may be carried out several times progressively. Progressive stretching enables uniform stretching even at a high stretching ratio. The stretching ratio herein represents (length after stretching/length before stretching).

### a) Parallel Stretching

A PVA film is swollen before stretching. Its swelling degree is from 1.2 to 2.0 times when a swollen film is compared in weight with the film yet to be swollen. Then, it is stretched in a bath containing an aqueous medium or a solution of a dichroic dye and having a temperature of from 15° C. to 50° C. and preferably from 17° C. to 40° C., while it is continuously conveyed by guide rolls, etc. Its stretching can be achieved by holding it by two pairs of nip rollers and operating the latter pair of nip rollers at a higher conveying speed than that of the former. Its stretching ratio is the ratio in length of the stretched film to the original film and is preferably from 1.2 to 3.5 times and more preferably from 1.5 to 3.0 times in view of the performance and advantages as stated above. Then, it is dried at a temperature of 50° C. to 90° C. to yield a polarizer.

### b) Inclined Stretching

Inclined stretching may be carried out by employing a method using a tenter extending in an inclined direction as described in JP-A-2002-86554. This stretching is carried out in the air and requires a film to contain water so that its stretching may be easier. Its water content is preferably from 5 to 100% and more preferably from 10 to 100%. Its stretching temperature is preferably from 40° C. to 90° C. and more preferably from 50° C. to 80° C. Its stretching relative humidity is preferably from 50 to 100%, more preferably from 70 to 100% and still more preferably from 80 to 100%. Its longitudinal traveling speed is preferably 1 m/min. or higher and more preferably 3 m/min or higher.

The stretched film is preferably dried for 0.5 to 10 minutes at a temperature of from 50° C. to 100° C. and more preferably from 60° C. to 90° C. Its drying time is more preferably from one to five minutes. The resulting polarizer preferably has an absorption axis of from 100 to 800, more preferably from 30° to 60° and still more preferably substantially 45° (40° to 50°).

Inclined stretching at an angle of 1° to 80 degrees is more preferable. The following is a description of the stretching methods:

### (A-3) Lamination

A transparent thermoplastic film as saponified above and a polarizer formed by stretching are bonded together, whereby they are bonded together so that the casting direction of the cellulose acylate film and the stretching direction of the polarizer preferably have an angle of 45° to each other.

Any adhesive can be used for bonding them together, and a PVA resin (including a modified PVA, such as an acetoacetyl group, sulfonate group, carboxyl group or oxyalkylene group) and an aqueous solution of a boron compound are, for example, available, though a PVA resin is preferred. An adhesive layer preferably has a dry thickness of from 0.01 to 10 μm and more preferably from 0.05 to 5 μm.

Such polarizing plate preferably has a high light transmittance and a high polarization degree. It preferably has a transmittance of 30 to 50%, more preferably 35 to 50% and still more preferably 40 to 50% to light having a wavelength of 550 nm. Its polarization degree is preferably from 90 to 100%, more preferably from 95 to 100% and still more preferably from 99 to 100% to light having a wavelength of 550 nm.

The polarizing plate may be stacked with a λ/4 plate to form a circular polarization of light. They are so stacked together that the slow axis of the λ/4 and the absorption axis of the polarizing plate may have an angle of 45° therebetween. While the λ/4 is not specifically limited, it preferably has such a wavelength dependence that low retardation may depend on a low wavelength. Moreover, it is preferable to use a polarizer having an absorption axis inclined at an angle of 20° to 70° to its length and a λ/4 plate composed of an optically anisotropic layer formed from a liquid crystal compound.

### (B) Impartation of Optical Compensatory Layer (Preparation of Optical Compensatory Sheet)

The optically anisotropic layer is for compensating a liquid crystal compound in a liquid crystal cell of a liquid crystal display device displaying a black color, and an optical compensatory layer is formed by forming an alignment layer on the cellulose acylate film of the present invention and further imparting an optically anisotropic layer.

### (B-1) Alignment Layer

An alignment layer is formed on the aforementioned cellulose acylate film subjected to the surface treatment. This film has a function of determining the orientation direction of liquid crystal molecules. However, if a liquid crystal compound is oriented, and then the oriented state is fixed, the function of the alignment layer is already attained, and it is not necessarily essential as a constituent of the present invention. That is, only the optically anisotropic layer on the alignment layer in which oriented state is fixed can be transferred on a polarizer to produce the polarizing plate of the present invention.

The alignment layer can be provided by rubbing an organic compound (preferably a polymer), oblique vapor deposition of an inorganic compound, formation of a layer having micro grooves, accumulation of an organic compound (for example, ω-tricosanoic acid, dioctadecylmethylammonium chloride, methyl stearate) by the Langmuir-Blodgett method (LB film). Furthermore, alignment layers in which an orienting function is imparted by applying an electrical field, applying a magnetic field or light irradiation are also known.

The alignment layer is preferably formed by subjecting a polymer to a rubbing treatment. In principle, the polymer used for the alignment layer should have has a molecular structure having a function of orienting liquid crystal molecules.

In the present invention, in addition to the impartation of the function of orienting liquid crystal molecules, it is preferable to introduce a side chain having a crosslinkable functional group (for example, double bond) into the main chain of the polymer, or a crosslinkable functional group having a function of orienting liquid crystal molecules into a side chain of the polymer.

As the polymer used for the alignment layer, any of a polymer that can be crosslinked by itself, a polymer that can be crosslinked with a crosslinking agent, and a combination of two or more kinds of such polymers can be used. Examples of the polymers include methacrylate copolymers, styrene copolymers, polyolefins, polyvinyl alcohols and modified polyvinyl alcohols, poly(N-methylolacrylamides), polyesters, polyimides, vinyl acetate copolymers, carboxymethylcelluloses, polycarbonates described in JP-A-H08-338913, paragraph [0022] and so forth. Silane coupling agents can also be used as the polymer. Among these polymers, water-soluble polymers (for example, poly(N-methylolacrylamides), carboxymethylcelluloses, gelatin, polyvinyl alcohols and modified polyvinyl alcohols are preferred, gelatin, polyvinyl alcohols and modified polyvinyl alcohols) are preferred, gelatin, polyvinyl alcohols and modified polyvinyl alcohols are more preferred, and polyvinyl alcohols and modified polyvinyl alcohols are most preferred. It is particularly preferable to use two kinds of polyvinyl alcohols or modified polyvinyl alcohols having different polymerization degrees in combination. The polyvinyl alcohols preferably have a saponification degree of 70 to 100%, more preferably 80 to 100%. The polymerization degree of the polyvinyl alcohols is preferably 100 to 5,000.

The side chain having a function of orienting liquid crystal molecules generally has a hydrophobic group as a functional group. The specific type of the functional group is decided depending on the type of the liquid crystal molecules and a required oriented state. For example, modification groups of the modified polyvinyl alcohol can be introduced by copolymerization modification, chain transfer modification or block polymerization modification. Examples of the modification group include a hydrophilic group (for example, carboxylic acid group, sulfonic acid group, phosphonic acid group, amino group, ammonium group, amide group, thiol group etc.), a hydrocarbon group having 10 to 100 carbon atoms, a fluorine-substituted hydrocarbon group, a thioether group, a polymerizable group (unsaturated polymerizable group, epoxy group, aziridinyl group etc.), an alkoxysilyl group (trialkoxysilyl group, dialkoxysilyl group, monoalkoxysilyl group) and so forth. Specific examples of the modified polyvinyl alcohols include those described in JP-A-2000-155216, paragraphs [0022] to [0145], JP-A-2002-62426, paragraphs [0018] to [0022] and so forth.

If a side chain having a crosslinkable functional group is bonded to the main chain of the alignment layer polymer or a crosslinkable functional group is introduced into a side chain of the polymer having a function of orienting liquid crystal molecules, the alignment layer polymer can be copolymerized with a polyfunctional monomer contained in the optically anisotropic layer. As a result, strong bonding based on covalent bonds is attained not only between the polyfunctional monomers, but also between the alignment layer polymers and between the polyfunctional monomer and the alignment layer polymer. Therefore, the introduction of the crosslinkable functional groups into the alignment layer polymer can markedly improve the strength of the optical compensatory sheet.

The crosslinkable functional groups of the alignment layer polymer preferably contain a polymerizable group like the polyfunctional monomer. Specific examples thereof are described in JP-A-2000-155216, paragraphs [0080] to [0100]. The alignment layer polymer can be crosslinked with a crosslinking agent, separately from the aforementioned crosslinkable functional group.

Examples of the crosslinking agent include aldehydes, N-methylol compounds, dioxane derivatives, compounds that act when the carboxylic group is activated, active vinyl compounds, active halogen compounds, isooxazoles and dialdehyde starch. Two or more kinds of crosslinking agents may be used in combination. Specific examples include the compounds described in JP-A-2002-62426, paragraphs [0023] to [0024]. Highly reactive aldehydes are preferred, and glutaraldehyde is particularly preferred.

The amount of the crosslinking agent is preferably 0.1 to 20 weight %, more preferably 0.5 to 15 weight %, based on the weight of the polymer. The amount of non-reacted crosslinking agent remaining in the alignment layer is preferably 1.0 weight % or less, more preferably 0.5 weight % or less. By adjusting the amount of remaining non-reacted crosslinking agent, sufficient durability of the alignment layer not generating any reticulation can be obtained even if the alignment layer is used in a liquid crystal display device for a long period of time or is left in a high temperature and high humidity atmosphere for a long period of time.

The alignment layer can be basically formed by coating a solution containing the aforementioned polymer as the alignment layer forming material and the crosslinking agent on a transparent support, drying (crosslinking) the coated layer by heating and rubbing the coated surface. The crosslinking reaction may be carried out in an arbitrary stage after applying the solution on the transparent support as described above. When a water-soluble polymer such as polyvinyl alcohol is used as the alignment layer forming material, a mixed solvent of an organic solvent having a defoaming action (for example, methanol) and water is preferably employed as the solvent of the application solution. The suitable ratio of water and the organic solvent is preferably 0:100 to 99:1, more preferably 0:100 to 91:9, in terms of weight ratio. By the use of such a mixed solvent, the generation of foams can be suppressed to markedly decrease defects in the alignment layer, especially the surface of the optically anisotropic layer.

As the application method for the alignment layer, the spin coating method, dip coating method, curtain coating method, extrusion coating method, rod coating method and roller coating method are preferred, and the rod coating method is particularly preferred. The thickness of the alignment layer after drying is preferably 0.1 to 10 μm. The drying by heating can be performed at a temperature of 20 to 110° C. In order to form sufficient crosslinkings, the drying temperature is preferably 60 to 100° C., particularly preferably 80 to 100° C. The drying time is generally 1 minute to 36 hours, preferably 1 to 30 minutes. Further, it is also preferable to adjust pH to an optimum value for the crosslinking agent used. When glutaraldehyde is used as the crosslinking agent, pH is preferably 4.5 to 5.5, particularly preferably 5.

The alignment layer is provided on the transparent supporter the base coat layer. The alignment layer can be obtained by crosslinking the polymer layer as described above and then rubbing the surface of the layer.

As the aforementioned rubbing treatment, the treatment methods widely used for a step of orientating liquid crystals of LCD can be adopted. That is, a method of rubbing a surface of an alignment layer along a certain direction with paper, gauze, felt, rubber, nylon, polyester fibers or the like to obtain orientation can be employed. In general, the rubbing treatment is performed by rubbing the surface several times with cloth to which fibers having the same length and the same diameter are evenly transplanted.

When the rubbing treatment is carries out in an industrial scale, it can be performed by contacting a rotating rubbing roller with a transported film provided with a polarizer. All of the roundness, cylindricality and deflection (eccentricity) of the roller are preferably 30 μm or less. The wrapping angle of the film with respect to the rubbing roll is preferably 0.1 to 90°. However, as disclosed in JP-A-H08-160430, a stable rubbing treatment may be performed by winding a film around the roller for 360° or more. The transportation speed of the film is preferably 1 to 100 m/minute. An appropriate rubbing angle is preferably selected from the range of 0 to 60°. When the film is used in a liquid crystal display device, the rubbing angle is preferably 40 to 50°, particularly preferably 45°.

The alignment layer prepared as described above preferably has a thickness of 0.1 to 10 μm.

Then, liquid crystal molecules of the optically anisotropic layer are oriented on the alignment layer. Thereafter, the alignment layer polymer is reacted with the polyfunctional monomers contained in the optically anisotropic layer, or a crosslinking agent is used to crosslink the alignment layer polymer, as required.

The liquid crystal molecules used for the optically anisotropic layer may be rod-shaped liquid crystal molecules or disk-like liquid crystal molecules. The rod-shaped liquid crystal molecule and the disk-like liquid crystal molecule each may be high molecular weight liquid crystal or low molecular weight liquid crystal. Furthermore, crosslinked low molecular weight liquid no longer exhibiting liquid crystallinity may also be used.

### (B-2) Rod-Shaped Liquid Crystal Molecule

As the rod-shaped liquid crystal molecules, azomethines, azoxy compounds, cyanobiphenyls, cyanophenyl esters, benzoic acid esters, cyclohexanecarboxylic acid phenyl esters, cyanophenylcyclohexane compounds, cyano-substituted phenylpyrimidines, alkoxy-substituted phenylpyrimidines, phenyldioxanes, tolans and alkenylcyclohexylbenzonitriles are preferably used.

The rod-shaped liquid crystal molecules include metal complexes. Liquid crystal polymers containing rod-shaped liquid crystal molecules in repeating units can also be used as the rod-shaped liquid crystal molecule. In other words, the rod-shaped liquid crystal molecule may be bonded to a (liquid crystal) polymer.

The rod-shaped liquid crystal molecules are described in Kikan Kagaku Sosetsu (Quarterly Chemical Review), vol. 22, “Chemistry of Liquid Crystal”, edited by the Chemical Society of Japan (1994), Chapters 4, 7, and 11, and “Liquid Crystal Device Handbook”, edited by Japan Society for the Promotion of Science, 142nd Committee, Chapter 3.

The rod-shaped liquid crystal molecule preferably has a birefringence in the range of 0.001 to 0.7.

The rod-shaped liquid crystal molecule preferably has a polymerizable group in order to fix the oriented state thereof. The polymerizable group is preferably a radically polymerizable unsaturated group or a cationic polymerizable group. Specific examples include the polymerizable groups and polymerizable liquid crystal compounds described in JP-A-2002-62427, paragraphs [0064] to [0086].

### (B-3) Disk-Like Liquid Crystal Molecule

Examples of the disk-like (discotic) liquid crystal molecule include benzene derivatives disclosed in the research report of C. Destrade et al., Mol. Cryst., vol. 71, p. 111 (1981); truxene derivatives disclosed in the research report of C. Destrade et al., Mol. Cryst., vol. 122, p. 141 (1985) and Phyics. Lett., A, vol. 78, p. 82 (1990); cyclohexane derivatives disclosed in the research report of B. Kohne et al., Angew. Chem. Soc., vol. 96, p. 70 (1984); and azacrown and phenylacetylene macrocycles disclosed in the research report of J. M. Lehn et al., J. Chem. Commun. p. 1794 (1985), and the research report of J. Zhang et al., J. Am. Chem. Soc. vol. 116, p. 2655 (1994).

The disk-like liquid crystal molecules include those having a structure in which linear alkyl groups, alkoxy groups or substituted benzoyloxy group radially substitute on a base nucleus locating at the center of the molecule and showing liquid crystallinity. Compounds of which molecule or cluster of molecules shows rotational symmetry and can be given a certain orientation are preferred. As for the optically anisotropic layer formed with disk-like liquid crystal molecules, the compound finally contained in the optically anisotropic layer does not need to be consisted of disk-like liquid crystal molecules, and for example, compounds obtained by polymerization or crosslinking of low molecular weight disk-like liquid crystal molecules having a thermo- or photo-reactive group with heat or light to form a polymer and thus no longer exhibiting liquid crystallinity are also included. Preferred examples of the disk-like liquid crystal molecule are described in Japanese Patent Laid-open Publication No. 8-50206. Polymerization of disk-like liquid crystal molecules is disclosed in JP-A-H08-27284.

In order to fix the disk-like liquid crystal molecules by polymerization, it is necessary to bond a polymerizable group as a substituent to the disk-like core of the disk-like liquid crystal molecule. A compound in which the disk-like core and the polymerizable group are bonded through a bridging group is preferred. By such a structure, the orientation state of the compound can be kept in the polymerization reaction. Examples of such a compound include the compounds described in JP-A-2000-155216, paragraphs [0151] to [0168].

In the hybrid orientation, the angle formed by the long axis (disc plane) of disk-like liquid crystal molecule and plane of polarizing plate increases or decreases with increase of distance from the plane of polarizing plate along the depth direction of the optically anisotropic layer. The angle preferably decreases with increase of the distance. Further, variation of the angle may be continuous increase, continuous decrease, intermittent increase, intermittent decrease, variation including continuous increase and decrease or intermittent variation including increase or decrease. The intermittent variation includes a region during which the tilt angle does not change in the middle of the thickness along the thickness direction of the layer. Even if such a region in which the angle does not change is included, it is sufficient that the angle should increase or decrease as a whole. It is more preferred that the angle should continuously change.

The average direction of the long axis of the disk-like liquid crystal molecule on the polarizing plate side can be generally controlled by selecting the disk-like liquid crystal molecule or the material of the alignment layer, or by selecting the method for the rubbing treatment. The direction of the long axis (disc plane) of disk-like liquid crystal molecule on the surface side (air side) can be generally controlled by selecting type of the disk-like liquid crystal molecule or type of additive used together with the disk-like liquid crystal molecule. Examples of the additive used together with the disk-like liquid crystal molecule include plasticizer, surfactant, polymerizable monomer and polymer and so forth. Further, degree of the variation of the orientation angle can also be controlled by selection of the liquid crystal molecule and additive like the aforementioned control.

### (B-4) Other Components of Optically Anisotropic Layer

By using a plasticizer, surfactant, polymerizable monomer and so forth together with the aforementioned liquid crystal molecules, uniformity of the coated film, strength of the film, orientation state of the liquid crystal molecules and so forth can be improved. Those components are preferably substances that are compatible with the liquid crystal molecules and can change the tilt angle of the liquid crystal molecules or do not inhibit the orientation.

Examples of the polymerizable monomer include radically polymerizable compounds and cationic polymerizable compounds. The polymerizable monomer is preferably a polyfunctional radically polymerizable monomer, and such a monomer copolymerizable with the aforementioned liquid crystal compound having the polymerizable group is preferred. Examples include those described in JP-A-2002-296423, paragraphs [0018] to [0020]. The amount of the compound is generally 1 to 50%, preferably 5 to 30 weight %, of the disk-like liquid crystal molecules.

Although the surfactant may be a conventionally known compound, a fluorine-containing compound is particularly preferred. Specific examples thereof include the compounds described in JP-A-2001-330725, paragraphs [0028] to [0056].

It is preferred that the polymer used together with the disk-like liquid crystal molecules can change the tilt angle of the disk-like liquid crystal molecules.

Examples of the polymer include cellulose esters. Preferred examples of the cellulose esters include those described in JP-A-2000-155216, paragraph [0178]. In order not to inhibit the orientation of the liquid crystal molecules, the amount of the polymer is preferably in the range of 0.1 to 10%, more preferably in the range of 0.1 to 8 weight %, with respect to the liquid crystal molecules.

The discotic nematic liquid crystal phase/solid phase transition temperature of the disk-like liquid crystal molecule is preferably 70 to 300° C., more preferably 70 to 170° C.

### (B-5) Formation of Optically Anisotropic Layer

The optically anisotropic layer can be formed by applying an application solution containing liquid crystal molecules as well as a polymerization initiator described later and arbitrary components as required on the alignment layer.

As the solvent used in the preparation of the application solution, an organic solvent is preferably used. Examples of the organic solvent include amides (for example, N,N-dimethylformamide), sulfoxides (for example, dimethyl sulfoxide), heterocyclic compounds (for example, pyridine), hydrocarbons (for example, benzene, hexane), alkyl halides (for example, chloroform, dichloromethane, tetrachloroethane), esters (for example, methyl acetate, butyl acetate), ketones (for example, acetone, methyl ethyl ketone) and ethers (for example, tetrahydrofuran, 1,2-dimethoxyethane). Alkyl halides and ketones are preferred. It is also possible to use two or more kinds of organic solvents together.

The application solution can be applied by a known method (for example, wire bar coating method, extrusion coating method, direct gravure coating method, reverse gravure coating method, die coating method).

The thickness of the optically anisotropic layer is preferably 0.1 to 20 μm, more preferably 0.5 to 15 μm, most preferably 1 to 10 μm.

### (B-6) Fixation of Oriented State of Liquid Crystal Molecules

The oriented liquid crystal molecules can be fixed with maintaining the oriented state. The fixation is preferably carried out by a polymerization reaction. The polymerization reaction includes a thermal polymerization reaction using a thermal polymerization initiator and a photopolymerization reaction using a photopolymerization initiator. The photopolymerization reaction is preferred.

Examples of the photopolymerization initiator include α-carbonyl compounds (described in U.S. Pat. Nos. 2,367,661 and 2,367,670), acyloin ethers (described in U.S. Pat. No. 2,448,828), α-hydrocarbon-substituted acyloin compounds (described in U.S. Pat. No. 2,722,512), polynuclear quinone compounds (described in U.S. Pat. Nos. 3,046,127 and 2,951,758), combinations of triarylimidazole dimer with p-aminophenyl ketone (described in U.S. Pat. No. 3,549,367), acridine and phenazine compounds (described in JP-A-S60-105667 and U.S. Pat. No. 4,239,850) and oxadiazol compounds (described in U.S. Pat. No. 4,212,970).

The photopolymerization initiator is preferably used in an amount of 0.01 to 20 weight %, more preferably 0.5 to 5 weight %, based on the solid matter in the application solution.

Light irradiation for polymerizing the liquid crystal molecules is preferably performed by using an ultraviolet ray.

The irradiation energy is preferably in the range of 2° mJ/cm² to 50 J/cm², more preferably 20 to 5,000 mJ/cm², still more preferably 100 to 800 mJ/cm². For promoting the photopolymerization reaction, the light irradiation may be carried out with heating.

Further, a protective layer may be provided on the optically anisotropic layer as required.

It is also preferable to combine this optical compensatory film with a polarizer. Specifically, such an application solution for forming the optically anisotropic layer as described above is applied on a surface of a polarizing plate to form an optically anisotropic layer. As a result, produced is a thin polarizing plate giving only a small stress (strain×sectional area×elastic modulus) generated in connection with dimensional change of the polarizer without using any polymer film between the polarizing plate and the optically anisotropic layer. By disposing a polarizing plate according to the present invention in a large-sized liquid crystal display device, images of high display quality can be displayed without causing problems such as light leakage.

The tilt angle between the polarizer and the optical compensatory layer is preferably adjusted by stretching the layers so that the angle should match the angle between the transmission axis of two polarizing plates adhered onto both surfaces of a liquid crystal cell constituting a LCD and the longitudinal or transverse direction of the liquid crystal cell. The tilt angle is generally 45°. However, transmission, reflection and semi-transmission type LCDs in which the angle is not necessarily 45° have recently been developed, and therefore it is preferred that the stretching direction can be arbitrarily adjusted depending on the design of LCD.

### (B-7) Liquid Crystal Display Device

Each of liquid crystal modes in which such an optical compensatory film is used will be explained hereinafter.

### (TN Mode Liquid Crystal Display Device)

Liquid crystal cells of TN mode are most widely used in color TFT liquid crystal displays and described in many references. In a liquid crystal cell of the TN mode displaying a black color, orientation state of the liquid crystal is that rod-shaped liquid crystal molecules in the central portion of the cell stand up, and the molecules lie down in portions near the substrate of the cell.

### (OCB Mode Liquid Crystal Display Device)

A liquid crystal cell of OCB mode is a liquid crystal cell of bend orientation mode in which rod-shaped liquid crystal molecules in the upper part and lower part of the liquid crystal cell are essentially inversely (symmetrically) oriented. Liquid crystal display devices utilizing liquid crystal cells of the bend orientation mode are disclosed in U.S. Pat. Nos. 4,583,825 and 5,410,422. Because the rod-shaped liquid crystal molecules in the upper part and lower part of the liquid crystal cell are symmetrically oriented, a liquid crystal cell of bend orientation mode has an optically self-compensating function. Therefore, this mode of liquid crystal is referred to as OCB (optically compensatory bend) mode of liquid crystal.

In a liquid crystal cell of the OCB mode, like that of the TN mode, the orientation state of liquid crystal in the cell displaying a black color is that rod-shaped liquid crystal molecules in the central portion of the cell stand up, and the molecules lie down in portions near substrate of the cell.

### (VA Mode Liquid Crystal Display Device)

A liquid crystal cell of the VA mode is characterized by substantially longitudinally aligning rod-shaped liquid crystal molecules when voltage is not applied, and liquid crystal cells of the VA mode include, in addition to (1) a liquid crystal cell of VA mode in a narrow sense in which rod-shaped liquid crystal molecules are substantially longitudinally aligned when voltage is not applied, and the molecules are essentially transversely aligned while voltage is applied (described in JP-A-H02-176625), (2) a liquid crystal cell of MVA mode in which the VA mode is modified to be multi-domain type in order to enlarge the viewing angle (described in SID97, Digest of tech. Papers, 28 (1997), 845), (3) a liquid crystal cell of n-ASM mode in which rod-shaped liquid crystal molecules are substantially longitudinally aligned while voltage is not applied, and the molecules are essentially oriented in twisted multi-domain alignment while voltage is applied (described in the proceedings of Nippon Ekisho Toronkai (Liquid Crystal Forum of Japan), 58-59 (1998)), and (4) a liquid crystal cell of SURVIVAL mode (published in LCD International '98).

### (IPS Mode Liquid Crystal Display Device)

IPS-mode liquid crystal display devices are characterized in that the rod-shaped liquid crystal molecules are oriented substantially transversely within the plane while voltage is not applied, thereby undergoing change in orientation direction according to the application or non-application of voltage to achieve switching. Specific examples to be used are described in JP-A-2004-365941, JP-A-2004-12731, JP-A-2004-215620, JP-A-2002-221726, JP-A-2002-55341 and JP-A-2003-195333.

### (Other Liquid Crystal Display Device)

Liquid crystal display devices of the ECB and STN modes can be optically compensated on the basis of the same approach as described above.

### (C) Impartation of Antireflection Layer (Antireflection Film)

An antireflection film is generally formed by providing a low refractive index layer, which also serves as an antifouling layer, and at least one layer having a refractive index higher than that of the low refractive index layer (i.e., a high refractive index layer and/or medium refractive index layer) on a transparent thermoplastic resin film.

Examples of the method for forming a multi-layered film comprising laminated transparent thin films of inorganic compounds (metal oxides etc.) having different refractive indexes include the chemical vapor deposition (CVD) method, physical vapor deposition (PVD) method and a method of forming a coated film of colloidal metal oxide particles by a sol-gel method from a metal compound such as metal alkoxides and subjecting the film to a post-treatment (such as ultraviolet radiation described in JP-A-H09-157855, or plasma treatment described in JP-A-2002-327310) to form a thin film.

Further, as antireflection films showing high productivity, various antireflection films prepared by laminating thin films of inorganic particles dispersed in a matrix by coating have been proposed.

Examples of the antireflection film also include antireflection films comprising an antireflection layer prepared by forming fine unevenness on the uppermost surface of such an antireflection film formed by application as described above to impart antiglare property to the surface.

Although any of the aforementioned methods can be used for the cellulose acylate film of the present invention, the application method (applied type) is particularly preferred.

### (C-1) Layer Constitution of a Coating Type Antireflection Layer

An antireflective layer at least having a medium refractive index layer, a higher refractive index layer and a lower refractive index layer (the outermost layer) laminated on a protective film in this order is designed so as to give a refractive index fulfilling the following relationship: refractive index of higher refractive index layer>refractive index of medium refractive index layer>refractive index of protective film>refractive index of lower refractive index layer.

Further, a hard coat layer may be provided between the protective film and the medium refractive index layer. It is also possible to employ the constitution of medium refractive index hard coat layer, higher refractive index layer and lower refractive index layer.

Use may be made of antireflective layers described in, for example, JP-A-H08-122504, JP-A-H08-110401, JP-A-H10-300902, JP-A-2002-243906 and JP-A-2000-111706.

Each layer may further have additional function(s). Examples thereof include a stainproof lower refractive index layer and an antistatic higher refractive index layer (see, for example, JP-A-H10-206603 and JP-A-2002-243906). The haze of the antireflective layer is preferably 5% or less, still preferably 3% or less. The strength of the film is preferably H or above, still preferably 2H or above and most desirably 3H or above, when determined by the pencil hardness test in accordance with JIS K5400.

### (C-2) Higher Refractive Index Layer and Medium Refractive Index Layer

In the antireflective layer, the layer having a higher refractive index is made of a hardening film containing at least fine particles of an inorganic compound with a higher refractive index having an average particle size of 100 nm or less and a matrix binder.

As the fine particles of an inorganic compound with a higher refractive index, use can be preferably made of an inorganic compound having a refractive index of 1.65 or above, still preferably 1.9 or above. Examples thereof include oxides of Ti, Zn, Sb, Sn, Zr, Ce, Ta, La and In and complex oxides containing these metal atoms.

These fine particles having 100 nm or less of the average particle size can be obtained by, for example, treating the particle surface with a surfactant (for example, a silane coupling agent: JP-A-H11-295503, JP-A-H11-153703 and JP-A-2000-9908, an anionic compound or an organic metal coupling agent: JP-A-2001-310432), employing a core-shell structure with the use of higher refractive index particles as the core (JP-A-2001-166104), or using together a specific dispersant (for example, JP-A-H11-153703, U.S. Pat. No. 6,210,858 B1 and JP-A-2002-2776069). As examples of the material forming the matrix, publicly known thermoplastic resins and hardening resin films may be cited.

It is also preferable to employ at least one composition selected from among a composition containing a polyfunctional compound having at least two radical polymerizable and/or cationic polymerizable groups and a composition comprising an organic metal compound having a hydrolysable group and a partial condensation product thereof. Examples thereof include compositions reported in JP-A-2000-47004, JP-A-2001-315242, 2001-31871 and JP-A-2001-296401.

Also, use may be preferably made of a hardening film obtained from a composition comprising a colloidal metal oxide obtained from a hydrolysis condensation product of a metal alkoxide and a metal alkoxide. Such a film is described in, for example, JP-A-2001-293818.

The refractive index of the higher refractive index layer preferably ranges 1.70 to 2.20. The thickness of the higher refractive index layer preferably ranges 5 nm to 10 μm, still preferably 10 nm to 1 μm.

The refractive index of the medium refractive index layer is controlled to an intermediate level between the refractive index of the lower refractive index layer and the refractive index of the higher refractive index layer. The refractive index of the medium refractive index layer preferably ranges 1.50 to 1.70.

### (C-3) Lower Refractive Index Layer

The lower refractive index layer is successively laminated on the higher refractive index layer. The refractive index of the lower refractive index layer preferably ranges 1.20 to 1.55, still preferably 1.30 to 1.50.

It is preferable to form the lower refractive index layer as the outermost layer having scuff proofness and stain proofness. As means of largely improving the scuff proofness, it is effective to impart slipperiness to the surface, which can be established by applying a publicly known thin film layer technique such as introduction of silicone or fluorine.

The refractive index of the fluorine-containing compound preferably ranges 1.35 to 1.5°, still preferably 1.36 to 1.47. As a fluorine-containing compound, a compound containing crosslinkable or polymerizable functional group containing 35 to 80% by weight of fluorine atom is preferred.

Examples thereof include compounds cited in paragraphs [0018] to [0026] in JP-AJP-A-H09-222503, paragraphs [0019] to [0030] in JP-A-H11-38202, paragraphs to [0028] in JP-A-2001-40284, and JP-A-2000-284102, paragraphs [0012] to [0077] in JP-A-2003-26732, and paragraphs [0030] to [0047] in JP-A-2004-45462.

A silicone compound is a compound having a polysiloxane structure and a compound having a hardening functional group or a polymerizable functional group in its polymer chain and gives a crosslinked structure in the film is preferable. Examples thereof include a reactive silicone (for example, SILAPLANE manufactured by CHISSO CORPORATION), polysiloxane having silanol groups at both ends (for example, JP-A-H11-258403).

To perform the crosslinking or polymerization reaction of the fluorine and/or siloxane polymer having a crosslinking or polymerizable group, it is preferable to irradiate or heat a coating composition for forming the outermost layer, which contains a polymerization initiator or a sensitizer, simultaneously with the application or after the application, thereby forming the lower refractive index layer.

It is also preferable to employ a sol gel hardening film which hardens via a condensation reaction between an organic metal compound such as a silane coupling agent and a silane coupling agent having a specific fluorinated hydrocarbon group in the coexistence of a catalyst.

Examples thereof include polyfluoroalkyl group-containing silane compounds or partly hydrolyzed condensation products thereof (compounds described in, for example, JP-A-S58-142958, JP-A-S58-147483, JP-A-S58-147484, JP-A-H09-157582 and JP-A-H11-106704), silyl compounds having poly “perfluoroalkyl ether” group (i.e., a fluorines containing long chain)(compounds described in, for example, JP-A-2000-117902, JP-A-2001-48590 and JP-A-2002-53804). In addition to the components as described above, the lower refractive index layer may contain additives such as a filler (for example, particles of inorganic compounds having a low refractive index and an average primary particle size of 1 to 150 nm such as silicon dioxide (silica) and fluorine-containing particles (magnesium fluoride, calcium fluoride and barium fluoride) and fine organic particles described in paragraphs [0020] to [0038] in JP-A-H11-3820)), a silane coupling agent, a slip agent and a surfactant.

In the case where the lower refractive index layer is provided below the outermost layer, the lower refractive index layer may be formed by a gas phase method (for example, the vacuum deposition method, the sputtering method, the ion plating method or the plasma CVD method). It is preferable to employ the coating method by which the lower refractive index layer can be formed at low cost.

The film thickness of the lower refractive index layer preferably ranges 30 to 200 nm, still preferably 50 to 150 nm and most desirably 60 to 120 nm.

### (C-4) Hard Coat Layer

In order to elevate the physical strength of the protective film having the antireflective layer, it is preferable to form a hard coat layer on the surface of the protective film.

It is particularly preferable to provide the hard coat layer between the transparent supporter and the higher refractive index layer as described above. The hard coat layer is formed preferably by a crosslinking reaction or a polymerization reaction of a hardening compound by means of light and/or heat. As a hardening functional group in the hardening compound, a photo polymerizable functional group is preferred. It is also preferable to use an organic metal compound or an organic alkoxysilyl compound having a hydrolysable functional group.

Specific examples of these compounds include those cited above with respect to the higher refractive index layer. Specific examples of a composition constituting the hard coat layer include those described in JP-A-2002-144913 and JP-A-2000-9908, and WO00/46617.

The hard coat layer may also serve as the higher refractive index layer. In this case, it is preferable to form the hard coat layer by finely dispersing fine particles by using a technique as described with respect to the higher refractive index layer.

The hard coat layer may contain particles having an average particle size of form 0.2 to 10 μm and also serve as an antiglare layer having an antiglare function.

The film thickness of the hard coat layer can be appropriately designed depending on the purpose. The film thickness of the hard coat layer preferably ranges 0.2 to 10 μm and still preferably 0.5 to 7 μm. The strength of the hard coat layer is preferably H or above, still preferably 2H or above and most desirably 3H or above, when determined by the pencil hardness test in accordance with JIS K5400. In the Taber abrasion test in accordance with JIS K5400, a less Taber volume loss in a test sample after the test, compared with the volume before the test, is the preferable.

### (C-5) Forward Scattering Layer

When the cellulose acylate film of the present invention is used in a liquid crystal display device, a forward scattering layer is provided in order to impart a viewing angle improving effect for the case of tilting the viewing angle up and down or right and left. The hard coat layer can be made to also serve as this layer by dispersing microparticles having different refractive indexes in the hard coat layer.

Examples include the one described in JP-A-H11-38208, in which the forward scattering coefficient of the forward scattering layer is particularly defined, the one described in JP-A-2000-199809, in which the relative refractive index of transparent resin and microparticles is defined to be within a particular range, the one described in JP-A-2002-107512, in which the haze value of the forward scattering layer is defined to be 40% or more, and so forth.

### (C-6) Other Layers

Besides the aforementioned layers, a primer layer, antistatic layer, undercoat layer, protective layer etc. may also be provided.

### (C-7) Coating Method

The layers constituting the antireflection film can be formed by application using any of dip coating, air knife coating, curtain coating, roller coating, wire bar coating, gravure coating, microgravure coating, and extrusion coating (U.S. Pat. No. 2,681,294) methods.

### (C-8) Antiglare Function

The antireflection film may have an antiglare function for scattering light from the outside. The antiglare function can be obtained by making unevenness on the surface of the antireflection film. When the antireflection film has the antiglare function, the antireflection film preferably has a haze of 3 to 30%, more preferably 5 to 20%, most preferably 7 to 20%.

As the method for forming unevenness on the surface of the antireflection film, any method capable of sufficiently maintaining such surface shape can be used. Examples of the method include a method of using microparticles in the low refractive index layer to form unevenness on the surface of the film (for example, JP-A-2000-271878), a method of adding a small amount (0.1 to 50 weight %) of relatively large particles (particle size: 0.05 to 2 μm) to the layer under the low refractive index layer (high refractive index layer, medium refractive index layer or hard coat layer) to form a film having an uneven surface and then forming the low refractive index layer thereon while keeping the uneven shape (for example, JP-A-2000-281410, JP-A-2000-95893, JP-A-2001-100004 and JP-A-2001-281407), a method of physically transferring uneven shape onto a surface of a coated uppermost layer (antifouling layer)(for example, those described in JP-A-S63-278839, JP-A-S11-183710 and JP-A-2000-275401 as methods using embossing) and so forth.

### Measurement Method

Hereinafter, a measurement method used in the invention will be described.

### (1) Wet Heat Dimension Variation (δL(w))

A sample film having a roll shape was cut in the MD and TD directions, humidity was controlled at a temperature of 25° C. and relative humidity of 60% for 5 hours or more, the length of the film was measured using a pin gauge having a length of 20 cm (MD(F) and TD(F)). This film was left in a thermo- and humidistat tank having a temperature of 60° C. and relative humidity of 90% for 500 hours without tension. After the film was carried out of the thermo- and humidistat tank, humidity was controlled at a temperature of 25° C. and relative humidity of 60% for 5 hours or more and the length of the film was measured of a pin gauge having a length of 20 cm (MD(t) and TD(t)). The wet heat dimension variations δMD(w) and δTD(w) in the MD and TD directions were obtained and a larger value between these values was set to the wet heat dimension variation δL(w).

δTD(w)(%)=100×|TD(F)−TD(t)|/TD(F)

δMD(w)(%)=100×|MD(F)−MD(t)|/MD(F)

### (2) Dry Heat Dimension Variation (δL(d))

The dry heat dimension variation was obtained by the same process as the thermal process of the wet heat dimension variation except for a temperature of 80° C., a dry state and 500 hours.

### (3) Re, Rth, Variations in Re and Rth in Transverse Direction and Longitudinal Direction, and Shift of Slow Axis

100 sample pieces having a size 3×3 cm were cut in the longitudinal direction of the film at an interval of 0.5 m. 50 sample pieces having a size of 3×3 cm were cut over the entire width of the film at the same interval. With these sample films, Re and Rth were measured by the above-described method and average values thereof were set to Re and Rth. The entire averages of the difference between the measured value and the average value of the 100 samples of the longitudinal direction (MD direction) and the 50 samples of the transverse direction (TD direction) were the variation in Re, the variation of Rth, and the shift of the slow axis.

### (4) Wet Heat Variations of Re and Rth

The humidity of the sample films was controlled for 5 hours or more at a temperature of 25° C. and relative humidity of 60% and Re and Rth were measured by the above-described method (Re(F) and Rth(F)). These sample films were left in a thermo- and humidistat tank having a temperature of 60° C. and relative humidity of 90% for 500 hours without tension. After the film was carried out of the thermo- and humidistat tank, humidity was controlled at a temperature of 25° C. and relative humidity of 60% for 5 hours or more and Re and Rth were measured (Re(t) and Rth(t)). The wet heat variations of Re and Rth were obtained by the following equations.

Wet heat variation of Re (%)=100×(Re(F)−Re(t))/Re(F)

Wet heat variation of Rth (%)=100×(Rth(F)−Rth(t))/Rth(F)

### (5) Dry Heat Variations of Re and Rth

The dry heat dimension variations of Re and Rth were obtained by the same process as the thermal process of the wet heat dimension variations of Re and Rth except for a temperature of 80° C., a dry state and 500 hours.

### (6) Fine Retardation Variation

The humidity of the sample films was controlled for 5 hours or more at a temperature of 25° C. and relative humidity of 60% and then the Re of 10 sample films were measured using an ellipsometer (made by UNIOPT Corp., automatic birefeingence evaluation system ABR-10A-10AT) while being shifted by 0.1 mm in the MD direction. At this time, a value (fine retardation variation of MD) obtained by dividing a difference between a maximum value and a minimum value by an average value of 10 samples was obtained. The fine retardation variation of TD was obtained by performing the measurement while being shifted by 0.1 mm in the TD direction. A larger side between the fine retardation variation of MD and the fine retardation variation of TD was set to the fine retardation variation.

### (7) Length/Width Ratio

A value (L/W) was obtained by dividing the distance between the nip rolls (L: distance between cores of the two pairs of nip rolls) used in the drawing by the width W of the cellulose acylate film before the drawing. When there are three pairs or more of nip rolls, a largest L/W was set to the Length/Width ratio.

### (8) Relaxation Ratio

This was obtained by dividing the relaxed length by a dimension before the drawing and was expressed by percentage.

### (9) Substitution Degree of Cellulose Acylate

The substitution degree of acyl of cellulose acylate was determined by the use of ¹³C-NMR according to the method described in Carbohydr. Res. 273 (1995), pp. 83 to 91 (by Tezuka, et al).

### (10) Polymerization Ratio of Cellulose Acylate

About 0.2 g of cellulose acylate dried completely was dissolved in a mixed solution of 100 ml of methylenechloride:ethanol=9:1. The time in seconds required for the falling was measured by Ostwald's viscosity meter at 25° C. to obtain the polymerization degree by the following equations:

ηᵣₑₗ=T/T₀;

[η]=In(ηᵣₑₗ)/C; and

DP=[η]/Km

wherein T denotes the time in seconds required for the falling of the measured sample, T₀ denotes the time in seconds required for the falling of a solvent, In denotes a natural log, C denotes a concentration (g/L), and Km denotes 6×10⁻⁴.

### (11) Tg

A 10 mg of film having a residual solvent quantity of 1 mass % or less was sampled, was dried until the percentage of water content is 1% or less, and was put into a measurement pan of DSC. This was heated from 30° C. to 250° C. by 10° C./min and was then cooled to 30° C. C by −20° C./min in nitrogen stream. Thereafter, this is heated from 30° C. to 250° C. by 10° C./min. Tg in a dry state was obtained by obtaining a temperature in which a base line starts to be biased from a lower temperature side from a DSC curved line.

### (12) Bowing Ratio

The bowing line was formed by drawing a straight line on the surface of the film before the transverse drawing using a permanent marker ink in the transverse direction. This bowing line is retracted in a concave shape or a convex shape with respect to the longitudinal direction of the film to be distorted in an arched line after the drawing in the tenter. At this time, a maximum convex amount or concave amount of the bowing line of the arched line was measured to calculate the bowing ratio (distortion) by the following equation.

At this time, a bowing line having a convex shape with respect to the traveling direction of the film is negative (−) and a bowing line having a concave shape is positive (+)

Bowing ratio (%)=maximum convex amount or concave amount of bowing line (mm)/entire width of film (mm)×100

(13) Quantity of Residual Solvent of Film Material before Drawing

The quantity of the residual solvent of the film material before the drawing was measured by gas chromatography (GC-18A, Shimadzu Corporation) by the following order. That is, 300 mg of film material before the drawing was dissolved in 30 ml of a solvent (dissolved in methyl acetate if the film is formed using a chlorine-based solvent and dissolved in dichloromethane if the film is formed using a non-chlorine-based solvent). This solution was analyzed using gas chromatography (GC) under the following condition and the quantity was determined using an analytical curve from a peak area other than the solvent and the sum thereof was the quantity of the residual solvent.
Column: DB-WAX(0.25 mmφ×30 m, thickness 0.25 μm)
Column temperature: 50° C.
Carrier gas: Nitrogen
Analysis time: 15 minutes
Sample injection quantity: 1 μl

### (14) Temperature Distribution of Longitudinal Direction and Temperature Distribution of Transverse Direction in Drawing Tenter

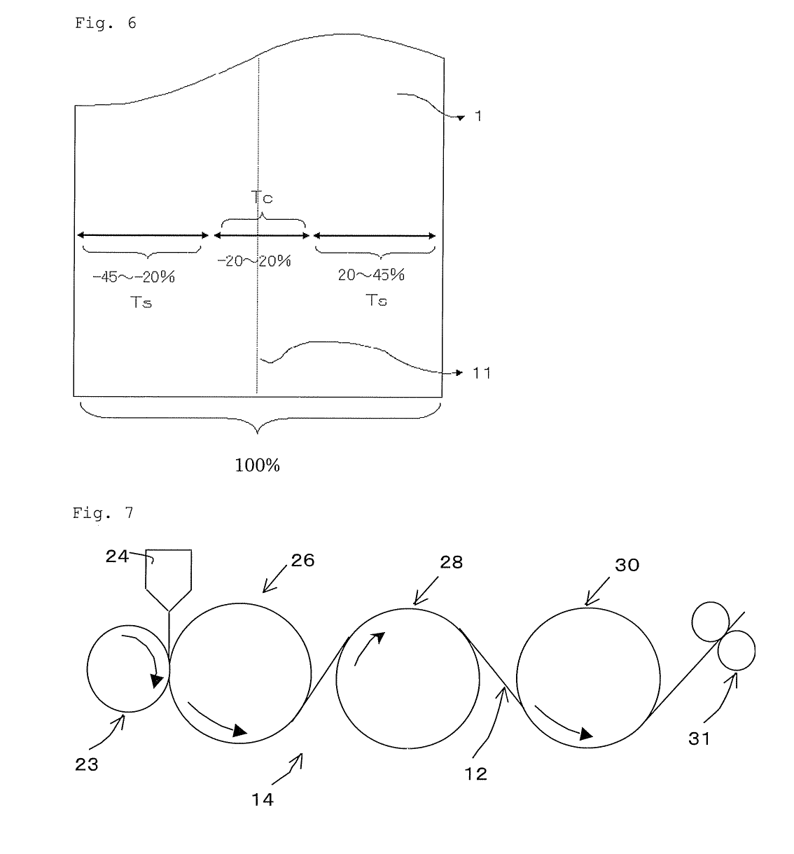

Before the drawing, plural pairs of heat conduction temperature sensors were adhered to the film at 11 positions from the both ends to the central portion of the transverse direction of the film using a Teflon tape and the temperatures of the zones and the temperature of the transverse direction were measured and recorded while the film are drawn and carried by the chucks (tenter clips). A difference between the temperature Ts of the both ends and the temperature Tc of the central portion was the temperature distribution of the transverse direction. Ts is an average temperature of a portion of 20 to 45% (total width of the film is 100%) from the central portion of the transverse direction of the film to the both sides and Tc is an average temperature of 20% or less from the central portion to the both sides (see FIG. 6).

### (15) Dimension Variation of Film of Wet Heat Process and Dry Heat Process

The dimension variation of the film in the wet heat and the dry heat was measured using an automatic pin gauge (made by Shinto Scientific Co., Ltd.). Five sample pieces having a length of 150 mm and a width of 50 mm in the casting direction (MD) of the sample film and the transverse direction (TD) were sampled. Holes of 6 mmφ were formed in the both ends of the sample pieces using a punch at an interval of 100 mm. The humidity was controlled for 24 hours or more in a chamber having a temperature of 25° C. and a relative humidity of 60%. An original dimension L1 of the punch interval was measured using the pin gauge up to a minimum scale of 1/1000 mm. Next, each sample piece was suspended without a load in a constant-temperature device having a temperature of 60° C. and a relative humidity of 90% or an oven having a temperature of 90° C. and a dry state and was heated for 500 hours, the humidity was controlled for 24 hours or more in a chamber having a temperature 25° C. and a relative humidity of 60%, and a dimension L2 of the punch interval after the heating treatment was measured using the automatic pin gauge. The dimension variation ratio was calculated by the following equation. The dimension variation ratio described herein is an average value of the measured values of the five sample pieces.

Dimension variation ratio (%)={(L2−L1)/L1}×100

### (16) Evaluation of Warpage

The cellulose acylate film was saponified and the following polarizing plate (drawn cellulose acylate film/PVA polarizer film/undrawn cellulose acylate) was produced using an adhesive including 3% PVA aqueous solution. The obtained polarizing plate was adhered with a thin glass plate having a thickness of 0.7 mm and a size of 40 inches using an adhesive. The polarizing plate was left for 30 minutes in an autoclave of 5 atmosphere at 50° C. to mature an adhesion state, the glass plate attached with the obtained polarizing plate was left for 24 hours at a temperature of 60° C. and a relative humidity of 90% or a temperature of 90° C. and a dry state, and the curved height of the longitudinal direction of the glass was measured. The measurement was performed using a caliper having measurement precision of 0.001 mm and a maximum value of the curved portion of the longitudinal direction of the glass plate was set to warpage. The maximum value of the warpage after 24 hours under the condition of a temperature of 60° C., a relative humidity of 90% or a temperature of 90° C. and a dry state is shown in Table 3.

### (17) Evaluation of Display Unevenness

A fresh product of a polarizing plate which is prepared using the cellulose acylate film and a polarizing plate after a wet heat thermal process (60° C., a relative humidity of 90%, 500 hours) or a dry heat thermal process (80° C., a dry state, 500 hours) were provided such that the drawn cellulose acylate is placed at a liquid crystal side, polarizing plates provided at viewer sides of liquid crystal display devices (made by Sharp Corporation) having a size of 20 inches and 40 inches were stripped based on the method described in FIGS. 2 to 9 of Japanese Unexamined Patent Application Publication No. 2000-154261, and polarizing plates to be evaluated were adhered to the viewer side using an adhesive such that the sample film is provided at the liquid crystal cell. This was compared with the polarizing plate subjected to the wet heat thermal process or the polarizing plate subjected to the dry heat thermal process and light leakage, color unevenness, in-plane viewing uniformity generated in the VA liquid crystal device having a black display state were evaluated by naked eyes in an environment having a temperature of 25° C. and a relative humidity of 60%. The display quality was evaluated to three ranks as follows.

∘ Light leakage and color unevenness were not generated in the four frames of a liquid crystal device.

It was a panel having good viewing uniformity and good and excellent quality.

Δ Light leakage and color unevenness were slightly generated in the four frames of a liquid crystal device.

It was a panel having good quality.

x Light leakage and color unevenness were wholly observed in the four frames of a liquid crystal device.

It was an unpreferable product having bad viewing uniformity.

### EXAMPLES

Hereinafter, the invention will be further specifically described with reference to Examples. In the following Examples, materials, the amount and the ratio thereof, details of the treatment, and the treatment process may be suitably modified within the range of not impairing the purpose of the invention. Accordingly, the invention should not be limitatively interpreted by the Examples mentioned below.

### Example A

### 1. Cellulose Acylate Resin

### (1-1) Synthesis of Cellulose Acetate Propionate (CAP)

150 parts by weight of cellulose (hardwood pulp) and 75 parts by weight of acetic acid were added to a reaction vessel equipped with a reflux device and the mixture was fiercely stirred for 2 hours while the vessel was heated at 60° C. The cellulose subjected to the pre-treatment as above was swollen and dissolved to have a fluffy shape. Then, the reaction vessel was left and cooled in an iced water bath at 2° C. for 30 min.

Separately, a mixture of 1,545 parts by weight of a propionic anhydride and 10.5 parts by weight of sulphuric acid was prepared as an acylating agent, and cooled at −30° C. After that, the mixture was added at one time to the reaction vessel in which the cellulose subjected to the pre-treatment was placed. After 30 minutes, exterior temperature was gradually increased in such a manner that interior temperature is adjusted to be 25° C. when 2 hours have passed after adding the acylating agent. The reaction vessel was cooled in the iced water bath at 5° C. in such a manner that the interior temperature is adjusted to be 10° C. when 0.5 hours have passed after adding the acylating agent, and adjusted to be 23° C. when 2 hours have passed after adding the acylating agent. Then, the mixture was stirred again for 3 hours while the interior temperature of the vessel was kept at 23° C. The reaction vessel was cooled in the iced water bath at 5° C., and 120 parts by weight of acetic acid having a water content of 25% by mass cooled at 5° C. was added to the vessel for 1 hour. The interior temperature was increased to 40° C. and the mixture was stirred for 1.5 hours (ripening). After that, a solution in which magnesium acetate tetrahydrate is dissolved by twice as much as sulphuric acid in mol in acetic acid having water content of 50% by mass is added to the reaction vessel, and then the mixture was stirred for 30 min. To the mixture, 1,000 parts by weight of acetic acid having a water content of 25% by mass, 500 parts by weight of acetic acid having a water content of 33% by mass, 1,000 parts by weight of acetic acid having a water content of 50% by mass, and 1,000 parts by weight of water were added in such an order, thereby precipitating cellulose acetate propionate. The obtained precipitate of cellulose acetate propionate was washed with warm water. After washing, the precipitate of cellulose acetate propionate was stirred in 0.005% by mass of calcium hydroxide aqueous solution at 20° C. for 0.5 hours. Subsequently, the precipitate of cellulose acetate propionate was washed again with water till the pH of a washing solution became 7 and vacuum dried at 70° C. According to NMR and GPC measurement, the obtained cellulose acetate propionate had the acetylation (Ac) degree of 0.3°, the propionylation (Pr) degree of 2.63, and the polymerization degree of 320.

Other compositions described in table 1 (substitution degree of acetylation and propionylation) and polymerization degree of CAP were controlled by varying the amount of acylation agent and by varying the ripening time, respectively.

### (1-2) Synthesis of Cellulose Acetate Butylate (CAB)

100 parts by weight of cellulose (hardwood pulp) and 135 parts by weight of acetic acid were added to a reaction vessel equipped with a reflux device and the flask was heated at 60° C. and left for 1 hour. After that, the mixture was fiercely stirred for 1 hour while the flask was heated at 60° C. The cellulose subjected to the pre-treatment as above was swollen and dissolved to have a fluffy shape. The reaction vessel was lest in an iced water bath at 5° C. for 1 hour to sufficiently cool the cellulose.

Separately, a mixture of 1,080 parts by weight of a butyric acid anhydride and 10.0 parts by weight of sulphuric acid was prepared as an acylating agent, and cooled at −20° C. After that, the mixture was added at one time to the reaction vessel in which the cellulose subjected to the pre-treatment was placed. After 30 minutes, exterior temperature was gradually increased to 20° C., and the mixture was reacted for 5 hours. The reaction vessel was cooled in the iced water bath at 5° C., and 2,400 parts by weight of acetic acid having a water content of 12.5% by mass cooled at 5° C. was added to the vessel for 1 hour. The interior temperature was increased to 30° C. and the mixture was stirred for 1 hours (ripening). After that, to the reaction vessel, 100 parts by weight of magnesium acetate tetrahydrate aqueous solution (50% by mass) was added and the mixture was stirred for 30 min. To the mixture, 1,000 parts by weight of acetic acid and 2,500 parts by weight of acetic acid having a water content of 50% by mass were gradually added, thereby precipitating cellulose acetate butylate. The obtained precipitate of cellulose acetate butylate was washed with warm water. After washing, the precipitate of cellulose acetate butylate was stirred in 0.005% by mass of calcium hydroxide aqueous solution for 0.5 hours. Subsequently, the precipitate of cellulose acetate butylate was washed again with water till the pH of a washing solution became 7 and dried at 70° C. The obtained cellulose acetate butylate had the acetylation (Ac) degree of 0.84, the butyrylation (Bu) degree of 2.12, and the polymerization degree of 268.

Other compositions described in table 1 (substitution degree of acetylation and butyrylation) and polymerization degree of CAB were controlled by varying the amount of acylation agent and by varying the ripening time, respectively.

### (1-3) Synthesis of Other Cellulose Acylates

By varying the kinds and amounts of the acylating agent, the substitution degree was varied, and by varying the ripening time, the polymerization degree was varied, thereby synthesizing cellulose acylate other than CAP and CAB represented in Table 1.

### 2. Film Melt Forming

### (2-1) Film Forming

### (2-1-1) Pelletization of Cellulose Acylate

100 parts by weight of the cellulose acylate, plasticizer (5 parts by weight of polyethylene glycol (molecular weight 60), 4 parts by weight of glycerin diacetate olate), stabilizer (0.1 parts by weight of bis-(2,6-di-tert-butyl-4-methylphenyl)phosphite, 0.1 parts by weight of tris-(2,4-di-tert-butylphenyl)phosphite), 0.05 parts by weight of silicon dioxide particle (Aerosil R972V), and UV absorbents (0.05 parts by weight of 2-(2′-hydroxy-3′,5-di-tert-butylphenyl)-benzotriazole and 0.1 parts by weight of 2,4-hydroxy-4-methoxybenzophenone) were mixed. And an optical adjuster having following structure (a retardation controlling agent) was added as described in table 1.

The mixture was dried at 100° C. for 3 hours to have a water content of 0.1% by mass or less. Then, the mixture was melted at 180° C. by the use of a twin screw kneader, extruded as a strand shape into warm water of 60° C., and cut to mold a cylinder shaped pellet having 3 mm of diameter and 5 mm of length.

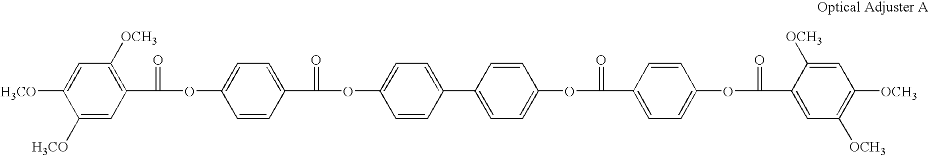

### Optical Adjuster B

A plate-shaped compound disclosed in Japanese Unexamined Patent Application Publication No. 2003-66230 (Formula I)

### (2-1-2) Melt-Casting Film Formation

A cellulose acylate pellet prepared by the above-described method was dried for 5 hours at 100° C. using dehumidification wind of dew-point temperature −40° C. such that the percentage of water content becomes 0.01 mass % or less. The pellet was input to a hopper of 80° C. and was molten by a melt extruder having a temperature of 180° C. (inlet temperature) and a temperature of 220° C. (outlet temperature). The diameter of the screw used herein was 60 mm, L/D=50, and a pressure ratio was 4. A predetermined amount of resin extruded from the melt extruder was sent via a gear pump. At this time, the number of rotations of the extruder was changed such that the pressure of the resin before the gear pump is controlled to a predetermined pressure of 10 MPa. The melt resin discharged from the gear pump was filtered using a leaf disc filter having filtering precision of 5 μm and was extruded from a hanger coat die having a temperature of 220° C. and a slit gap of 0.8 mm via a static mixer.

This was solidified by a casting drum of (Tg−10° C.) At this time, electrostatic charges were applied to the both ends by 10 cm using an electrostatic charge applying method (a 10-kV wire is mounted at a place separated from a landing point of the casting drum of the melt by 10 cm). The solidified melt was detached from the casting drum, the both ends thereof were trimmed (5% of the entire width) immediately before winding, and the both ends thereof were subjected to a process (knurling) for adjusting the width to 10 mm and the height to 50 μm, thereby obtaining an undrawn film having a width 1.5 m and a length of 3000 m at 30 m/min.

### (2-2) Solution-Casting Film Formation

### (2-2-1) Feeding

100 mass % of cellulose acylate resin was dried such that the percentage of water content becomes 0.1 mass % or less and the following additive agents were added thereto.
Plasticizer: 9 mass % of triphenylphosphate (TPP) and 3 mass % of biphenyldiphenylphosphate (BDP)
Optical adjuster: Optical adjuster A or B of the amount described in Table 1
UV agent a: 2,4-bis-(n-octylthio)-6-(4-hydroxy-3,5-di-tert-butylanilino)-1,3,5-triazine (0.5 mass %)
UV agent b: 2(2′-hydroxy-3′,5′-di-tert-butylphenyl)-5-chlorobenzotriazole (0.2 mass %)
UV agent c: 2(2′-hydroxy-3′,51)-di-tert-amylphenyl)-5-chlorobenzotriazole (0.1 mass %)
Particles: silicon dioxide(particle size 20 nm), Mohs hardness) about 7(0.25 mass %)
Solvent (described in Table 1) was dissolved in citric acid ethyl ester (1:1 mixture of monoester and diester, 0.2 mass %) and such that the quantity of the cellulose acylate becomes 25 mass %.

Non-chlorine-based: methyl acetate/acetone/methanol/ethanol/buthanol (mass ratio 80/5/7/5/3)
Chlorine-based: dichloromethane/buthanol (mass ratio 94/6)

### (2-2-2) Swelling and Dissolution

The cellulose acylate, the solvent and the additive agents were fed to the solvent while being stirred. When the feeding is finished, the stirring was stopped and the swelling process was performed for 3 hours at 25° C., thereby preparing a slurry. This is stirred again to completely dissolve the cellulose acylate.

### (2-2-3) Filtering and Condensation

Thereafter, this was filtered by a filter paper (made by Toyo Roshi Kaisha, LTd., #63) having absolute filtering precision of 0.01 mm and was filtered by a filter paper (made by Poul Co., FH025) of absolute filtering precision of 3 μm.

### (2-2-4) Forming Film

The above-described dope was heated to 35° C. and was casted by the following banding method. In addition, the film was formed by the following drum method to obtain the same result as the banding method.

### (i) Banding Method

Geeser was passed and casted onto a mirror stainless support having a band length of 60 m at 15° C. The used geeser similar to that disclosed in Japanese Unexamined Patent Application Publication No. 11-314233 was used. The casting speed was 40 m/min and the casting width was 150 cm. The film was peeled off in a state that the quantity of residual solvent is 100 mass % and was dried at 130° C. and was wound when the quantity of the residual solvent becomes 1 mass % or less, obtaining a cellulose acylate film. The both ends of the e film were trimmed by 3 cm, and knurls having a height of 100 μm were applied to potions spaced apart from the both ends by 2 to 10 mm, and the film was wound in a roll shape by 3000 m.

### (ii) Drum Method

Geeser was passed and casted onto a mirror stainless drum having a diameter of 3 m at −15° C. The geeser similar to that disclosed in Japanese Unexamined Patent Application Publication No. 11-314233 was used. The casting speed was 100 m/min and the casting width was 250 cm. The film was peeled off in a state that the quantity of residual solvent is 200 mass % and was dried at 130° C. and was wound when the quantity of the residual solvent becomes 1 mass % or less, obtaining a wound cellulose acylate film. The both ends of the obtained film were trimmed by 3 cm, and knurls having a height of 100 μm were applied to potions spaced apart from the both ends by 2 to 10 mm, and the film was wound in a roll shape by 3000 m.

### 3. Drawing

### (3-1) Longitudinal (MD) Drawing

The cellulose acylate films (the quantity of the residual solvent of the film obtained by the solution-casting film formation method was greater than 0.01 mass % and was equal to or less 0.5 mass % and the quantity of the residual solvent of the film obtained by the melt-casting film formation method was 0 mass %) obtained by the melt-casting film formation method and the solution-casting film formation method were longitudinally drawn using two pairs of nip rolls with a drawing ratio described in Table 1 at (Tg+15° C.), a drawing speed, a method (inclination and parallel), and a length/width ratio described in Table 1. After the longitudinal drawing, longitudinal relaxation was performed at Tg with a relaxation ratio described in Table 1 at a timing (after the longitudinal drawing and after the transverse drawing (In Table 1, they were described as “after longitudinal” and “after transverse”)). The longitudinal relaxation after the longitudinal drawing was performed by reducing the speed of the carrying roll immediately after the longitudinal drawing of the nip roll.

### (3-2) Transverse (TD) Drawing

After the longitudinal drawing and the longitudinal relaxation, transverse drawing was performed with a drawing ratio described in Table 1 at (Tg+10° C.) using the tenter. Thereafter, transverse relaxation was performed at Tg as shown in Table 1. The transverse relaxation was performed by providing a heating zone next to the tenter and carrying the film in the heating zone with low tension at Tg.

### 4. Evaluation of Drawn Film

The wet heat dimension variation δ(L(w)), the dry heat dimension variation (δL(d)), Re and Rth before the wet heating and dry heating processes (fresh), the fine retardation variation, the wet heat variation δRe(w) and δRth(w) of Re and Rth, the dry heat variation δRe(d) and δRth(d) of Re and Rth were measured by the above-described method and described in Table 1.

TABLE 1

| | Cellulous acylate | | | | | | | | | | |
|---|---|---|---|---|---|---|---|---|---|---|---|
| | Substitution degree | | | | | | | | Optical adjuster | | |
| | Acetate | Propionate | Butylate | Pentanoate | Hexanoate | B (sum of | | Polymerization | | Amount | |
| | group (A) | group (B1) | group (B2) | group (B3) | group (B4) | B1 to B4) | A + B | degree | Kind | (wt %) | Tg (° C.) |
| Example 1 | 0.30 | 2.63 | | | | 2.63 | 2.93 | 320 | — | 0 | 115 |
| Example 2 | 1.30 | 1.50 | | | | 1.50 | 2.80 | 170 | — | 0 | 132 |
| Example 3 | 1.30 | 1.50 | | | | 1.50 | 2.80 | 170 | — | 0 | 132 |
| Example 4 | 1.30 | 1.50 | | | | 1.50 | 2.80 | 170 | — | 0 | 132 |
| Comparative | 1.30 | 1.50 | | | | 1.50 | 2.80 | 170 | — | 0 | 132 |
| Example 1 | | | | | | | | | | | |
| Comparative | 1.30 | 1.50 | | | | 1.50 | 2.80 | 170 | — | 0 | 132 |
| Example 2 | | | | | | | | | | | |
| Comparative | 1.30 | 1.50 | | | | 1.50 | 2.80 | 170 | — | 0 | 132 |
| Example 3 | | | | | | | | | | | |
| Example 5 | 0.70 | 2.00 | | | | 2.00 | 2.70 | 120 | — | 0 | 124 |
| Example 6 | 0.70 | 2.00 | | | | 2.00 | 2.70 | 120 | — | 0 | 124 |
| Example 7 | 0.70 | 2.00 | | | | 2.00 | 2.70 | 120 | — | 0 | 124 |
| Example 8 | 0.70 | 2.00 | | | | 2.00 | 2.70 | 120 | — | 0 | 124 |
| Example 9 | 0.70 | 2.00 | | | | 2.00 | 2.70 | 120 | — | 0 | 124 |
| Example 10 | 0.70 | 2.00 | | | | 2.00 | 2.70 | 120 | — | 0 | 124 |
| Example 11 | 0.70 | 2.00 | | | | 2.00 | 2.70 | 120 | — | 0 | 124 |
| Example 12 | 0.70 | 2.00 | | | | 2.00 | 2.70 | 120 | — | 0 | 124 |
| Example 13 | 0.70 | 2.00 | | | | 2.00 | 2.70 | 120 | — | 0 | 124 |
| Example 14 | 0.10 | 2.85 | | | | 2.85 | 2.95 | 240 | A | 3 | 100 |
| Example 15 | 1.26 | 1.26 | | | | 1.26 | 2.52 | 220 | — | 0 | 190 |
| Example 16 | 0.84 | | 2.12 | | | 2.12 | 2.96 | 268 | — | 0 | 110 |
| Example 17 | 1.00 | | 1.70 | | | 1.70 | 2.70 | 185 | — | 0 | 120 |
| Example 18 | 1.20 | | 1.30 | | | 1.30 | 2.50 | 125 | B | 5 | 130 |
| Example 19 | 0.70 | 0.50 | 0.50 | 0.50 | 0.50 | 2.00 | 2.70 | 210 | — | 0 | 90 |
| Example 20 | 0.20 | 2.75 | | | | 2.75 | 2.95 | 280 | B | 12 | 90 |
| Example 21 | 0.75 | 2.00 | | | | 2.00 | 2.75 | 200 | A | 8 | 100 |
| Example 22 | 1.20 | 2.30 | | | | 2.30 | 2.50 | 120 | — | 0 | 130 |
| Example 23 | 1.10 | | 1.70 | | | 1.70 | 2.80 | 290 | — | 0 | 125 |
| Example 24 | 0.40 | | 2.20 | | | 2.20 | 2.60 | 210 | A | 10 | 125 |
| Example 25 | 0.15 | | 2.80 | | | 2.80 | 2.95 | 120 | B | 14 | 85 |
| Example 26 | | 0.70 | 0.70 | 0.75 | 0.75 | 2.90 | 2.90 | 160 | A | 18 | 80 |
| Comparative | 2.90 | | | | | 0.00 | 2.90 | 300 | — | 0 | 120 |
| Example* 4 | | | | | | | | | | | |
| Example 27 | 2.90 | | | | | 0.00 | 2.90 | 300 | — | 0 | 120 |
| Example 28 | 1.60 | | | | | 1.30 | 2.90 | 300 | — | 0 | 120 |
| Comparative | 1.95 | 0.70 | | | | 0.70 | 2.65 | 250 | — | 0 | 115 |
| Example** 5 | | | | | | | | | | | |
| Example 29 | 1.95 | 0.70 | | | | 0.70 | 2.65 | 250 | — | 0 | 115 |
| Example 30 | 0.45 | 2.40 | | | | 2.40 | 2.85 | 150 | — | 0 | 125 |
| Example 31 | 1.00 | | 1.70 | | | 1.70 | 2.70 | 185 | — | 0 | 120 |

| | | | Drawing method | | | | | | | |
|---|---|---|---|---|---|---|---|---|---|---|
| | | | MD | | | | | | TD | |
| | | | | | Drawing | Drawing | MD | | Drawing | TD |
| | Film forming process | | | | ratio | speed | relaxation | MD relaxation | ratio | relaxation |
| | Method | Solvent | MD/TD | Kind | (%) | (m/min) | (%) | timing | (%) | (%) |
| Example 1 | Melt casting | — | 0.02 | Inclined | 7 | 30 | 3 | After MD drawning | 50 | 3 |
| Example 2 | Melt casting | — | 0.1 | Inclined | 7 | 30 | ″ | After MD drawning | 50 | 3 |
| Example 3 | Melt casting | — | 0.28 | Inclined | 7 | 30 | ″ | After MD drawning | 50 | 3 |
| Example 4 | Melt casting | — | 0.1 | Inclined | 7 | 30 | 1 | After MD drawning | 50 | 3 |
| Comparative | Melt casting | — | 0.008 | Inclined | 7 | 30 | 3 | After MD drawning | 50 | 3 |
| Example 1 | | | | | | | | | | |
| Comparative | Melt casting | — | 0.32 | Parallel | 7 | 30 | ″ | After MD drawning | 50 | 3 |
| Example 2 | | | | | | | | | | |
| Comparative | Melt casting | — | 0.1 | Inclined | 7 | 30 | 0 | — | 50 | 3 |
| Example 3 | | | | | | | | | | |
| Example 5 | Melt casting | — | 0.2 | Inclined | 2 | 20 | 1 | After MD drawning | 240 | 48 |
| Example 6 | Melt casting | — | 0.2 | Inclined | 20 | 20 | 8 | After MD drawning | 170 | 28 |
| Example 7 | Melt casting | — | 0.2 | Inclined | 100 | 20 | 25 | After MD drawning | 80 | 15 |
| Example 8 | Melt casting | — | 0.2 | Inclined | 6 | 20 | 3 | After MD drawning | 8 | 4 |
| Example 9 | Melt casting | — | 0.2 | Inclined | 300 | 20 | 50 | After MD drawning | 5 | 1 |
| Example 10 | Melt casting | — | 0.2 | Inclined | 20 | 11 | 8 | After MD drawning | 170 | 28 |
| Example 11 | Melt casting | — | 0.2 | Inclined | 20 | 95 | 8 | After MD drawning | 170 | 28 |
| Example 12 | Melt casting | — | 0.2 | Inclined | 20 | 8 | 8 | After MD drawning | 170 | 28 |
| Example 13 | Melt casting | — | 0.2 | Inclined | 20 | 20 | 8 | After MD drawning | 170 | 28 |
| Example 14 | Melt casting | — | 0.2 | Inclined | 12 | 25 | 5 | After MD drawning | 140 | 18 |
| Example 15 | Melt casting | — | 0.2 | Inclined | 35 | 25 | 8 | After MD drawning | 35 | 5 |
| Example 16 | Melt casting | — | 0.2 | Inclined | 7 | 25 | 2 | After MD drawning | 200 | 45 |
| Example 17 | Melt casting | — | 0.2 | Inclined | 100 | 25 | 20 | After MD drawning | 15 | 6 |
| Example 18 | Melt casting | — | 0.2 | Inclined | 280 | 25 | 50 | After MD drawning | 15 | 0 |
| Example 19 | Melt casting | — | 0.2 | Inclined | 150 | 25 | 10 | After MD drawning | 5 | 1 |
| Example 20 | Solution | Chlorine-based | 0.1 | Inclined | 5 | 12 | 2 | After MD drawning | 170 | 22 |
| | casting | | | | | | | | | |
| Example 21 | Solution | Chlorine-based | 0.1 | Inclined | 20 | 25 | 10 | After MD drawning | 20 | 8 |
| | casting | | | | | | | | | |
| Example 22 | Solution | Chlorine-based | 0.1 | Inclined | 100 | 85 | 25 | After MD drawning | 20 | 4 |
| | casting | | | | | | | | | |
| Example 23 | Solution | Non-chlorine-based | 0.2 | Inclined | 10 | 14 | 4 | After MD drawning | 220 | 46 |
| | casting | | | | | | | | | |
| Example 24 | Solution | Non-chlorine-based | 0.2 | Inclined | 80 | 35 | 15 | After MD drawning | 150 | 35 |
| | casting | | | | | | | | | |
| Example 25 | Solution | Non-chlorine-based | 0.2 | Inclined | 150 | 85 | 40 | After MD drawning | 70 | 18 |
| | casting | | | | | | | | | |
| Example 26 | Solution | Non-chlorine-based | 0.05 | Inclined | 280 | 95 | 48 | After MD drawning | 10 | 3 |
| | casting | | | | | | | | | |
| Comparative | Solution | Chlorine-based | 2 | Parallel | 40 | 8 | 0 | — | 0 | 0 |
| Example* 4 | casting | | | | | | | | | |
| Example 27 | Solution | Chlorine-based | 0.1 | Inclined | 40 | 15 | 5 | After MD drawning | 0 | 0 |
| | casting | | | | | | | | | |
| Example 28 | Solution | Chlorine-based | 0.1 | Inclined | 40 | 15 | 5 | After MD drawning | 0 | 0 |
| | casting | | | | | | | | | |
| Comparative | Solution | Chlorine-based | 1.5 | Parallel | 50 | 8 | 0 | — | 0 | 0 |
| Example** 5 | casting | | | | | | | | | |
| Example 29 | Solution | Chlorine-based | 0.1 | Inclined | 50 | 15 | 8 | After MD drawning | 0 | 0 |
| | casting | | | | | | | | | |
| Example 30 | Melt casting | — | 0.02 | Inclined | 5 | 30 | 3 | After MD drawning | 45 | 3 |
| Example 31 | Melt casting | — | 0.02 | Inclined | 10 | 30 | 20 | After MD drawning | 55 | 6 |

| | Evaluation of drawn film | | | | | | | | | | | |
|---|---|---|---|---|---|---|---|---|---|---|---|---|
| | Re | | | Rth | | | Dimension variation | | Fine | | | |
| | | δ Re | δ Re | | δ Rth | δ Rth | δ L | δ L | retardation | | Display unevenness | |
| | Fresh | (w) | (d) | Fresh | (w) | (d) | (w) | (d) | variation | Composition of | Dry thermo | Wet thermo |
| | (nm) | (%) | (%) | (nm) | (%) | (%) | (%) | (%) | (%) | polarizing plate | (%) | (%) |
| Example 1 | 80 | 0 | 0 | 260 | 0 | 0 | 0 | 0 | 0 | A | 0 | 0 |
| Example 2 | 50 | 0 | 0 | 200 | 0 | 0 | 0 | 0 | 0 | A | 0 | 0 |
| Example 3 | 45 | 8 | 7 | 190 | 7 | 8 | 0.17 | 0.15 | 3 | A | 4 | 5 |
| Example 4 | 45 | 6 | 7 | 195 | 5 | 7 | 0.16 | 0.14 | 3 | A | 3 | 4 |
| Comparative | 60 | 12 | 13 | 210 | 13 | 14 | 0.24 | 0.26 | 15 | A | 25 | 27 |
| Example 1 | | | | | | | | | | | | |
| Comparative | 40 | 22 | 25 | 180 | 24 | 26 | 0.36 | 0.39 | 29 | A | 36 | 38 |
| Example 2 | | | | | | | | | | | | |
| Comparative | 50 | 15 | 17 | 200 | 14 | 18 | 0.31 | 0.29 | 21 | A | 31 | 32 |
| Example 3 | | | | | | | | | | | | |
| Example 5 | 240 | 2 | 3 | 300 | 2 | 2 | 0.04 | 0.04 | 1 | B | 3 | 4 |
| Example 6 | 160 | 1 | 1 | 200 | 1 | 0 | 0.03 | 0.02 | 1 | B | 0 | 1 |
| Example 7 | 40 | 1 | 0 | 100 | 0 | 0 | 0.02 | 0.01 | 0 | B | 0 | 1 |
| Example 8 | 15 | 1 | 1 | 45 | 1 | 1 | 0.03 | 0.02 | 0 | B | 1 | 0 |
| Example 9 | 280 | 3 | 4 | 450 | 4 | 5 | 0.12 | 0.14 | 4 | B | 5 | 6 |
| Example 10 | 150 | 2 | 4 | 200 | 3 | 4 | 0.05 | 0.07 | 2 | B | 2 | 2 |
| Example 11 | 160 | 2 | 3 | 220 | 2 | 2 | 0.04 | 0.05 | 1 | B | 1 | 2 |
| Example 12 | 130 | 7 | 8 | 180 | 8 | 9 | 0.17 | 0.16 | 8 | B | 8 | 7 |
| Example 13 | 150 | 8 | 9 | 170 | 7 | 9 | 0.16 | 0.17 | 7 | B | 9 | 8 |
| Example 14 | 160 | 2 | 2 | 290 | 2 | 3 | 0.06 | 0.05 | 2 | A | 3 | 3 |
| Example 15 | 10 | 2 | 3 | 80 | 2 | 4 | 0.07 | 0.07 | 2 | A | 3 | 2 |
| Example 16 | 300 | 1 | 1 | 330 | 1 | 0 | 0.02 | 0.01 | 0 | A | 1 | 0 |
| Example 17 | 220 | 1 | 1 | 190 | 0 | 1 | 0.03 | 0.02 | 0 | A | 0 | 0 |
| Example 18 | 280 | 5 | 5 | 220 | 4 | 5 | 0.09 | 0.11 | 3 | A | 5 | 6 |
| Example 19 | 130 | 2 | 3 | 180 | 2 | 3 | 0.07 | 0.05 | 1 | A | 2 | 3 |
| Example 20 | 120 | 1 | 1 | 210 | 0 | 1 | 0.01 | 0.02 | 1 | B | 1 | 2 |
| Example 21 | 10 | 0 | 0 | 90 | 0 | 0 | 0.02 | 0.02 | 1 | B | 1 | 1 |
| Example 22 | 180 | 0 | 0 | 240 | 0 | 1 | 0.03 | 0.01 | 2 | B | 2 | 3 |
| Example 23 | 290 | 1 | 0 | 300 | 0 | 1 | 0.03 | 0.02 | 1 | A | 2 | 1 |
| Example 24 | 180 | 1 | 0 | 380 | 1 | 0 | 0.02 | 0.01 | 2 | A | 1 | 2 |
| Example 25 | 140 | 0 | 0 | 280 | 1 | 0 | 0.03 | 0.02 | 2 | A | 1 | 2 |
| Example 26 | 350 | 6 | 6 | 400 | 7 | 7 | 0.08 | 0.11 | 5 | A | 7 | 6 |
| Comparative | 135 | 39 | 43 | 100 | 41 | 44 | 0.45 | 0.47 | 35 | A | 38 | 41 |
| Example* 4 | | | | | | | | | | | | |
| Example 27 | 140 | 7 | 8 | 95 | 8 | 7 | 0.16 | 0.18 | 7 | A | 8 | 7 |
| Example 28 | 160 | 2 | 3 | 115 | 1 | 2 | 0.02 | 0.01 | 2 | A | 3 | 2 |
| Comparative | 250 | 29 | 31 | 100 | 31 | 30 | 0.38 | 0.39 | 28 | A | 31 | 33 |
| Example** 5 | | | | | | | | | | | | |
| Example 29 | 265 | 6 | 5 | 110 | 7 | 7 | 0.02 | 0.03 | 7 | A | 7 | 8 |
| Example 30 | 70 | 0 | 0 | 200 | 0 | 0 | 0 | 0 | 0 | A | 0 | 0 |
| Example 31 | 60 | 1 | 1 | 230 | 0 | 0 | 0.02 | 0.01 | 0 | A | 0 | 0 |

*Sample NO. S-11 in JP-A-2003-315551
**Example 1 in JP-A-2002-311240

### 5. Production of Polarizing Plate

### (5-1) Surface Treatment

The stretched cellulose acylate film was saponified by the following dipping method. The film was also saponified by coating method. The polarizing plate produced by each saponification method showed good optical properties.

### (5-1-1) Dip Saponification

A 1.5 mol/L aqueous solution of NaOH was used as a saponifying solution. This solution was adjusted to a temperature of 60° C., and the cellulose acylate film was dipped therein for 2 minutes. Thereafter, the film was dipped in 0.05 mol/L aqueous solution of sulfuric acid for 30 seconds, and passed through a water-washing bath.

### (5-1-2) Coat Saponification

20 parts by mass of water was added to 80 parts by mass of isopropyl alcohol, and KOH was dissolved therein so that its concentration became 1.5 mol/L. This solution was adjusted to a temperature of 60° C. to use as a saponifying solution. This solution was coated on a cellulose acylate film of 60° C. in an amount of 10 g/m², and saponification was conducted for one minute. Then, warm water of 50° C. was sprayed thereover for 1 minute in an amount of 10 l/m² per minute to conduct washing.

### (5-2) Preparation of Polarizer Film

A circumferential velocity difference was applied to two pairs of nip rolls according to Embodiment 1 of Japanese Unexamined Patent Application Publication No. 2001-141926, and the drawing was performed in the longitudinal direction, thereby preparing a polarizing plate having a thickness of 20 μm. A polarizing plate which is drawn such that a drawing axis is inclined at an angle of 45 degrees similar to Embodiment 1 of Japanese Unexamined Patent Application Publication No. 2002-86554 was prepared and the evaluation result thereof was equal to the result of the above-described polarizing plate.

### (5-3) Lamination

The polarizer thus obtained in (5-2) and the cellulose acylate films formed, stretched, and saponification-treated by (5-1) were laminated so that they were formed in the below combinations by using a 3% aqueous solution of PVA (PVA-117H; manufactured by Kuraray CO., LTD.) as an adhesive. The FUJITAC (TD80; manufactured by Fuji Photo Film Co., Ltd.) listed below was subjected to a saponification treatment by the above-mentioned method.

Polarizing Plate A: Stretched cellulose acylate film/polarizer/FUJITAC

Polarizing Plate B: Stretched cellulose acylate film/polarizer/non-stretched cellulose acylate film

(In polarizing plate B, non-stretched cellulose acylate films were the one which above stretched cellulose acylate films were used before they stretched.)

A fresh product of the obtained polarizing plate and a polarizing plate after a wet heat thermal process (60° C., a relative humidity of 90%, 500 hours) or a dry heat thermal process (80° C., a dry state, 500 hours) were mounted on 20-inch VA liquid crystal display device described in FIGS. 2 to 9 of Japanese Unexamined Patent Application Publication No. 2000-154261 such that the drawn cellulose acylate is placed at a liquid crystal side. The fresh polarizing plate was compared with the polarizing plate subjected to the wet heat thermal process or the polarizing plate subjected to the dry heat thermal process and was evaluated by naked eyes, and a ratio of an area, in which color unevenness, occurs to the entire area was described in Table 1. Embodiments according to the invention had good capabilities.

Meanwhile, optical characteristics other than the range of the invention deteriorated. In particular, Embodiment 1 of Japanese Unexamined Patent Application Publication No. 2002-311240 (Comparative example 4 of Table 1) and Sample No. S-11 of the embodiment of Japanese Unexamined Patent Application Publication No. 2003-315551 (Comparative example 5 of Table 2) significantly deteriorated. In contrast, Embodiments 27, 28 and 29 of the invention had good capabilities. Among them, Embodiment 28 in which the composition of the cellulose acylate is changed to the composition of the cellulose acylate of the invention had better capability.

### 6. Preparation of Optical Compensatory Film

### (6-1) Preparation of Optical Compensatory Film

Instead of the cellulose acetate film coated with a liquid crystal layer of Embodiment 1 of Japanese Unexamined Patent Application Publication No. 11-316378, an optical compensatory film was prepared using the drawn cellulose acylate film of the invention. At this time, an optical compensatory film prepared using the drawn cellulose acylate film (fresh product) immediately after forming and drawing the film and an optical compensatory film prepared using the drawn cellulose acylate film which is subjected to a wet heat thermal process (60° C., a relative humidity of 90%, 500 hours) or a dry heat thermal process (80° C., a dry state, 500 hours) were compared. Regions in which the color unevenness occurs were evaluated by naked eyes to obtain the result that the color unevenness did not occur and good optical capabilities were obtained in the optical compensatory films using the drawn cellulose acylate film of the invention.

### (6-2) Preparation of Optical Compensatory Film

It was also possible to prepare a good optical compensatory film according to the (6-1) mentioned test even when an optical compensatory filter film having the cellulose acylate film according to the present invention in stead of the cellulose acylate film coated with the liquid crystal layer of Example 1 in JP-A-H7-333433.

### (7) Preparation of Low Reflective Film

Low reflective films were prepared by using the cellulose acylate films of the present invention according to Kokai Gifo of Japan Institute of Invention & Innovation, Kogi No. 2001-1745, Example 47. As a result, superior optical performance could be obtained.

### (8) Preparation of Liquid Crystal Display Device

The aforementioned polarizing plates of the present invention were used in the liquid crystal display device described in JP-A-H10-48420, Example 1, optically anisotropic layer containing discotic liquid crystal molecules and oriented film applied with polyvinyl alcohol described in JP-A-H09-26572, Example 1, 20-inch VA type liquid crystal display device described in JP-A-2000-154261, FIGS. 2 to 9, and 20-inch OCB type liquid crystal display device described in JP-A-2000-154261, FIGS. 10 to 15. Further, the low reflective films of the present invention were adhered to the outermost layers of these liquid crystal display devices and evaluated. As a result, superior optical performance could be obtained.

### Embodiment-B

A cellulose acylate raw material having the same composition as Embodiments 30 and 31 of Table 1 of Embodiment A was used and was dried for 5 hours at 100° C. using dehumidification wind of dew-point temperature −40° C. such that the percentage of water content becomes 0.01 mass % or less. This was put into a hopper having a temperature 80° C. and was molten by a melt extruder having a temperature of 180° C. (inlet temperature) and a temperature of 230° C. (outlet temperature). The diameter of the screw used herein was 60 mm, L/D=5°, and a pressure ratio was 4. A predetermined amount of resin extruded from the melt extruder was sent via a gear pump. At this time, the number of rotations of the extruder was changed such that the pressure of the resin before the gear pump is controlled to a predetermined pressure of 10 MPa. The melt resin discharged from the gear pump was filtered using a leaf disc filter having filtering precision of 5 μm, was extruded from a hanger coat die having a temperature of 230° C. and a slit gap of 0.8 mm onto 3 cast rolls having 115° C., 120° C. and 110° C. via a static mixer, a touch roll under the condition described in Table 2 was in contact with an uppermost cast roll, thereby forming an undrawn film (see FIG. 4). That described in Embodiment 1 of Japanese Unexamined Patent Application Publication No. 11-235747 (double pressing roll was used as the touch roll) was used as the touch roll (but, the thickness of the thin outer metal tube was 3 mm).

This was drawn under the condition described in Table 2 and the drawn film was evaluated similar to Embodiment-A.

Thereafter, a polarizing plate was prepared and was subjected to the wet thermal process and the dry thermal process similar to Embodiment-A. These processes were performed for 1000 hours or 500 hours. In the film formed using the touch roll, the color unevenness hardly occurred although the time of the thermal process increases to 1000 hours.

With respect to the cellulose acylate film described in Table 2, an optical compensatory film, a low reflection film and a liquid crystal display device were prepared similar to Embodiment-A and had good capabilities.

The film was formed using the touch roll (cooling water used in an outer metal tube is changed to oil having a temperature of 18° C. to 120° C.) similar to a first embodiment of PCT Publication 97/28950 (described as a sheet molding roll) and was drawn under the condition described in Table 2 to prepare the optical compensatory film, the low reflection film and the liquid crystal display device. In this case, the result described in Table 2 was obtained.

TABLE 2
Table 2

| | | Touch roll film formation | | | Evaluation | | |
|---|---|---|---|---|---|---|---|
| | | linear | | | of drawn film | | |
| | Substitution degree, polymarization | pressure of | Temperature | | Re | | |
| | degree, optimal adjuster, and Tg of | touch roll | of touch roll | | Fresh | δ Re (w) | δ Re (d) |
| | cellulose acylate | (kg/cm) | (° C.) | Drawing condition | (nm) | (%) | (%) |
| Example a | The same as Example 30 in Table 1 | Did not use touch roll | | The same as Example 30 in Table 1 | 70 | 0 | 0 |
| Example a-1 | The same as Example 30 in Table 1 | 3 | 120 | The same as Example 30 in Table 1 | 70 | 0 | 0 |
| Example a-2 | The same as Example 30 in Table 1 | 10 | 120 | The same as Example 30 in Table 1 | 70 | 0 | 0 |
| Example a-3 | The same as Example 30 in Table 1 | 50 | 120 | The same as Example 30 in Table 1 | 72 | 0 | 0 |
| Example a-4 | The same as Example 30 in Table 1 | 95 | 120 | The same as Example 30 in Table 1 | 74 | 0 | 0 |
| Example a-5 | The same as Example 30 in Table 1 | 105 | 120 | The same as Example 30 in Table 1 | 80 | 0 | 0 |
| Example a-6 | The same as Example 30 in Table 1 | 20 | 55 | The same as Example 30 in Table 1 | 80 | 0 | 0 |
| Example a-7 | The same as Example 30 in Table 1 | 20 | 65 | The same as Example 30 in Table 1 | 74 | 0 | 0 |
| Example a-8 | The same as Example 30 in Table 1 | 20 | 100 | The same as Example 30 in Table 1 | 72 | 0 | 0 |
| Example a-9 | The same as Example 30 in Table 1 | 20 | 150 | The same as Example 30 in Table 1 | 70 | 0 | 0 |
| Example a-10 | The same as Example 30 in Table 1 | 20 | 170 | The same as Example 30 in Table 1 | 65 | 0 | 0 |
| Example b | The same as Example 31 in Table 1 | Did not use touch roll | | The same as Example 31 in Table 1 | 60 | 1 | 1 |
| Example b-1 | The same as Example 31 in Table 1 | 10 | 115 | The same as Example 31 in Table 1 | 65 | 0 | 0 |

| | Evaluation of drawn film | | | | | | | | | | |
|---|---|---|---|---|---|---|---|---|---|---|---|
| | | | | Dimension | | | | Display | | | |
| | Rth | | | variation | | Fine | | unevenness | | | |
| | | δ Rth | δ Rth | δ L | δ L | retardation | Composition | Dry thermo | | Wet thermo | |
| | Fresh | (w) | (d) | (w) | (d) | variation | of polarizing | 500 h | 1000 h | 500 h | 1000 h |
| | (nm) | (%) | (%) | (%) | (%) | (%) | plate | (%) | (%) | (%) | (%) |
| Example a | 200 | 0 | 0 | 0 | 0 | 0 | A | 0 | 2.2 | 0 | 3.3 |
| Example a-1 | 200 | 0 | 0 | 0 | 0 | 0 | A | 0 | 0.5 | 0 | 0.8 |
| Example a-2 | 200 | 0 | 0 | 0 | 0 | 0 | A | 0 | 0.1 | 0 | 0.2 |
| Example a-3 | 205 | 0 | 0 | 0 | 0 | 0 | A | 0 | 0 | 0 | 0 |
| Example a-4 | 210 | 0 | 0 | 0 | 0 | 0 | A | 0 | 0.2 | 0 | 0.3 |
| Example a-5 | 240 | 0 | 0 | 0 | 0 | 0 | A | 0 | 1.3 | 0 | 1.8 |
| Example a-6 | 225 | 0 | 0 | 0 | 0 | 0 | A | 0 | 1 | 0 | 1.3 |
| Example a-7 | 210 | 0 | 0 | 0 | 0 | 0 | A | 0 | 0.3 | 0 | 0.6 |
| Example a-8 | 205 | 0 | 0 | 0 | 0 | 0 | A | 0 | 0.1 | 0 | 0.2 |
| Example a-9 | 200 | 0 | 0 | 0 | 0 | 0 | A | 0 | 0 | 0 | 0 |
| Example a-10 | 190 | 0 | 0 | 0 | 0 | 0 | A | 0 | 1.3 | 0 | 0.5 |
| Example b | 230 | 0 | 0 | 0.02 | 0.01 | 0 | A | 0 | 2.3 | 0 | 3.5 |
| Example b-1 | 235 | 0 | 0 | 0 | 0 | 0 | A | 0 | 0 | 0 | 0 |

### Example C

### 1. Cellulose Acylate Resin

### (1-1) Synthesis of Cellulose Acetate Propionate (CAP)

150 parts by weight of cellulose (hardwood pulp) and 75 parts by weight of acetic acid were added to a reaction vessel equipped with a reflux device and the mixture was fiercely stirred for 2 hours while the vessel was heated at 60° C. The cellulose subjected to the pre-treatment as above was swollen and dissolved to have a fluffy shape. Then, the reaction vessel was left and cooled in an iced water bath at 2° C. for 30 min.

Separately, a mixture of 1,545 parts by weight of a propionic anhydride and 10.5 parts by weight of sulphuric acid was prepared as an acylating agent, and cooled at −30° C. After that, the mixture was added at one time to the reaction vessel in which the cellulose subjected to the pre-treatment was placed. After 30 minutes, exterior temperature was gradually increased in such a manner that interior temperature is adjusted to be 25° C. when 2 hours have passed after adding the acylating agent. The reaction vessel was cooled in the iced water bath at 5° C. in such a manner that the interior temperature is adjusted to be 10° C. when 0.5 hours have passed after adding the acylating agent, and adjusted to be 23° C. when 2 hours have passed after adding the acylating agent. Then, the mixture was stirred again for 3 hours while the interior temperature of the vessel was kept at 23° C. The reaction vessel was cooled in the iced water bath at 5° C., and 120 parts by weight of acetic acid having a water content of 25% by mass cooled at 5° C. was added to the vessel for 1 hour. The interior temperature was increased to 40° C. and the mixture was stirred for 1.5 hours (ripening). After that, a solution in which magnesium acetate tetrahydrate is dissolved by twice as much as sulphuric acid in mol in acetic acid having water content of 50% by mass is added to the reaction vessel, and then the mixture was stirred for 30 min. To the mixture, 1,000 parts by weight of acetic acid having a water content of 25% by mass, 500 parts by weight of acetic acid having a water content of 33% by mass, 1,000 parts by weight of acetic acid having a water content of 50% by mass, and 1,000 parts by weight of water were added in such an order, thereby precipitating cellulose acetate propionate. The obtained precipitate of cellulose acetate propionate was washed with warm water. After washing, the precipitate of cellulose acetate propionate was stirred in 0.005% by mass of calcium hydroxide aqueous solution at 20° C. for 0.5 hours. Subsequently, the precipitate of cellulose acetate propionate was washed again with water till the pH of a washing solution became 7 and vacuum dried at 80° C.

According to NMR and GPC measurement, the obtained cellulose acetate propionate had the acetylation (Ac) degree of 0.45, the propionylation (Pr) degree of 2.33, and the polymerization degree of 190.

### (1-2) Synthesis of Cellulose Acetate Butylate (CAB)

100 parts by weight of cellulose (hardwood pulp) and 135 parts by weight of acetic acid were added to a reaction vessel equipped with a reflux device and the flask was heated at 60° C. and left for 1 hour. After that, the mixture was fiercely stirred for 1 hour while the flask was heated at 60° C. The cellulose subjected to the pre-treatment as above was swollen and dissolved to have a fluffy shape. The reaction vessel was lest in an iced water bath at 5° C. for 1 hour to sufficiently cool the cellulose.

Separately, a mixture of 1,080 parts by weight of a butyric acid anhydride and 10.0 parts by weight of sulphuric acid was prepared as an acylating agent, and cooled at −20° C. After that, the mixture was added at one time to the reaction vessel in which the cellulose subjected to the pre-treatment was placed. After 30 minutes, exterior temperature was gradually increased to 20° C., and the mixture was reacted for 5 hours. The reaction vessel was cooled in the iced water bath at 5° C., and 2,400 parts by weight of acetic acid having a water content of 12.5% by mass cooled at 5° C. was added to the vessel for 1 hour. The interior temperature was increased to 30° C. and the mixture was stirred for 1 hours (ripening). After that, to the reaction vessel, 100 parts by weight of magnesium acetate tetrahydrate aqueous solution (50% by mass) was added and the mixture was stirred for 30 min. To the mixture, 1,000 parts by weight of acetic acid and 2,500 parts by weight of acetic acid having a water content of 50% by mass were gradually added, thereby precipitating cellulose acetate butylate. The obtained precipitate of cellulose acetate butylate was washed with warm water. After washing, the precipitate of cellulose acetate butylate was stirred in 0.005% by mass of calcium hydroxide aqueous solution for 0.5 hours. Subsequently, the precipitate of cellulose acetate butylate was washed again with water till the pH of a washing solution became 7 and dried at 70° C. The obtained cellulose acetate butylate had the acetylation (Ac) degree of 1.2, the butyrylation (Bu) degree of 1.55, and the polymerization degree of 260.

### (1-3) Synthesis of Other Cellulose Acylates

By varying the kinds of the acylating agent, reaction temperature and time, and partial hydrolysis temperature and time, thereby synthesizing cellulose acylate other than CAP and CAB represented in Table 3.

### 2. Producing of Cellulose Acylate Film by Film Melt Forming

### (2-1) Feeding

100 parts by weight of the cellulose acylate was prepared for drying until the amount of water is 0.1% or less by mass, and then below described additives were added.

The amount of additives (% by mass) represents parts by mass for the cellulose acylate 100 parts by mass.

Plasticising agent A: biphenyldiphenylphosphate (3% by mass)

UV absorbents a: 2,4-bis-(n-octylthio)-6-(4-hydroxy-3,5-di-tert-butylanilino)-1,3,5-triazin (0.2% by mass)

UV absorbents b: 2-(2′-hydroxy-3′,5-di-tert-butylphenyl)-5-chrolobenzotriazole (0.2% by mass)

UV absorbents c: 2-(2′-hydroxy-3′,5-di-tert-amylphenyl)-5-chrolobenzotriazole (0.1% by mass)

Particles: silicon dioxide (Aerosil R972V)(0.05% by mass)

Citric acid ethyl ester: 1:1 mixture of monoester and diester (0.2% by mass)

Optical adjuster: selected from following structure (a retardation controlling agent) as described in table 3 and added as the amount described in table 3.

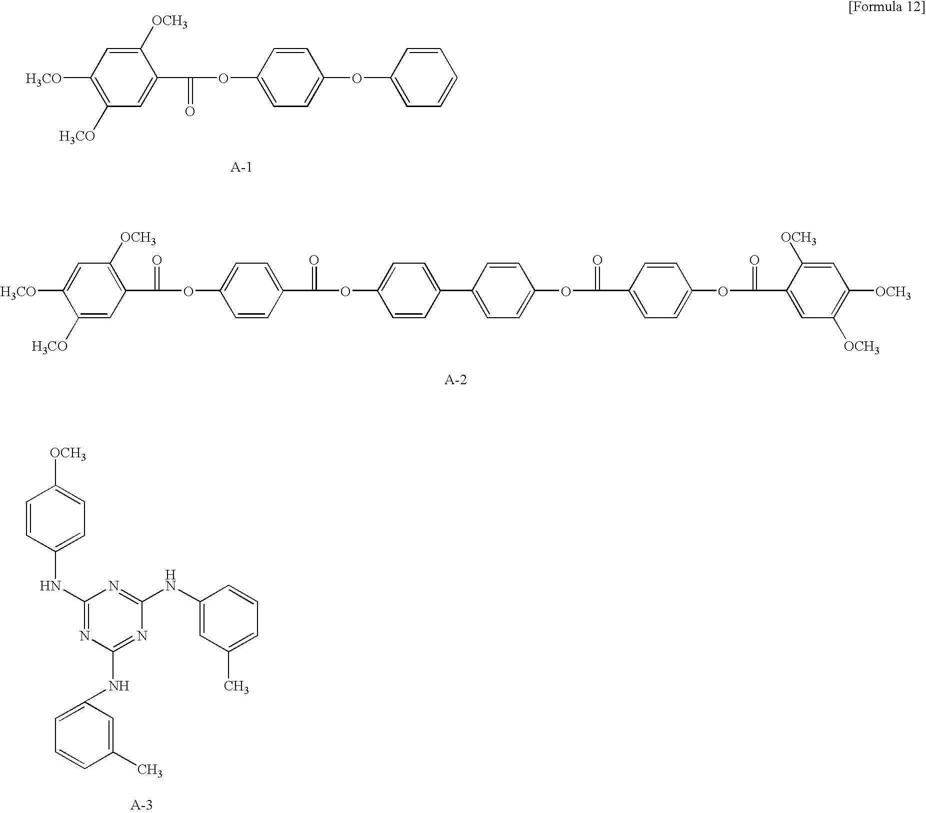

Then these were dissolved in the solvent described in table 3 and such that the quantity of the cellulose acylate becomes 25 mass %. Non-chlorine-based and Chlorine-based described in table 3 as an abbreviation represent below solvent.
Non-chlorine-based: methyl acetate/acetone/methanol/ethanol/buthanol (mass ratio 80/5/7/5/3)
Chlorine-based: dichloromethane/methanol/buthanol (mass ratio 81.4/14.8/3.6)

### (2-2) Swelling and Dissolution

The cellulose acylate, the solvent and the additive agents were fed to the solvent while being agitated. When the feeding is finished, the agitation was stopped and the swelling process was performed for 3 hours at 25° C., thereby preparing a slurry. This is agitated again to completely dissolve the cellulose acylate.

### (2-3) Filtering and Condensation

Thereafter, this was filtered by a filter paper (made by Toyo Roshi Kaisha, LTd., #63) having absolute filtering precision of 0.01 mm and was filtered by a filter paper (made by Poul Co., FH025) of absolute filtering precision of 3 μm.

### (2-4) Film Formation

The obtained dope was casted using the method described in Table 3 (solution banding method or solution drum method) to form the film. The order of the banding method and the drum method is as follows.

### i) Banding Method

Geeser was passed and casted onto a mirror stainless support having a band length of 60 m at 15° C. The geeser similar to that disclosed in Japanese Unexamined Patent Application Publication No. 11-314233 was used. The casting speed was 30 m/min and the casting width was 250 cm.

The both ends of the doped film (web) of the cellulose acylate film material peeled off in a state that the quantity of residual solvent is 100 mass % were inserted into the chucks (tenter clips) and the doped films of the film material inserted into the chucks were carried to the dry zone. In the dry zone having a temperature distribution of 40° C. to 110° C., the film was dried such that the quantity of the residual solvent shown in Table 3 was obtained. The both ends of the obtained film material were trimmed by 3 cm, and knurls having a height of 100 μm were applied to potions spaced apart from the both ends by 2 to 10 mm, and the film was wound in a roll shape by 2000 m.

i) Drum Method

Geeser was passed and casted onto a mirror stainless drum having a diameter of 3 m at −15° C. The geeser similar to that disclosed in Japanese Unexamined Patent Application Publication No. 11-314233 was used. The casting speed was 60 m/min and the casting width was 250 cm.

The both ends of the doped film (web) of the cellulose acylate film material peeled off in a state that the quantity of residual solvent is 200 mass % were inserted into the chucks (tenter clips) and the doped film of the film material inserted into the chucks were carried to the dry zone. In the dry zone having a temperature distribution of 40° C. to 110° C., the film was dried such that the quantity of the residual solvent shown in Table 3 was obtained. The both ends of the obtained film material were trimmed by 3 cm, and knurls having a height of 100 μm were applied to potions spaced apart from the both ends by 2 to 10 mm, and the film was wound in a roll shape by 2000 m.

### 3. Film Melt Forming

### (3-1) Pelletization of Cellulose Acylate

In Example 111 to 124 of the invention and Comparative Example 104 to 107 described in table 3, 100 parts by weight of the cellulose acylate, plasticizer (4 parts by weight of biphenyldiphenylphosphate, 3 parts by weight of glycerin diacetate monoolete), stabilizer (0.1 parts by weight of bis-(2,6-di-tert-butyl-4-methylphenyl)phosphite, 0.1 parts by weight of tris-(2,4-di-tert-butylphenyl)phosphite), 0.05 parts by weight of silicon dioxide particle (Aerosil R972V), and UV absorbents (0.05 parts by weight of 2-(2′-hydroxy-3′,5-di-tert-butylphenyl)-benzotriazole and 0.1 parts by weight of 2,4-hydroxy-4-methoxybenzophenone) were mixed. And an optical adjuster having above mentioned structure (a retardation controlling agent) was added as described in table 3. The mixture was dried at 100° C. for 3 hours to have a water content of 0.1% by mass or less. Then, the mixture was melted at 180° C. by the use of a twin screw kneader, extruded as a strand shape into warm water of 60° C., and cut to mold a cylinder shaped pellet having 3 mm of diameter and 5 mm of length.

In Example 125 to 127 of the invention described in table 3, 100 parts by weight of the cellulose acylate, stabilizer (0.1 parts by weight of bis-(2,6-di-tert-butyl-4-methylphenyl)phosphite, 0.1 parts by weight of tris-(2,4-di-tert-butylphenyl)phosphite), 0.05 parts by weight of silicon dioxide particle (Aerosil R972V) were mixed and pelletized according to the same conditions described above.

### (3-2) Melt-casting Film Formation

A cellulose acylate pellet prepared by the above-described method was dried for 5 hours at 100° C. using dehumidification wind of dew-point temperature −40° C. such that the percentage of water content becomes 0.01 mass % or less. The pellet was input to a hopper of 80° C. and was molten by a melt extruder having a temperature of 180° C. (inlet temperature) and a temperature of 220° C. (outlet temperature). The diameter of the screw used herein was 60 mm, L/D=5°, and a pressure ratio was 4. A predetermined amount of resin extruded from the melt extruder was sent via a gear pump. At this time, the number of rotations of the extruder was changed such that the pressure of the resin before the gear pump is controlled to a predetermined pressure of 10 MPa. The melt resin discharged from the gear pump was filtered using a leaf disc filter having filtering precision of 5 μm and was extruded from a hanger coat die having a temperature of 220° C. and a slit gap of 0.8 mm via a static mixer.

This was solidified by a casting drum of (Tg−10° C.) At this time, electrostatic charges were applied to the both ends by 10 cm using an electrostatic charge applying method (a 10-kV wire is mounted at a place separated from a landing point of the casting drum of the melt by 10 cm). The solidified melt was detached from the casting drum, the both ends thereof were trimmed (5% of the entire width) immediately before winding, and the both ends thereof were subjected to a process (knurling) for adjusting the width to 10 mm and the height to 50 μm, thereby obtaining an undrawn film having a width 1.5 m and a length of 3000 m at 30 m/min.

### 4. Drawing of Cellulose Acylate Film

### (4-1) Drawing and Relaxation

The undrawn cellulose acylate film obtained by the melt-casting film formation method or the solution-casting film formation method was longitudinally and transversely drawn under the condition described in Table 3. The longitudinal drawing was performed at a speed of 20 m/min by performing a preheat process using a preheat roll at a temperature of Tg and applying a circumferential velocity difference to the nip rolls (distance between the nip rolls is 5 cm) at a temperature (Tg+5° C.) in the longitudinal direction (MD). Thereafter, the film was carried to the inlet of the transverse drawing tenter while being cooled by a pass roll and the both ends of the film were inserted into the chucks (tenter clips). The transverse drawing was performed using the drawing tenter with a drawing ratio described in Table 3 at a speed of 20 m/min in a state that the both ends of the cellulose acylate film are gripped by the plural pairs of chucks. Thereafter, the both ends of the film were relaxed with a relaxation ratio described in Table 3 such that the film is reduced in the transverse direction.

The temperature distribution of the longitudinal direction in the drawing tenter was shown in Table 3 and Table 4. The temperature distribution of the transverse direction of each zone was set as shown in Table 3 and Table 4.

### (4-2) Heating Treatment

Subsequently, one side or both sides of the drawn cellulose acylate film was released from the chuck in the tenter having slit devices of the ends of the film or a device for detaching the chuck mounted at the inlet of the heating zone and heat treatment was performed for 1.5 min while the film is carried with carrying tension described in Table 3 at a temperature of (Tg+2° C.). Thereafter, a tension cut process was performed at the winding side and a winding process was performed with high tension of 100 N/m (width) while the temperature gradually decreases to a room temperature. In addition, In Comparative examples 101 to 106, the processes were performed in a state that the chucks are not removed from the both sides of the drawn cellulose acylate film as described in Table 4.

### 5. Evaluation of Drawn Film

The dimension variation ratio, the bowing amount, Re, Rth (average value), and the variations thereof in the MD and TD directions, and the shift of the orientation slow axis in the wet heat and the dry heat of the drawn film were measured and described in Table 3 and Table 4. In the other physical properties of the drawn film which satisfies the condition of the invention, the haze was 0.3% or less and the transparency degree (transparency) was 92.5% or more. In addition, luminescent foreign matters did not occur, die line or step unevenness did not occur in the surface of the film, an in-plane shape was excellent, and excellent characteristics was obtained with respect to the optical use.

Meanwhile, in Comparative examples 101 to 106, a drawn film was produced in the drawing condition having a range different from the range of the invention. That is, the removal of the chuck in the heating zone, the temperature distribution of the transverse direction in the drawing zone, relaxation ratio, and the quantity of the residual solvent before the drawing were changed as shown in Table 3 and Table 4. The physical properties of the film of the comparative examples were measured similar to above and the results were described in Table 3 and Table 4.

TABLE 3
Table 3

| | Cellulous acylate | | | | | | | | | | |
|---|---|---|---|---|---|---|---|---|---|---|---|
| | | Other | | Groups | | | | | | | |
| | | than | Total | other than | | Optical | | Film forming | | Film | |
| | Acetate | Acetate | substitution | Acetate | polimerization | adjuster | | process | | Thickness | Tg |
| | group | group | degree | group | degree | Kind | Amount | Type | solvent | (μm) | (° C.) |
| Example 101 | 1.20 | 1.55 | 2.75 | Butyryl | 260 | A-1 | 2.0 | Solution/ | chlorine | 80 | 117 |
| | | | | | | | | drum | based | | |
| Example 102 | 1.00 | 1.57 | 2.57 | Butyryl | 280 | A-1 | 2.0 | Solution/ | chlorine | 100 | 119 |
| | | | | | | | | banding | based | | |
| Example 103 | 0.80 | 1.85 | 2.65 | Propionyl | 320 | A-1 | 4.0 | Solution/ | chlorine | 95 | 112 |
| | | | | | | | | drum | based | | |
| Example 104 | 2.10 | 0.60 | 2.70 | Propionyl | 246 | A-1 | 6.0 | Solution/ | chlorine | 115 | 127 |
| | | | | | | | | drum | based | | |
| Example 105 | 1.25 | 1.50 | 2.75 | Benzoyl | 230 | A-1 | 1.5 | Solution/ | chlorine | 90 | 113 |
| | | | | | | | | banding | based | | |
| Example 106 | 1.90 | 0.78 | 2.68 | Butyryl | 255 | A-1 | 4.0 | Solution/ | chlorine | 98 | 122 |
| | | | | | | | | banding | based | | |
| Comparative | 1.90 | 0.78 | 2.68 | Butyryl | 255 | A-1 | 4.0 | Solution/ | chlorine | 98 | 122 |
| Example 101 | | | | | | | | banding | based | | |
| Comparative | 1.90 | 0.78 | 2.68 | Butyryl | 255 | A-1 | 4.0 | Solution/ | chlorine | 98 | 122 |
| Example 102 | | | | | | | | banding | based | | |
| Example 107 | 1.12 | 1.74 | 2.86 | Butyryl | 220 | A-3 | 3.0 | Solution/ | non- | 85 | 115 |
| | | | | | | | | banding | chlorine- | | |
| | | | | | | | | | based | | |
| Example 108 | 1.40 | 1.45 | 2.85 | Butyryl | 280 | A-3 | 3.0 | Solution/ | non- | 120 | 121 |
| | | | | | | | | banding | chlorine- | | |
| | | | | | | | | | based | | |
| Example 109 | 0.86 | 1.96 | 2.82 | Propionyl | 265 | A-3 | 3.0 | Solution/ | non- | 80 | 120 |
| | | | | | | | | banding | chlorine- | | |
| | | | | | | | | | based | | |
| Example 110 | 2.00 | 0.80 | 2.80 | Propionyl | 250 | A-3 | 3.0 | Solution/ | chlorine | 110 | 128 |
| | | | | | | | | banding | based | | |
| Comparative | 2.00 | 0.80 | 2.80 | Propionyl | 250 | A-3 | 3.0 | Solution/ | chlorine | 110 | 128 |
| Example 103 | | | | | | | | banding | based | | |
| Example 111 | 0.10 | 2.75 | 2.85 | Propionyl | 180 | A-2 | 1.0 | Melt | / | 100 | 103 |
| Example 112 | 0.15 | 2.67 | 2.82 | Propionyl | 220 | A-2 | 1.0 | Melt | / | 95 | 105 |
| Example 113 | 0.28 | 2.45 | 2.73 | Propionyl | 210 | A-2 | 1.0 | Melt | / | 150 | 107 |
| Example 114 | 0.45 | 2.33 | 2.78 | Propionyl | 190 | A-2 | 1.0 | Melt | / | 120 | 110 |
| Example 115 | 0.75 | 2.08 | 2.83 | Propionyl | 190 | A-2 | 1.0 | Melt | / | 95 | 114 |
| Example 116 | 1.10 | 1.75 | 2.85 | Propionyl | 170 | A-2 | 1.0 | Melt | / | 118 | 117 |
| Comparative | 1.10 | 1.75 | 2.85 | Propionyl | 170 | A-2 | 1.0 | Melt | / | 118 | 117 |
| Example 104 | | | | | | | | | | | |
| Comparative | 1.10 | 1.75 | 2.85 | Propionyl | 170 | A-2 | 1.0 | Melt | / | 118 | 117 |
| Example 105 | | | | | | | | | | | |
| Example 117 | 1.50 | 1.41 | 2.91 | Propionyl | 160 | A-1 | 2.5 | Melt | / | 150 | 116 |
| Example 118 | 0.80 | 2.04 | 2.84 | Propionyl | 170 | A-1 | 2.5 | Melt | / | 90 | 112 |
| Example 119 | 1.00 | 1.78 | 2.78 | Propionyl | 150 | A-1 | 2.5 | Melt | / | 85 | 115 |
| Example 120 | 0.70 | 2.10 | 2.80 | Propionyl | 165 | A-1 | 2.5 | Melt | / | 90 | 113 |
| Example 121 | 1.00 | 1.65 | 2.65 | Butyryl | 180 | A-1 | 2.5 | Melt | / | 180 | 103 |
| Example 122 | 1.70 | 1.15 | 2.85 | Butyryl | 150 | A-1 | 2.5 | Melt | / | 230 | 109 |
| Example 123 | 1.20 | 1.70 | 2.90 | Butyryl | 160 | A-1 | 2.5 | Melt | / | 155 | 104 |
| Example 124 | 1.20 | 1.70 | 2.90 | Butyryl | 160 | A-1 | 2.5 | Melt | / | 155 | 104 |
| Comparative | 1.20 | 1.70 | 2.90 | Butyryl | 160 | A-1 | 2.5 | Melt | / | 155 | 104 |
| Example 106 | | | | | | | | | | | |
| Comparative | 2.55 | 0.25 | 2.80 | Butyryl | 165 | A-1 | 2.5 | Melt | / | Physical properties | |
| Example 107 | | | | | | | | | | were not | |
| | | | | | | | | | | evaluated due | |
| | | | | | | | | | | to unsuccessful | |
| | | | | | | | | | | melt-casting | |
| | | | | | | | | | | film formation | |
| Example 125 | 1.00 | 1.75 | 2.75 | Butyryl | 160 | No | 0 | Melt | / | 95 | 135 |
| Example 126 | 0.18 | 2.60 | 2.78 | Propionyl | 155 | No | 0 | Melt | / | 90 | 133 |
| Example 127 | 0.42 | 2.41 | 2.83 | Propionyl | 145 | No | 0 | Melt | / | 85 | 140 |

| | | | | | Temperature distribution in the tenter for TD stretching | | | |
|---|---|---|---|---|---|---|---|---|
| | Before | | | | | | | TD direction |
| | drawing | MD | TD drawing | | | | | temperature |
| | Amount of | drawing | | Relaxation | Temperature | Temperature | Temperature | difference of |
| | residual | MD | TD | ratio(to TD | of preheat | of stretching | of relaxation | each zone |
| | solvent | ratio | ratio | ratio) | zone (to Tg) | zone (to Tg) | zone (to Tg) | Ts − Tc |
| | (mass %) | (%) | (%) | (%) | (° C.) | (° C.) | (° C.) | (° C.) |
| Example 101 | 0.2 | 0 | 25 | 5 | Tg + 5 | Tg + 15 | Tg + 10 | 3 |
| Example 102 | 0.2 | 5 | 35 | 5 | Tg + 5 | Tg + 15 | Tg + 10 | 3 |
| Example 103 | 0.3 | 5 | 35 | 3 | Tg + 15 | Tg + 10 | Tg | 2 |
| Example 104 | 0.7 | 5 | 35 | 3 | Tg + 10 | Tg + 15 | Tg + 10 | 2 |
| Example 105 | 0.1 | 0 | 30 | 3 | Tg + 5 | Tg + 15 | Tg + 10 | 3 |
| Example 106 | 0.3 | 0 | 30 | 3 | Tg + 5 | Tg + 15 | Tg + 10 | 3 |
| Comparative | 0.3 | 0 | 30 | 3 | Tg + 5 | Tg + 15 | Tg + 10 | 3 |
| Example 101 | | | | | | | | |
| Comparative | 0.3 | 0 | 30 | 0 | Tg + 5 | Tg + 15 | Tg + 10 | 3 |
| Example 102 | | | | | | | | |
| Example 107 | 0.2 | 5 | 35 | 3 | Tg + 6 | Tg + 15 | Tg + 5 | 3 |
| Example 108 | 0.3 | 10 | 45 | 3 | Tg − 10 | Tg + 20 | Tg + 20 | 3 |
| Example 109 | 0.6 | 0 | 25 | 3 | Tg + 10 | Tg + 5 | Tg − 5 | 0 |
| Example 110 | 0.8 | 5 | 35 | 3 | Tg − 5 | Tg + 20 | Tg + 12 | 2 |
| Comparative | 3.5 | 5 | 35 | 3 | Tg − 5 | Tg + 20 | Tg + 12 | 2 |
| Example 103 | | | | | | | | |
| Example 111 | 0 | 5 | 50 | 6 | Tg − 5 | Tg + 10 | Tg | 3 |
| Example 112 | 0 | 5 | 35 | 6 | Tg + 15 | Tg + 5 | Tg | 2 |
| Example 113 | 0 | 10 | 70 | 10 | Tg | Tg + 15 | Tg + 8 | 5 |
| Example 114 | 0 | 10 | 70 | 10 | Tg + 3 | Tg + 15 | Tg + 8 | 1 |
| Example 115 | 0 | 0 | 50 | 5 | Tg − 10 | Tg + 15 | Tg + 8 | 3 |
| Example 116 | 0 | 0 | 45 | 3 | Tg + 5 | Tg + 12 | Tg + 7 | 3 |
| Comparative | 0 | 0 | 45 | 3 | Tg + 5 | Tg + 12 | Tg + 7 | 3 |
| Example 104 | | | | | | | | |
| Comparative | 0 | 0 | 45 | 3 | Tg + 5 | Tg + 12 | Tg + 7 | −2 |
| Example 105 | | | | | | | | |
| Example 117 | 0 | 30 | 50 | 2 | Tg − 5 | Tg + 15 | Tg + 5 | 3 |
| Example 118 | 0 | 5 | 35 | 6 | Tg | Tg + 10 | Tg + 2 | 3 |
| Example 119 | 0 | 0 | 30 | 3 | Tg | Tg + 10 | Tg + 2 | 3 |
| Example 120 | 0 | 0 | 40 | 3 | Tg | Tg + 15 | Tg + 10 | 3 |
| Example 121 | 0 | 18 | 120 | 15 | Tg − 5 | Tg + 15 | Tg + 10 | 2 |
| Example 122 | 0 | 5 | 210 | 30 | Tg + 25 | Tg + 15 | Tg + 10 | 2 |
| Example 123 | 0 | 15 | 80 | 5 | Tg − 5 | Tg + 15 | Tg + 5 | 3 |
| Example 124 | 0 | 15 | 80 | 5 | Tg − 25 | Tg + 15 | Tg + 5 | 3 |
| Comparative | 0 | 15 | 80 | 5 | Tg − 5 | Tg + 15 | Tg + 15 | 3 |
| Example 106 | | | | | | | | |
| Comparative | Physical properties were not evaluated due to unsuccessful melt-casting film formation | | | | | | | |
| Example 107 | | | | | | | | |
| Example 125 | 0 | 5 | 35 | 5 | Tg | Tg + 10 | Tg + 2 | 3 |
| Example 126 | 0 | 5 | 35 | 5 | Tg | Tg + 10 | Tg + 2 | 3 |
| Example 127 | 0 | 5 | 35 | 5 | Tg | Tg + 10 | Tg + 2 | 3 |

TABLE 4
Table 4

| Condition of heat | | | | | | | | | | | |
|---|---|---|---|---|---|---|---|---|---|---|---|
| treatment | | | | | | | | | | | |
| Removal of the | | | Dimensional valuation of drawn film | | | Optical property valuation of drawn film | | | | | |
| binding force | | Thickness of drawn | Dry heat | Wet heat | | | | Slow | | Shift of | |
| of the chucks | Carrying | film | tratment | treatment | Warpage | Re | Rth | axis | Bowing | the slow | Composition |

| | (one side/both | tension | Average | Unevenness | MD | TD | MD | TD | (maximum value) | Average | Variation | Average | Variation | angle | ratio | axis | of polarizing | Display |
|---|---|---|---|---|---|---|---|---|---|---|---|---|---|---|---|---|---|---|
| | sides) | (N/m) | (μm) | (μm) | (%) | (%) | (%) | (%) | (mm) | (nm) | (nm) | (nm) | (nm) | (°) | (%) | (°) | plate | unevenness |
| Example 101 | Removed/ | 8 | 68 | 0 | −0.03 | −0.03 | −0.04 | −0.05 | 1.2 | 61 | 1 | 180 | 1 | 90 | 0 | 0 | A | ◯ |
| | one side | | | | | | | | | | | | | | | | | |
| Example 102 | Removed/ | 30 | 76 | 0 | −0.05 | −0.08 | −0.06 | −0.08 | 1.5 | 62 | 3 | 197 | 3 | 89.9 | −0.2 | 0.3 | A | ◯ |
| | one side | | | | | | | | | | | | | | | | | |
| Example 103 | Removed/ | 65 | 70 | 0 | −0.01 | −0.05 | −0.08 | −0.1 | 0.7 | 83 | 2 | 205 | 4 | 90.1 | 0.9 | −0.4 | A | Δ |
| | both sides | | | | | | | | | | | | | | | | | |
| Example 104 | Removed/ | 40 | 83 | 0 | 0 | 0.02 | −0.02 | 0.03 | 0 | 90 | 2 | 201 | 3 | 89.9 | −0.3 | 0.3 | A | ◯ |
| | both side | | | | | | | | | | | | | | | | | |
| Example 105 | Removed/ | 18 | 70 | 1 | −0.06 | −0.08 | −0.04 | −0.07 | 1.5 | 64 | 2 | 166 | 3 | 90 | −0.5 | 0.2 | A | ◯ |
| | both sides | | | | | | | | | | | | | | | | | |
| Example 106 | Removed/ | 33 | 75 | 0 | −0.03 | −0.04 | −0.02 | −0.05 | 0.2 | 75 | 3 | 196 | 1 | 90 | −0.4 | 0.1 | A | ◯ |
| | one side | | | | | | | | | | | | | | | | | |
| Comparative | Not removed | 90 | 75 | 1 | −0.21 | −0.35 | −0.21 | −0.42 | 4.5 | 79 | 8 | 202 | 11 | 90 | −0.6 | 0.4 | A | X |
| Example 101 | | | | | | | | | | | | | | | | | | |
| Comparative | Not removed | 90 | 77 | 1 | −0.32 | −0.48 | −0.37 | −0.57 | 5.2 | 82 | 8 | 212 | 23 | 89.4 | −2.3 | 1.5 | A | X |
| Example 102 | | | | | | | | | | | | | | | | | | |
| Example 107 | Removed/ | 15 | 63 | 0 | −0.06 | −0.03 | −0.08 | −0.10 | 1.2 | 66 | 0 | 194 | 1 | 89.9 | −0.2 | 0.1 | B | ◯ |
| | both sides | | | | | | | | | | | | | | | | | |
| Example 108 | Removed/ | 15 | 77 | 0 | −0.04 | −0.08 | −0.05 | −0.07 | 0.9 | 73 | 2 | 226 | 3 | 90 | −0.1 | 0.2 | B | ◯ |
| | both sides | | | | | | | | | | | | | | | | | |
| Example 109 | Removed/ | 15 | 64 | 0 | −0.03 | 0.06 | −0.03 | −0.04 | 0.4 | 60 | 5 | 192 | 10 | 89.5 | 1.0 | 0.5 | B | Δ |
| | both sides | | | | | | | | | | | | | | | | | |
| Example 110 | Removed/ | 15 | 78 | 1 | −0.02 | −0.03 | −0.01 | −0.04 | 0 | 77 | 1 | 209 | 4 | 90 | −0.3 | 0.1 | B | ◯ |
| | both sides | | | | | | | | | | | | | | | | | |
| Comparative | Not removed | 80 | 80 | 2 | −0.23 | −0.34 | −0.28 | −0.46 | 3.1 | 78 | 12 | 215 | 17 | 89.4 | −1.6 | 1.4 | B | X |
| Example 103 | | | | | | | | | | | | | | | | | | |
| Example 111 | Removed/ | 10 | 67 | 1 | −0.03 | −0.05 | −0.05 | −0.08 | 0.7 | 75 | 0 | 210 | 1 | 89.9 | 0.3 | 0.3 | B | ◯ |
| | both sides | | | | | | | | | | | | | | | | | |
| Example 112 | Removed/ | 20 | 72 | 1 | 0.01 | 0.03 | 0.02 | 0.04 | 0.4 | 65 | 0 | 193 | 2 | 90 | 0.2 | 0.2 | B | ◯ |
| | both sides | | | | | | | | | | | | | | | | | |
| Example 113 | Removed/ | 15 | 84 | 0 | −0.06 | −0.09 | −0.07 | −0.10 | 0.5 | 90 | 0 | 220 | 3 | 90.2 | −0.2 | 0.2 | B | ◯ |
| | one side | | | | | | | | | | | | | | | | | |
| Example 114 | Removed/ | 15 | 68 | 1 | −0.05 | −0.08 | −0.07 | −0.09 | 0.4 | 94 | 2 | 232 | 3 | 90 | −0.3 | −0.3 | B | ◯ |
| | one side | | | | | | | | | | | | | | | | | |
| Example 115 | Removed/ | 15 | 66 | 1 | −0.03 | −0.06 | −0.04 | −0.05 | 0.4 | 60 | 3 | 190 | 5 | 90 | −0.4 | 0.3 | B | ◯ |
| | one side | | | | | | | | | | | | | | | | | |
| Example 116 | Removed/ | 50 | 82 | 0 | −0.02 | 0.02 | −0.05 | 0.03 | 0.4 | 80 | 2 | 202 | 3 | 89.9 | −0.3 | 0.3 | B | ◯ |
| | both sides | | | | | | | | | | | | | | | | | |
| Comparative | Not removed | 100 | 81 | 1 | −0.21 | −0.34 | −0.21 | −0.46 | 3.5 | 85 | 8 | 210 | 13 | 90 | −0.6 | 0.4 | B | X |
| Example 104 | | | | | | | | | | | | | | | | | | |
| Comparative | Not removed | 100 | 82 | 2 | −0.22 | −0.39 | −0.24 | −0.51 | 3.5 | 88 | 12 | 222 | 21 | 89.2 | −1.9 | −1.6 | B | X |
| Example 105 | | | | | | | | | | | | | | | | | | |

| Condition of heat | | | | | |
|---|---|---|---|---|---|
| treatment | | | | | |
| Removal of the | | | Optical property valuation of drawn film | | |
| binding force | Thickness of drawn | Dimensional valuation of drawn film | | Slow | Shift of |

| | | | | | | | | | | | |
|---|---|---|---|---|---|---|---|---|---|---|---|
| of the chucks | Carrying | film | Dry heet | Wet heet | 3Warpage | Re | Rth | axis | Bowing | the slow | Composition |

| | (one side/both | tension | Average | Unevenness | MD | TD | MD | TD | (maximum value) | Average | Variation | Average | Variation | angle | ratio | axis | of polarizing | Display |
|---|---|---|---|---|---|---|---|---|---|---|---|---|---|---|---|---|---|---|
| | sides) | (N/m) | (μm) | (μm) | (%) | (%) | (%) | (%) | (mm) | (nm) | (nm) | (nm) | (nm) | (°) | (%) | (°) | plate | unevenness |
| Example 117 | Removed/ | 5 | 79 | | −0.03 | −0.05 | −0.05 | −0.08 | 0 | 58 | 3 | 200 | 1 | 89.9 | 0.2 | −0.3 | A | ◯ |
| | one side | | | | | | | | | | | | | | | | | |
| Example 118 | Removed/ | 20 | 68 | 0 | −0.04 | −0.07 | −0.07 | −0.10 | 0.1 | 74 | 1 | 195 | 3 | 90 | 0.1 | 0.2 | A | ◯ |
| | one side | | | | | | | | | | | | | | | | | |
| Example 119 | Removed/ | 20 | 66 | 1 | 0 | −0.02 | −0.01 | −0.03 | 0.3 | 72 | 2 | 190 | 5 | 90.1 | 0 | 0 | A | ◯ |
| | one side | | | | | | | | | | | | | | | | | |
| Example 120 | Removed/ | 20 | 65 | 0 | −0.04 | −0.08 | −0.08 | −0.09 | 0.4 | 83 | 1 | 203 | 4 | 90 | −0.2 | −0.3 | A | ◯ |
| | one side | | | | | | | | | | | | | | | | | |
| Example 121 | Removed/ | 30 | 76 | 1 | −0.07 | −0.08 | −0.07 | −0.10 | 1.4 | 129 | 4 | 269 | 6 | 89.9 | −0.6 | 0.4 | A | Δ |
| | both sides | | | | | | | | | | | | | | | | | |
| Example 122 | Removed/ | 15 | 85 | 2 | 0 | 0.03 | 0.02 | 0.04 | 0.3 | 165 | 2 | 367 | 5 | 89.8 | −0.4 | 0.4 | A | ◯ |
| | both sides | | | | | | | | | | | | | | | | | |
| Example 123 | Removed/ | 30 | 78 | 2 | −0.08 | −0.10 | −0.08 | −0.10 | 1.8 | 90 | 4 | 210 | 9 | 90.2 | −0.7 | −0.4 | A | Δ |
| | both sides | | | | | | | | | | | | | | | | | |
| Example 124 | Removed/ | 30 | 78 | 1 | −0.01 | −0.03 | −0.03 | −0.06 | 0.4 | 95 | 3 | 228 | 4 | 90 | −0.2 | 0.2 | A | ◯ |
| | both sides | | | | | | | | | | | | | | | | | |
| Comparative | Not removed | 85 | 78 | 1 | −0.18 | −0.31 | −0.22 | −0.49 | 2.4 | 88 | 6 | 205 | 16 | 89.4 | −1.5 | 1.2 | A | X |
| Example 106 | | | | | | | | | | | | | | | | | | |

| Comparative | Physical properties were not evaluated due to unsuccessful melt-casting film formation | | | | | | | | | | | | | | | | | |
|---|---|---|---|---|---|---|---|---|---|---|---|---|---|---|---|---|---|---|
| Example 107 | | | | | | | | | | | | | | | | | | |
| Example 125 | Removed/ | 20 | 70 | 2 | −0.08 | −0.09 | −0.05 | −0.09 | 1.1 | 33 | 2 | 135 | 4 | 89.8 | −0.5 | −0.5 | A | Δ |
| | one side | | | | | | | | | | | | | | | | | |
| Example 126 | Removed/ | 20 | 67 | 2 | −0.07 | −0.10 | −0.06 | −0.08 | 0.9 | 36 | 2 | 140 | 4 | 89.9 | −0.4 | 0.6 | A | Δ |
| | one side | | | | | | | | | | | | | | | | | |
| Example 127 | Removed/ | 20 | 64 | 1 | −0.07 | −0.09 | −0.05 | −0.07 | 0.9 | 30 | 1 | 130 | 3 | 89.8 | −0.6 | 0.6 | A | Δ |
| | one side | | | | | | | | | | | | | | | | | |

As can be seen from the result of Table 3, the films of Embodiments 101 to 127 of the invention have an excellent dimension stability, small panel warpage, a small variation of Re and Rth in the longitudinal direction and the transverse direction, a small bowing ratio, the slight shift of orientation slow axis, low retardation variation unevenness, and the slight shift of the orientation axis. In addition, the color unevenness hardly occurred in the light leakage and viewability in the black display when being assembled into a liquid crystal display device.

Meanwhile, the films of Comparative examples 101 to 106 produced by the condition having a range different from the range of the invention have the dimension variation in the wet heat and the dry heat, the panel warpage is large, the retardation variation, the shift of the orientation slow axis in the longitudinal direction and the transverse direction and the bowing ratio are large, and the display unevenness and light leakage when being assembled into a liquid crystal display device are bad.

### 6. Application of Cellulose Acylate Film

### (6-1) Production of Polarizing Plate

### (6-1-1) Surface Treatment

The stretched cellulose acylate film was saponified by the dip saponification method. 2.5 mol/L aqueous solution of KOH which adjusted to a temperature of 60° C. was used as a saponifying solution. The cellulose acylate film was dipped therein for 2 minutes. Thereafter, the film was dipped in 0.05 mol/L aqueous solution of sulfuric acid for 30 seconds, and passed through a water-washing bath.

The film was also saponified by coating method. However, the result was the same as that from saponification by dipping. By coating method, 20 parts by mass of water was added to 80 parts by mass of isopropyl alcohol, and KOH was dissolved therein so that its concentration became 1.5 mol/L. This solution was adjusted to a temperature of 60° C. to use as a saponifying solution. This solution was coated on a cellulose acylate film of 60° C. in an amount of 10 g/m², and saponification was conducted for one minute. Then, warm water of 50° C. was sprayed thereover for 1 minute in an amount of 10 l/m² per minute to conduct washing.

### (6-1-2) Preparation of Polarizer Film

A circumferential velocity difference was applied to two pairs of nip rolls according to Embodiment 1 of Japanese Unexamined Patent Application Publication No. 2001-141926, and the drawing was performed in the longitudinal direction, thereby preparing a polarizing plate having a thickness of 20 μm.

### (6-1-3) Lamination

The polarizer thus obtained in (6-1-2), the cellulose acylate films saponification-treated by (6-1-1) and the saponification-treated unstretched triacetate film (FUJITAC; manufactured by Fuji Photo Film Co., Ltd.) were laminated so that they were formed in the below combinations to obtain polarizing plate A and B by using a 3% aqueous solution of PVA (PVA-117H; manufactured by Kuraray CO., LTD.) as an adhesive. When they were laminating, they were laminated as the stretched direction of polarizer film and the cellulose acylate film forming direction (longitudinal direction) were the same direction. In polarizing plate B, non-stretched cellulose acylate films were the one which above stretched cellulose acylate films were used before they stretched.

Polarizing Plate A: Stretched cellulose acylate film/polarizer/FUJITAC

Polarizing Plate B: Stretched cellulose acylate film/polarizer/non-stretched cellulose acylate film

The warpage of the polarizing plate produced by each stretched cellulose acylate film were measured and the results were described in table 4.

### (6-2) Preparation of Liquid Crystal Display Device

A fresh product of the obtained polarizing plate and a polarizing plate after a wet heat thermal process (60° C., a relative humidity of 90%, 500 hours) or a dry heat thermal process (80° C., a dry state, 500 hours) were mounted on liquid crystal display devices (made by Sharp Corporation) having a size of 20 inches and 40 inches such that the drawn cellulose acylate is placed at a liquid crystal side, on the basis of the method described in FIGS. 2 to 9 of Japanese Unexamined Patent Application Publication No. 2000-154261. This was compared with the polarizing plate subjected to the wet heat thermal process or the polarizing plate subjected to the dry heat thermal process, and light leakage, color unevenness, in-plane viewing uniformity generated in the VA liquid crystal device having a black display state were evaluated by naked eyes. In the invention, the color unevenness did not occur and viewing uniformity was excellent. According to Embodiment 1 of Japanese Unexamined Patent Application Publication No. 2002-86554, a polarizing plate which was drawn using the tenter such that the drawing axis is inclined by an angle of 45° was tested and a good result was obtained in the device using the cellulose acylate film of the invention, substantially the same as described above.

In contrast, in the liquid crystal display devices using the films of the Comparative examples 101 to 106 having a range different from the range of the invention, the color unevenness occurred, the optical characteristics deteriorated, and the viewing uniformity deteriorated.

### (6-3) Preparation of Optical Compensatory Film

Instead of the cellulose acetate film coated with a liquid crystal layer of Embodiment 1 of Japanese Unexamined Patent Application Publication No. 11-316378, an optical compensatory film was prepared using the drawn cellulose acylate film of the invention. At this time, an optical compensatory film prepared using the drawn cellulose acylate film (fresh product) immediately after forming and drawing the film and an optical compensatory film prepared using the drawn cellulose acylate film which is subjected to a wet heat thermal process (60° C., a relative humidity of 90%, 500 hours) or a dry heat thermal process (80° C., a dry state, 500 hours) were compared and regions in which the color unevenness occurs were evaluated by naked eyes. Good optical capabilities were obtained in the optical compensatory films using the drawn cellulose acylate film of the invention.

The optical compensatory film produced using the drawn cellulose acylate film of the invention instead of the cellulose acetate film coated with a liquid crystal layer of Embodiment 1 of Japanese Unexamined Patent Application Publication No. 7-333433 has good optical capabilities.

(6-4) Preparation of low reflective film

Low reflective films were prepared by using the cellulose acylate films of the present invention according to Kokai Gifo of Japan Institute of Invention & Innovation, Kogi No. 2001-1745, Example 47. As a result, superior optical performance could be obtained.

### 7. Melt-Casting Film Formation Using Touch Roll Method

In Embodiment 112, Embodiment 113, Embodiment 121, and Embodiments 125 to 127 of the invention, the films were formed using the touch roll (described as the double pressing roll) described in Embodiment 1 of Japanese Unexamined Patent Application Publication No. 11-235747 (but, the thickness of the thin outer metal tube was 3 mm) under the condition described in Table 5 (under the same conditions except that the film is formed using the touch roll).

The in-plane shape (thickness variation and fine irregularities) of the drawn cellulose acylate film obtained by the same drawing condition was measured by the following method.

### (Measurement of Thickness Variation)

A film was sampled over the entire width of the cellulose acylate film with a width of 35 mm (TD sample). A widthwise central portion was sampled with a width of 35 mm and a length of 2 m (MD sample). The TD sample and the MD sample were measured using a sequencing film thickness tester (FILM THICKNESS TESTER Kg601A, ANRITSU (made by Anritsu Co., Ltd.) and an average of (maximum value-average value) and (average value−minimum vale) was set to the thickness variation.

### (Measurement of Fine Irregularities (Die Line))

The cellulose acylate film was measured using a three-dimensional surface structure analysis microscope (made by Zygo Corporation, New View 5022) under the following condition:

Objective lens: 2.5 times;

Image zoom: one times; and

Measured view: transverse direction (TD) 2.8 mm and longitudinal direction (MD) 2.1 mm.

Among them, the number of mountain parts (convex part) having a height of 0.01 μm to 30 μm and the number of valley parts (concave part) having a depth of 0.01 μm to 30 μm are counted. Here, the convex part and the concave part have a length of 1 mm or more in the MD direction. The numbers of the convex parts and the concave parts are divided by a measured width (2.8 mm) and are multiplied by 100, thereby obtaining the numbers of the convex parts and the concave parts per 10 cm. The numbers of the convex parts and the concave parts were measured at 30 points at a constant interval over the entire width of the sample film and were averaged, thereby obtaining the numbers of the convex parts and the concave parts per width of 10 cm

TABLE 5
Table 5

| | | | Propeties of drawn film | | | | | | |
|---|---|---|---|---|---|---|---|---|---|
| | | | Thickness | | | | | | |
| | | | unevenness | | The | | | | |
| | Touch roll film formation | | (μm) | | numbers | | | | |
| | linear pressure | Temperature | longitudinal | Transverse | of fine | Re | | Rth | |
| | of touch roll | of touch roll | direction | direction | irregularities | Average | Variation | Average | Variation |
| | (kg/cm) | (° C.) | MD | TD | (/10 cm) | (nm) | (nm) | (nm) | (nm) |
| Example 112 | No touch roll | / | 1.1 | 1.3 | 3 | 65 | 0 | 193 | 2 |
| Example 112-t | 10 | 100 | 0.6 | 0.8 | 0 | 80 | 0 | 221 | 0 |
| Example 113 | No touch roll | / | 0.3 | 0.4 | 4 | 90 | 0 | 220 | 3 |
| Example 113-t | 3 | 105 | 0.1 | 0.0 | 0 | 94 | 0 | 253 | 0 |
| Example 121 | No touch roll | / | 1.2 | 1.4 | 3 | 129 | 4 | 269 | 6 |
| Example 121-t | 15 | 100 | 1.0 | 1.3 | 0 | 220 | 0 | 311 | 1 |
| Example 125 | No touch roll | / | 1.7 | 2.1 | 5 | 33 | 2 | 135 | 4 |
| Example 125-t | 50 | 120 | 1.1 | 1.5 | 1 | 44 | 0 | 164 | 1 |
| Example 126 | No touch roll | / | 1.6 | 2.1 | 4 | 36 | 2 | 140 | 4 |
| Example 126-t | 8 | 120 | 1.0 | 1.3 | 0 | 38 | 0 | 158 | 0 |
| Example 127 | No touch roll | / | 0.9 | 1.2 | 4 | 30 | 1 | 130 | 4 |
| Example 127-t | 5 | 125 | 0.5 | 0.7 | 0 | 41 | 0 | 153 | 0 |

| | Propeties of drawn film | | | | Display | Display | |
|---|---|---|---|---|---|---|---|
| | Dimensional | | | | unevenness | unevenness | |
| | valuation after wet | | Warpage | Shift of | (constant | (constant | |
| | heat treatment | | (maximum | the slow | temperature | temperature | |
| | MD | TD | value) | axis | and shifting | and changed | |
| | (%) | (%) | (mm) | (°) | humidity) | humidity) | Refernce |
| Example 112 | 0.01 | 0.03 | 0.4 | 0.2 | ◯ | Δ | The same as Example |
| | | | | | | | 112 in Tables 3 to 5 |
| Example 112-t | 0.01 | 0.01 | 0.1 | 0.0 | ◯ | ◯ | Touch roll film forming |
| | | | | | | | method was used |
| Example 113 | −0.06 | −0.09 | 0.5 | 0.2 | ◯ | Δ | The same as Example |
| | | | | | | | 113 in Tables 3 to 5 |
| Example 113-t | −0.01 | 0.04 | 0.2 | 0.1 | ◯ | ◯ | Touch roll film forming |
| | | | | | | | method was used |
| Example 121 | −0.07 | −0.08 | 1.4 | 0.4 | Δ | Δ | The same as Example |
| | | | | | | | 121 in Tables 3 to 5 |
| Example 121-t | −0.02 | −0.04 | 0.7 | 0.1 | ◯ | ◯ | Touch roll film forming |
| | | | | | | | method was used |
| Example 125 | −0.08 | −0.09 | 1.1 | −0.5 | Δ | Δ | The same as Example |
| | | | | | | | 125 in Tables 3 to 5 |
| Example 125-t | −0.03 | −0.04 | 0.6 | −0.2 | ◯ | ◯ | Touch roll film forming |
| | | | | | | | method was used |
| Example 126 | −0.07 | −0.10 | 0.9 | 0.6 | Δ | Δ | The same as Example |
| | | | | | | | 126 in Tables 3 to 5 |
| Example 126-t | −0.03 | −0.05 | 0.4 | 0.2 | ◯ | ◯ | Touch roll film forming |
| | | | | | | | method was used |
| Example 127 | −0.07 | −0.09 | 0.9 | 0.6 | Δ | Δ | The same as Example |
| | | | | | | | 127 in Tables 3 to 5 |
| Example 127-t | −0.03 | −0.04 | 0.4 | 0.1 | ◯ | ◯ | Touch roll film forming |
| | | | | | | | method was used |

As shown in Table 5, it was confirmed that the fine irregularities (die line) formed and the thickness variation are furthermore better when the film is molten and formed using the touch roll method. The retardation (Re and Rth) variation, the axis shift and the dimension variation ratio of the film formed using the touch roll method were reduced and the display unevenness was good when the film was mounted on the liquid crystal display device at a constant temperature and a constant humidity, similar to the above embodiments. In the evaluation method of emphasizing the display unevenness, the panel was evaluated by changing from a temperature of 25° C. and a relative humidity of 80% to a temperature of 25° C. and a relative humidity of 10%. As the evaluated result, the display unevenness of the film which is molten and formed using the touch roll method was further improved.

The film was formed using the touch roll (cooling water used in an outer metal tube is changed to oil having a temperature of 18° C. to 120° C.) similar to a first embodiment of PCT Publication 97/28950 (described as a sheet molding roll) and the touch roll method was performed under the condition described in Table 5. In this case, the result described in Table 5 was obtained.

### INDUSTRIAL APPLICABILITY

A cellulose acylate film according to the invention can suppress color unevenness when being assembled into a liquid crystal display device and placed at a high temperature and high humidity. According to the invention, it is possible to provide a cellulose acylate film having a small dimension variation in wet heat and dry heat processes, the uniform physical property in the longitudinal direction and the transverse direction, the slight shift of a slow axis of the transverse direction, and small variations in retardations Re and Rth. In a production method according to the invention, it is possible to efficiently produce a cellulose acylate film having such properties. A polarizing plate, an optical compensatory film, a retardation film, a anti-reflection film, and a liquid crystal display device according to the invention have excellent functions even at a high temperature and high humidity. Accordingly, the invention is available industrially.

1-35. (canceled)

36. A method for producing a cellulose acylate film, which comprises:
longitudinally drawing a cellulose acylate film by 1% to 300% under the condition that a length/width ratio (L/W) which is a ratio of a drawing length L to a width W of the film before drawing is greater than 0.01 and less than 0.3, and longitudinally relaxing the cellulose acylate film by 1% to 50%.

37. The method for producing a cellulose acylate film according to claim 36, wherein the longitudinal drawing is performed by passing the cellulose acylate film obliquely between two pairs of nip rolls.

38. The method for producing a cellulose acylate film according to claim 36 wherein transverse drawing is performed after the longitudinal relaxation is performed.

39. The method for producing a cellulose acylate film according to claim 34, wherein the transverse drawing is performed using a tenter with a drawing ratio of 1% to 250%.

40. The method for producing a cellulose acylate film according to claim 38, wherein the film is transversely relaxed by 1% to 50% after the transverse drawing is performed.

41. The method for producing a cellulose acylate film according to claim 36, wherein the cellulose acylate film is formed by a melt-casting film formation method and is drawn.

42. The method for producing a cellulose acylate film according to claim 41, wherein the melt-casting film formation method is performed using a touch roll.

43. A cellulose acylate film, wherein a wet heat dimension variation δL(w) and a dry heat dimension variation δL(d) are both in the range of 0% to 0.2%, a wet heat variation δRe(w) and a dry heat variation δRe(d) of an in-plane retardation (Re) are both in the range of 0% to 10%, and a wet heat variation δRth(w) and a dry heat variation δRth(d) of a thickness retardation Rth are both in the range of 0% to 10%.

44. The cellulose acylate film according to claim 43, wherein a fine retardation variation is 0% to 10%.

45. The cellulose acylate film according to claim 43, wherein Re is 0 nm to 300 nm and Rth is 30 nm to 500 nm.

46. The cellulose acylate film according to claim 43, wherein Equations (1-1) and (1-2) below are satisfied:
2.5≦A+B<3.0; and Equation (1-1)
1.25≦B<3 Equation (1-2)
wherein A denotes the substitution degree of an acetyl group and B denotes the sum of the substitution degrees of propionyl group, a butyryl group, a pentanoyl group, and a hexanoyl group.

47. The cellulose acylate film according to claim 43, wherein the quantity of a residual solvent is 0.01 mass % or less.

48. The cellulose acylate film according to claim 43, wherein after the cellulose acylate film is formed, the cellulose acylate film is longitudinally drawn by 1% to 300% under the condition that a length/width ratio (L/W) which is a ratio of a drawing length L to a width W of a film before drawing is greater than 0.01 and less than 0.3 and then is longitudinally relaxed by 1% to 50%.

49. A method for producing a cellulose acylate film, which comprises drawing a cellulose acylate film by passing the cellulose acylate film obliquely between two pairs of nip rolls and relaxing or heating the cellulose acylate film.

50. The method for producing a cellulose acylate film according to claim 49, further comprising:
longitudinally drawing the cellulose acylate film by 1% to 300% under the condition that a length/width ratio (L/A) which is a ratio of a drawing length L to a width W of a film before drawing is greater than 0.01 and less than 0.3; and
longitudinally relaxing the cellulose acylate film by 1% to 50%.

51. The method for producing a cellulose acylate film according to claim 49, wherein transverse drawing is performed after the longitudinal relaxation is performed.

52. The method for producing a cellulose acylate film according to claim 51, wherein the transverse drawing is performed using a tenter with a drawing ratio of 1% to 250%.

53. The method for producing a cellulose acylate film according to claim 51, wherein the film is transversely relaxed by 1% to 50% after the transverse drawing is performed.

54. The method for producing a cellulose acylate film according to claim 49, wherein the cellulose acylate film is formed by a melt-casting film formation method and is drawn.

55. The method for producing a cellulose acylate film according to claim 54, wherein the melt-casting film formation method is performed using a touch roll.

56. A method for producing a cellulose acylate film, which comprises drawing a cellulose acylate film using a tenter by 5% to 250% in a transverse direction while the quantity of a residual solvent of the cellulose acylate film is 1 mass % or less and heating the cellulose acylate film at a temperature of (Tg−30° C.) to (Tg+20° C.) in a state that binding of chucks at one or both sides of the tenter is released.

57. The method for producing a cellulose acylate film according to claim 56, wherein cellulose acylate included in the cellulose acylate film has at least two types of acylate groups having a carbon number of 2 to 7 and satisfies Equations (A) to (C):
2.45<X+Y<3.0; Equation (A)
0≦x≦2.45; and Equation (B)
0.3≦y≦3.0 Equation (C)
wherein X denotes the substitution degree of an acetyl group and Y denotes the sum of the substitution degrees of the acyl groups having a carbon number of 3 to 7.

58. The method for producing a cellulose acylate film according to claim 56, wherein the drawing is performed under the condition that a bowing ratio of the cellulose acylate film after the drawing becomes −1 to 1%.

59. The method for producing a cellulose acylate film according to claim 56, wherein the absolute value of an angle between a slow axis direction and a longitudinal direction of the cellulose acylate film after the heating is 89.5° to 90.5°.

60. The method for producing a cellulose acylate film according to claim 56, wherein the film is carried with tension of 1 N/m to 70 N/m after the binding of the chuck is released in the tenter.

61. The method for producing a cellulose acylate film according to claim 56, wherein the film is relaxed by 0.1% to 40% in the transverse direction after the transverse drawing and before the heating at a temperature lower than a temperature when the transverse drawing is finished by 0 to 20° C.

62. The method for producing a cellulose acylate film according to claim 56, wherein a temperature distribution upon the transverse drawing in the tenter satisfies the following equation:
1≦Ts−Tc≦5
wherein Tc denotes an average temperature of a central portion of the film and Ts denotes an average temperature of the both ends of the film.

63. The method according to claim 56, wherein the cellulose acylate film is drawn by 0% to 50% in the longitudinal direction before the drawing.

64. The method for producing a cellulose acylate film according to claim 57, wherein the cellulose acylate film having at least two kinds of acylate groups having the carbon number of 2 to 7 and satisfying said Equations (A) to (C) is a film which is formed by a melt-casting film formation method and is drawn using a touch roll.

65. A cellulose acylate film, wherein a dimension variation ratio when the film is suspended for 500 hours in an environment having a temperature of 60° C. and a relative humidity of 90% is −0.1% to 0.1% in a slow axis direction and a direction perpendicular thereto, a dimension variation ratio when the film is suspended for 500 hours in an environment having a temperature of 90° C. and a dry state is −0.1% to 0.1% in the slow axis direction and the direction perpendicular thereto, a thickness variation is 0 to 2 μm, a variation in in-plane retardation Re is 0 to 5 nm, a variation in a thickness retardation Rth is 0 to 10 nm, and the shift of the slow axis is −0.5 to 0.50.

66. The cellulose acylate film according to claim 65, wherein cellulose acylate included in the cellulose acylate film has at least two types of acylate groups having a carbon number of 2 to 7 and satisfies Equations (A) to (C):
2.45<X+Y<3.0; Equation (A)
0≦x≦2.45; and Equation (B)
0.3≦y≦3.0 Equation (C)
wherein X denotes the substitution degree of an acetyl group and Y denotes the sum of the substitution degrees of the acyl groups having a carbon number of 3 to 7.

67. The cellulose acylate film according to claim 65, wherein the cellulose acylate film obtained by forming the cellulose acylate to a film is drawn by 5% to 250% in the transverse direction using a tenter and is heated in a state that binding of chucks at one or both sides of the tenter is released.

68. A method for producing a cellulose acylate film, which comprises drawing a cellulose acylate film and relaxing or heating the cellulose acylate film.

69. The method for producing a cellulose acylate film according to claim 68, further comprising:
longitudinally drawing the cellulose acylate film by 1% to 300% under the condition that a length/width ratio (LAN) which is a ratio of a drawing length L to a width W of a film before drawing is greater than 0.01 and less than 0.3; and
longitudinally relaxing the cellulose acylate film by 1% to 50%.

70. The method for producing a cellulose acylate film according to claim 69, wherein transverse drawing is performed after the longitudinal relaxation is performed.

71. The method for producing a cellulose acylate film according to claim 70, wherein the transverse drawing is performed using a tenter with a drawing ratio of 1% to 250%.

72. The method for producing a cellulose acylate film according to claim 70, wherein the film is transversely relaxed by 1% to 50% after the transverse drawing is performed.

73. The method for producing a cellulose acylate film according to claim 69, wherein the cellulose acylate film is formed by a melt-casting film formation method and is drawn.

74. The method for producing a cellulose acylate film according to claim 73, wherein the melt-casting film formation method is performed using a touch roll.

75. The method for producing a cellulose acylate film according to claim 68, wherein the cellulose acylate film is drawn using the tenter by 5% to 250% in a transverse direction and is heated in a state that binding of chucks at one or both sides of the tenter is released.

76. The method for producing a cellulose acylate film according to claim 75, wherein cellulose acylate included in the cellulose acylate film has at least two types of acylate groups having a carbon number of 2 to 7 and satisfies Equations (A) to (C):
2.45<X+Y<3.0; Equation (A)
0≦x≦2.45; and Equation (B)
0.3≦y≦3.0 Equation (C)
wherein X denotes the substitution degree of an acetyl group and Y denotes the sum of the substitution degrees of the acyl groups having a carbon number of 3 to 7.

77. The method for producing a cellulose acylate film according to claim 75, wherein the drawing is performed under the condition that a bowing ratio of the cellulose acylate film after the drawing becomes −1 to 1%.

78. The method for producing a cellulose acylate film according to claim 75, wherein the absolute value of an angle between a slow axis direction and a longitudinal direction of the cellulose acylate film after the heating is 89.5° to 90.5°.

79. The method for producing a cellulose acylate film according to claim 75, wherein the film is carried with tension of 1 N/m to 70 N/m after the binding of the chuck is released in the tenter.

80. The method for producing a cellulose acylate film according to claim 75, wherein the film is relaxed by 0.1% to 40% in the transverse direction after the transverse drawing and before the heating at a temperature lower than a temperature when the transverse drawing is finished by 0 to 20° C.

81. The method for producing a cellulose acylate film according to claim 75, wherein a temperature distribution upon the transverse drawing in the tenter satisfies the following equation:
1≦Ts−Tc≦5
wherein Tc denotes an average temperature of a central portion of the film and Ts denotes an average temperature of the both ends of the film.

82. The method for producing a cellulose acylate film according to claim 75, wherein the drawing is performed in a state that the quantity of a residual solvent of the cellulose acylate film is 1 mass % or less.

83. The method according to claim 75, wherein the cellulose acylate film is drawn by 0% to 50% in the longitudinal direction before the drawing.

84. The method for producing a cellulose acylate film according to claim 76, wherein the cellulose acylate film having at least two kinds of acylate groups having the carbon number of 2 to 7 and satisfying said Equations (A) to (C) is a film which is formed by a melt-casting film formation method and is drawn using a touch roll.
